(19) United States
(12) Patent Application Publication
(10) Pub. No.: US 2013/0141681 A1
(43) Pub. Date: Jun. 6, 2013

(54) LAMINATE, OPTICAL FILM AND PRODUCTION METHOD FOR THESE, POLARIZING PLATE, IMAGE DISPLAY DEVICE, THREE-DIMENSIONAL IMAGE DISPLAY SYSTEM

(71) Applicant: FUJIFILM Corporation, Tokyo (JP)

(72) Inventors: Keita TAKAHASHI, Ashigarakami-gun (JP); Shinichi MORISHIMA, Ashigarakami-gun (JP); Kazuto KUNITA, Ashigarakami-gun (JP)

(73) Assignee: FUJIFILM Corporation, Tokyo (JP)

(21) Appl. No.: 13/752,895

(22) Filed: Jan. 29, 2013

Related U.S. Application Data
(63) Continuation of application No. PCT/JP2011/067225, filed on Jul. 28, 2011.

(30) Foreign Application Priority Data
Jul. 30, 2010 (JP) 2010-173077

(51) Int. Cl. G02F 1/13363

(52) U.S. Cl. CPC G02F 1/13363
USPC 349/117; 428/195.1; 428/141; 428/1.2; 427/164

(57) ABSTRACT

A laminate comprising a transparent support and, as formed on the transparent support, a patterned alignment control layer containing a first alignment control region and a second alignment control region each having an alignment control surface, in which the two regions differ from each other in point of the composition thereof and in point of the alignment-controlling capability thereof, in which the individual alignment control surfaces are alternately positioned in the patterned alignment control layer, and in which the alignment control surfaces of the first alignment control region and the second alignment control region can control liquid crystals in such a manner that the long axes of the aligned liquid crystals could be vertical to each other in the plane parallel to the alignment control surfaces.

### CROSS-REFERENCE TO RELATED APPLICATIONS

This application is a continuation application of International Application No. PCT/JP2011/067225, filed Jul. 28, 2011, which in turn claims the benefit of priority from Japanese Application No. 2010-173077, filed Jul. 30, 2010, the disclosures of which Applications are incorporated by reference herein in their entirety.

### BACKGROUND OF THE INVENTION

1. Field of the Invention

The present invention relates to a laminate useful as a support for a patterned optical film, and a method for producing it, as well as to an optical film, a polarizing plate and an image display device, especially a three-dimensional image display device using the laminate.

2. Description of the Related Art

Heretofore, as an optical film for 3D image display devices, an optically-anisotropic layer patterned in liquid-crystal domains with their slow axes kept vertical to each other has been provided. As a production method for the optical film with such a patterned optical anisotropic layer formed thereon, there has been known a method of using a photo-alignment film processed for alignment treatment to alternately form regions each having a different alignment-controlling capability through photoirradiation in two directions via a photomask or the like (see PTL 1, NPL 1).

There has also been proposed a method of using a rubbed alignment film. For example, PTL 2 discloses a method of forming a patterned retardation layer by using a patterned alignment layer that comprises portions aligned in different directions, and discloses a method of forming an alignment layer that comprises portions aligned in different directions, through mask-rubbing treatment. However, the production methods for a photoalignment film using a photomask and an alignment film through mask rubbing require expensive production facilities and require high-accuracy mask positioning on films, and in addition, the methods are still unsatisfactory in point of the patterning accuracy of the two alignment control regions in the obtained alignment films. Further, in the rubbing method, the rubbing direction must be changed relative to the film traveling direction, and therefore the method has a serious problem in point of the difficulty in production.

As opposed to these, PTL 3 discloses a method for producing a patterned alignment film through photolithography in place of the production methods for a photoalignment film using a photomask and an alignment film through mask rubbing, in which a photosensitive vertical alignment film-forming material and a horizontal alignment film-forming material are applied onto a substrate, exposed to light, then developed on a part of one of these, and thereafter rubbed all at a time to thereby produce an alignment film with a pattern of a vertical alignment layer and a horizontal alignment layer. However, in the patent literatures, produced is a patterned alignment film for controlling the liquid crystal alignment in a liquid-crystal cell in a liquid-crystal display device, and the patterned alignment film is disclosed merely for controlling the alignment of liquid crystals in the vertical direction and the horizontal direction relative to the patterned alignment film obtained therein.

On the other hand, an embodiment of forming a patterned alignment film by printing has been known. However, the production methods heretofore known in the art are all those where only one region of the two regions of the patterned alignment film has an alignment-controlling capability but the other region does not have an alignment-controlling capability (for example, see PTL 4). Accordingly, a method has not as yet been known of using a patterned alignment film in which both the two patterned regions are alignment control regions and in which the two alignment control regions differ in point of the alignment-controlling capability thereof.

On the other hand, a rubbed alignment film is, in general, a horizontal alignment film with which rod-shaped liquid-crystal molecules can be aligned in the same direction as the rubbing direction of the film; however, a vertical alignment film of using a predetermined polymer has also been known with which rod-shaped liquid-crystal molecules can be aligned in the direction vertical to the rubbing direction of the film (see PTL 5). In addition, various types of materials for rubbed alignment films have been proposed (see PTL 6 and PTL 7). However, nothing has been disclosed relating to use for formation of a patterned optical anisotropic layer.

### CITATION LIST

### Patent Literature

PTL 1: WO2005/096041
PTL 2: JP-A 2003-207641
PTL 3: JP-A 2007-163722
PTL 4: JP-A 2008-287273
PTL 5: JP-A 2002-98836
PTL 6: JP-A 2005-99228
PTL 7: JP-A 2006-276203

### Non Patent Literature

NPL 1: Photoalignment of Liquid Crystal, by Kunihiro Ichimura, Yoneda Publishing (2007)

### SUMMARY OF INVENTION

In production of a patterned optical anisotropic layer in this, when the step of alignment treatment in multiple direction is not needed, the production process may be dramatically simplified and will be therefore advantageous in continuous production. However, as described above, in production of a patterned optical anisotropic layer, it has heretofore been a prevailing view that an alignment film treated for alignment in different directions, for example, a photoalignment film that has been photoirradiated in different directions, or a rubbed alignment film that has been rubbed in different directions through mask rubbing or the like is necessary.

In particular, no one knows an alignment film with patterned two alignment control regions by which a liquid-crystal compound can be so controlled that two retardation regions could be vertical to each other in the plane parallel to the surface of the retardation plate, such as a patterned retardation plate for 3D image display devices.

The first object of the invention is to provide a laminate having at least two types of alignment control layers formed on a transparent support, in which the alignment control layers can control the alignment of liquid crystals in such a manner that the major axes of the aligned liquid crystals could be vertical to each other in the plane parallel to the alignment control surfaces of the layers, and to provide an optical film using the laminate. The second object is to provide simple production methods for the laminate and the optical film. The third object is to provide a polarizing plate using the optical film, and to provide, at low cost, an image display device and a three-dimensional image display system both having high visibility.

The present inventors tried using at least two materials each having a different composition and pattering them in a specific lamination mode to thereby form alignment control layers on a transparent support. As a result, the inventors have succeeded in producing a good patterned optical anisotropic layer and have found that a laminate and an optical film capable of solving the above-mentioned problems can be provided.

Specifically, the invention comprises the following constitution.

[1] A laminate comprising a transparent support and, as formed on the transparent support, a patterned alignment control layer containing a first alignment control region and a second alignment control region each having an alignment control surface, in which the two regions differ from each other in point of the composition thereof and in point of the alignment-controlling capability thereof, in which the individual alignment control surfaces are alternately positioned in the patterned alignment control layer, and in which the alignment control surfaces of the first alignment control region and the second alignment control region can control liquid crystals in such a manner that the long axes of the aligned liquid crystals could be vertical to each other in the plane parallel to the alignment control surfaces.
[2] The laminate according to [1], wherein the first alignment control region and the second alignment control region are processed in the same direction.
[3] The laminate according to [1], wherein the first alignment control region and the second alignment control region are rubbed in the same direction to be in a rubbed alignment film.
[4] The laminate according to anyone of [1] to [3], wherein the first alignment control region and the second alignment control region each are any of a film containing a modified or unmodified polyvinyl alcohol as the main ingredient thereof; a film containing a modified or unmodified polyacrylic acid; a film containing, as the main ingredient thereof, a (meth)acrylic acid copolymer that contains a recurring unit represented by the following general formula (I) or a recurring unit represented by the following general formula (II) or (III); or a film containing, as the main ingredient thereof, a polymer that has at least one structural unit represented by any of the following general formulae, (I-TH), (II-TH) and (III-TH):

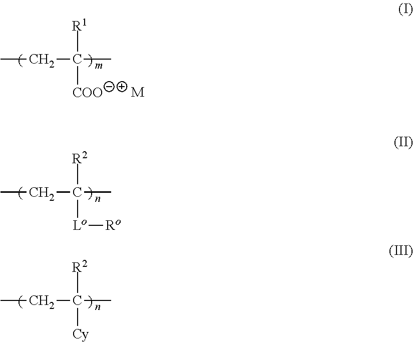

wherein, in the general formulae (I) to (III);
R¹ and R² each independently represent a hydrogen atom, a halogen atom or an alkyl group having from 1 to 6 carbon atoms;
M represents a proton, an alkali metal ion or an ammonium ion;
L⁰ represents a divalent linking group selected from the group consisting of —O—, —CO—, —NH—, —SO₂—, an alkylene group, an alkenylene group, an arylene group and a combination thereof;
R⁰ represents a hydrocarbon group having from 10 to 100 carbon atoms, or a fluorine atom-substituted hydrocarbon group having from 1 to 100 carbon atoms;
Cy represents an aliphatic cyclic group, an aromatic group or a heterocyclic group;
m indicates from 10 to 99 mol %; and n indicates from 1 to 90 mol %;

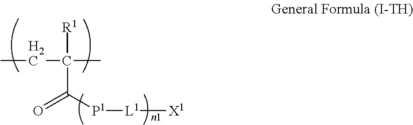

wherein, in the formula, R¹ represents a hydrogen atom, a methyl group, a halogen atom or a cyano group, P¹ represents an oxygen atom, —CO— or —NR¹²—, R¹² represents a hydrogen atom, or a substituted or unsubstituted alkyl group having from 1 to 6 carbon atoms, L¹ represents a divalent linking group selected from the group consisting of a substituted or unsubstituted, alkylene group, divalent cyclic aliphatic group, divalent aromatic group or divalent heterocyclic group, or a combination thereof, X¹ represents a hydrogen-bonding group, n1 indicates an integer of from 1 to 3;

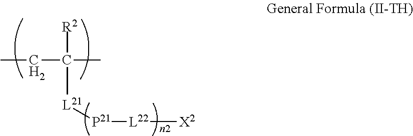

wherein, in the formula, R² represents a hydrogen atom, a methyl group, a halogen atom or a cyano group, L²¹ represents a substituted or unsubstituted, divalent aromatic group or divalent heterocyclic group, P²¹ represents a single bond, or a divalent linking group selected from the group consisting of —O—, —NR²¹—, —CO—, —S—, —SO—, —SO₂— and a combination thereof, R²¹ represents a hydrogen atom, or a substituted or unsubstituted alkyl group having from 1 to 6 carbon atoms, L²² represents a divalent linking group selected from the group consisting of a substituted or unsubstituted, alkylene group, divalent cyclic aliphatic group, divalent aromatic group or divalent heterocyclic group, or a combination thereof; X² represents a hydrogen-bonding group; n2 indicates an integer of from 0 to 3;

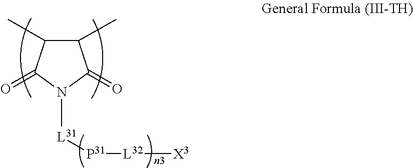

wherein, in the formula, L³¹ represents a substituted or unsubstituted, divalent aromatic group or divalent heterocyclic group, P³¹ represents a single bond, or a divalent linking group selected from the group consisting of —O—, —NR³¹—, —CO—, —S—, —SO—, —SO₂— and a combination thereof, R³¹ represents a hydrogen atom, or a substituted or unsubstituted alkyl group having from 1 to 6 carbon atoms, L³² represents a divalent linking group selected from the group consisting of a substituted or unsubstituted, alkylene group, divalent cyclic aliphatic group, divalent aromatic group or divalent heterocyclic group, or a combination thereof; X³ represents a hydrogen-bonding group; n3 indicates an integer of from 0 to 3.
[5] The laminate according to any one of [1] to [4], wherein the first alignment control region and the second alignment control region each comprise a different resin as the main ingredient thereof.
[6] The laminate according to any one of [1] to [5], wherein at least one region of the first alignment control region and the second alignment control region contains at least one of a pyridinium compound and an imidazolium compound.
[7] The laminate according to any one of [1] to [4], wherein the first alignment control region and the second alignment control region both comprise the same resin as the main ingredient thereof, and at least one region thereof contains at least one of a pyridinium compound and an imidazolium compound.
[8] The laminate according to [6] or [7], wherein the pyridinium compound or the imidazolium compound is liquid-crystalline.
[9] The laminate according to any one of [1] to [8], wherein the first alignment control region and the second alignment control region both comprise a non-developing resin as the main ingredient thereof.
[10] The laminate according to any one of [1] to [9], wherein the first alignment control region and the second alignment control region each are any one mode of the following (1) or (2):

Mode (1): The first alignment control region is formed on the transparent support and the second alignment control region is formed on a part of the first alignment control region.

Mode (2): The first alignment control region is formed on a part of the transparent support and the second alignment control region is formed on the other part of the transparent support on which the first alignment control region is not formed.

[11] The laminate according to any one of [1] to [10], wherein a black matrix is arranged between the first alignment control region and the second alignment control region.
[12] The laminate according to any one of [1] to [11], wherein Re(550) of the transparent support is from 0 to 10 nm, and Re(550) means the front retardation value (unit: nm) at a wavelength of 550 nm.
[13] The laminate according to any one of [1] to [12], which is used as a support of a patterned optical anisotropic layer.
[14] An optical film having a laminate of any one of [1] to [13], and having, on the alignment control region on the laminate, an optical anisotropic layer formed of a composition comprising a polymerizing group-having liquid crystal as the main ingredient thereof, wherein:

the optical anisotropic layer comprises a first retardation region and a second retardation region that are alternately patterned and that differ in the in-plane slow axis thereof.

[15] The optical film according to [14], wherein in the optical anisotropic layer, the first retardation region and the second retardation region are alternately belt-like patterned so as to have long sides parallel to one side of the optical anisotropic layer, and wherein the in-plane slow axis of the first retardation region is nearly vertical to the in-plane slow axis of the second retardation region.
[16] The optical film according to [14] or [15], of which the total Re(550) is from 100 to 190 nm, and Re(550) means the front retardation value (unit: nm) at a wavelength of 550 nm.
[17] The optical film according to any one of [14] to [16], wherein the polymerizing group-having liquid crystal is a discotic liquid crystal, and in the optical anisotropic layer, the discotic liquid crystal is fixed in a vertical alignment state.
[18] The optical film according to [17], wherein the optical anisotropic layer contains at least one of a pyridinium compound and an imidazolium compound.
[19] The optical film according to any one of [14] to [16], wherein the polymerizing group-having liquid crystal is a rod-shaped liquid crystal, and in the optical anisotropic layer, the rod-shaped liquid crystal is fixed in a vertical alignment state.
[20] The optical film according to any one of [14] to [19], which has a black matrix between the first retardation region and the second retardation region.
[21] A polarizing plate containing an optical film of any one of [14] to [20] and a polarizing film, wherein the in-plane slow axis direction of the first retardation region and the in-plane slow axis direction of the second retardation region in the optical anisotropic layer are both at 45° to the absorption axis direction of the polarizing film.
[22] The polarizing plate according to [21], wherein the optical film and the polarizing plate are laminated via an adhesive layer therebetween.
[23] The polarizing plate according to [21] or [22], which is further laminated with at least one antireflection film on the outermost surface thereof.
[24] An image display device having at least the following:

first and second polarizing films;

as arranged between the first and second polarizing films, a liquid-crystal cell including a pair of substrates of which at least one has an electrode and which are arranged to face each other and a liquid-crystal layer between the pair of substrates; and

an optical film of anyone of [14] to [23] to be arranged outside the first polarizing film, wherein:

the absorption axis direction of the first polarizing film is at an angle of ±45° to both the in-plane slow axis of the first retardation region and the in-plane slow axis of the second retardation region in the optical film.

[25] A three-dimensional image display system comprising at least an image display device of [24] and a third polarizing plate to be arranged outside the optical film, wherein a three-dimensional image is visualized through the third polarizing plate.
[26] A method for producing a laminate of any one of [1] to
[13], comprising at least the following steps:

a first alignment control region-forming step of forming a first alignment control region of a first composition on a transparent support, and

a second alignment control region-forming step of pattern-like printing a second alignment control region of a second composition that differ from the first composition.

[27] The method for producing a laminate according to [26], wherein in the first alignment control region-forming step, the first alignment control region is formed on the transparent substrate according to any of the following method (I) or (II):

Method (I): The first alignment control region is formed on the entire surface of the transparent support.

Method (II): The first alignment control region is formed on a part of the transparent support.

[28] The method for producing a laminate according to [26] or [27], which includes a step of aligning the first alignment control region and the second alignment control region in one direction.
[29] The method according to any one of [26] to [28], which includes a step of forming the alignment control layer that contains the first alignment control region and the second alignment control region, according to any one of the following printing steps of (I-A), (I-B) and (II-A):

Printing Step (I-A): The first alignment control region is printed on the transparent support, then the second alignment control region is printed on a part of the first alignment control region, and both the first alignment control region and the second alignment control region are simultaneously processed in one direction.

Printing Step (I-B): The first alignment control region is printed on the transparent support, then the first alignment control region is processed in one direction, and thereafter the second alignment control region is printed on a part of the processed surface of the first alignment controlled region.

Printing Step (II-A): The first alignment control region is printed on a part of the transparent support, the second alignment control region is printed on the other region of the transparent support on which the first alignment control region is not printed, and the first alignment control region and the second alignment control region are simultaneously processed in one direction.

[30] The method according to [28] or [29], wherein the processing step in one direction is a rubbing step in one direction.
[31] The method according to any one of [26] to [30], wherein the second alignment control region is formed through flexographic printing.
[32] The method according to any one of [29] to [31], wherein in the printing step (I-A) or (II-A), the first composition for use in printing the first alignment control region contains any one of a parallel alignment film composition and a vertical alignment film composition and a first solvent, and the second composition for use in printing the second alignment control region contains the other compound and a second alignment solvent.
[33] The method according to any one of [29] to [32], wherein in the printing step (I-B), the first composition for use in printing the first alignment control region contains an alignment film compound and a first solvent, and the second composition for use in printing the second alignment control region contains at least any one of a pyridinium compound and an imidazolium compound, and a second solvent.
[34] A method for producing an optical film, which comprises arranging a composition that contains a polymerizing group-having liquid crystal, on a laminate of any one of [1] to [13], forming an optical anisotropic layer, and forming a patterned optical anisotropic layer that contains a first retardation region with alignment control on the first alignment control region and a second retardation region with alignment control on the second alignment control region.
[35] The method according to [34], wherein at least one of the first alignment control region and the second alignment control region in the laminate contains at least one of a pyridinium compound and an imidazolium compound, the liquid crystal is a discotic liquid crystal, and after a composition containing the discotic liquid crystal is arranged on the laminate, the laminate is heat-treated to control the alignment of the discotic liquid crystal, thereby forming the first retardation region and the second retardation region.
[36] The method according to [34] or [35], wherein before or after the formation of the optical anisotropic layer, a black matrix is formed between the first retardation region and the second retardation region.

### Advantageous Effects of Invention

According to the invention, there is provided a laminate having, as formed on a transparent support, at least two alignment control layers capable of so controlling the alignment of liquid crystals that the long axes thereof could be vertical to each other in the plane parallel to the alignment control surfaces of the layers. The laminate and the optical film of the invention can provide a patterned optical anisotropic layer, not using any expensive photomask but using any already-existing alignment film production apparatus and can be produced only by rubbing or the like alignment treatment in one direction, and therefore have great merits of low production cost and are excellent in easiness in their production. Further, the optical film of the invention has an optical anisotropic layer having a high-precision alignment pattern, and is excellent in practicability.

According to the production method for the laminate and the production method for the optical film of the invention, the laminate and the optical film of the invention can be provided conveniently and inexpensively.

According to the invention, a polarizing plate, an image display device and a three-dimensional image display system using the optical film of the invention can be provided conveniently and inexpensively.

### BRIEF DESCRIPTION OF DRAWINGS

FIG. 1 is a schematic view showing one embodiment of the cross section of a flexographic plate for use in the production method of the invention.

FIG. 2 is a schematic view showing a flexographic printing method of one embodiment of printing in the production method of the invention.

FIG. 3 includes schematic views each showing the optical characteristics evaluation results of the optical films obtained in Examples.

FIG. 4 is a schematic view showing one embodiment of the cross section of the optical film using an alignment control layer of the invention.

FIG. 5 is a schematic view showing another embodiment of the cross section of the optical film using an alignment control layer of the invention.

In the drawings, 1 is flexographic plate, 2 is parallel alignment film (or vertical alignment film), 3 is vertical alignment film liquid for pattern printing (or parallel alignment film liquid for pattern printing), 10 is flexographic printing apparatus, 11 is impression cylinder, 12 is printing roller, 13 is anilox roller, 14 is doctor blade, 21 is transparent support, 22a is first alignment control region, and 22b, 22c are second alignment control region.

### DETAILED DESCRIPTION OF THE INVENTION

The invention is described in detail hereinunder. In this description, the numerical range expressed by the wording “a number to another number” means the range that falls between the former number indicating the lower limit of the range and the latter number indicating the upper limit thereof.

In this description, “visible light” means from 380 nm to 780 nm. Unless otherwise specifically indicated in this description, the measurement wavelength is 550 nm.

In this description, the angle (for example, the angle of “90°” or the like) and its relationship (for example, “vertical”, “parallel”, “intersection at 45°” or the like) shall include the range of error acceptable in the technical field to which the invention belongs. For example, the angle means within a range of a strict angle ±less than 10°, and the error from the strict angle is preferably at most 5°, more preferably at most 3°.

In this description, the parallel alignment means that the long axes of liquid-crystal molecules are aligned nearly in parallel to the processing direction in the alignment control region; and the vertical alignment means that the long axes of liquid-crystal molecules are aligned nearly vertically to the processing direction in the alignment control region.

In this description, the wording “different compositions” means that the compositions differ not only in the main ingredient and/or at least one additive in each composition but also in the blend ratio of the constituent ingredients even though the types of the ingredients in the two compositions are the same.

In this description, the long axis direction of a molecule means the direction of the longest axis in the molecule for rod-shaped liquid-crystal molecules, but for discotic liquid-crystal molecules, the long axis direction means the direction in which the discotic faces of the molecule align (vertical direction to discotic faces).

### [Laminate]

The laminate of the invention comprises a transparent support and, as formed on the transparent support, a patterned alignment control layer containing a first alignment control region and a second alignment control region each having an alignment control surface, in which the two regions differ from each other in point of the composition thereof and in point of the alignment-controlling capability thereof, in which the individual alignment control surfaces are alternately positioned in the patterned alignment control layer, and in which the alignment control surfaces of the first alignment control region and the second alignment control region can control liquid crystals in such a manner that the long axes of the aligned liquid crystals could be vertical to each other in the plane parallel to the alignment control surfaces.

The laminate of the invention has an alignment control layer in which the alignment control surfaces differing from each other in point of the controlling capability are alternately positioned; and when one and the same type of liquid crystal is aligned on the laminate, then the liquid-crystal molecules in the first and second alignment control regions are aligned with their long axes kept vertical to each other. Accordingly, when the laminate of the invention is used as a support and when an optical anisotropic layer of a liquid-crystal composition is formed thereon, then a patterned optical anisotropic layer can be formed with ease in which the in-plane slow axis directions of the first and second retardation layers are vertical to each other. Specifically, using the laminate of the invention having the specific configuration as above makes it possible to provide an optical anisotropic layer having a good pattern formed therein, not requiring any expensive photomask but using any already-existing alignment film production apparatus.

The alignment control surfaces of the first alignment control region and the second alignment control region can control the alignment of liquid-crystal molecules in such a manner that the long axes of the aligned liquid-crystal molecules could be vertical to each other in the plane parallel to the alignment control surfaces. In one example, the alignment-controlling capability of the alignment control surfaces of the first alignment control region and the second alignment control region satisfies the following (A), and in another example, satisfies the following (B).

(A) Rod-shaped liquid-crystal molecules are controlled in a direction of horizontal alignment in which the long axes of the molecules are vertical to each other.

(B) Discotic liquid-crystal molecules are controlled in a direction in which the discotic surfaces of the molecules could be vertical to the alignment control layer surfaces and the long axes thereof could be vertical to each other.

The alignment control surfaces each showing a different alignment-controlling capability may not be good to be on the same plane. For example, of the first and second alignment control regions, one alignment control region may be formed uniformly and the other alignment control region may be pattern-like formed thereon in one embodiment of the case. Needless-to-say, the alignment control surfaces each showing a different alignment-controlling capability may be alternately positioned on the same plane, or that is, in the embodiment, the two alignment control regions may be alternately aligned on the same plane. In a different expression, the embodiment of the invention means that, when the surface of the transparent support opposite to the surface thereof facing the alignment control layer is orthographically projected on a virtual plane parallel to the transparent support, the first alignment control region and the second alignment control regions are alternately patterned.

For example, in the former embodiment, the cross section has the configuration shown in FIG. 4. In FIG. 4, when the laminate of the invention is produced according to the embodiment (I), the first alignment control region 22a is formed on the transparent support 21, and the second alignment control region 22b is formed on a partial region of the first alignment control region 22a. The alignment film can maintain the power thereof to control the alignment of the liquid-crystal molecules laminated thereon in the direction vertical to the film surface thereof, even when it is relatively thick, and therefore, the alignment control layer having such irregularities on the film surface thereof is acceptable here. In this case, the first alignment control region 22a and the second alignment control region 22b may be processed in one direction, or the alignment control region 22b may be good not to be processed for any physical alignment treatment such as rubbing treatment or the like. In case where the alignment control region 22b is not processed for any physical alignment treatment such as rubbing treatment or the like, the second alignment control region 22b may be laminated on the first alignment control region 22a, and the liquid-crystal molecules laminated on the alignment control region 22b can be aligned in the direction differing from the alignment treatment direction of the lower alignment control region 22a.

In this case, the surface of the alignment control layer opposite to the surface thereof facing the transparent support faces the above-mentioned upper layer of the second alignment control region 22b, and therefore, in this case, when the surface of the alignment control layer of the laminate opposite to the surface thereof facing the transparent layer is orthographically projected on a virtual plane parallel to the transparent support, the first alignment control region derived from the part where the lower layer of the first alignment control region 22a provides the surface and the second alignment control region derived from the part where the upper layer of the second alignment control region 22b provides the surface are alternately patterned.

In the laminate of the invention, in case where the alignment control layer is produced according to the embodiment (I), preferably, the thickness of the alignment control region is from 0.01 to 10 μm, more preferably from 0.01 to 1 μm. When the layer has a thickness on the level falling within the range, then it can fully maintain the power thereof to control the alignment of the liquid-crystal molecules laminated thereon in the direction vertical to the film surface thereof, even though the film surface is uneven.

In the latter embodiment, the cross section has the configuration shown in FIG. 5. In FIG. 5, the first alignment control region 22a is formed on a partial region of the transparent support 21, and the second alignment control region 22c is formed on the region of the transparent support 21 on which the first alignment control region 22a is not formed. Preferably, both the first alignment control region 22a and the second alignment control region 22c are processed in one direction.

In this case, the surface of the alignment control layer opposite to the surface thereof facing the transparent support is composed of the first alignment control region 22a and the second alignment control region 22c, and therefore, in this case, when the surface of the alignment control layer of the laminate opposite to the surface thereof facing the transparent layer is orthographically projected on a virtual plane parallel to the transparent support, the first alignment control region and the second alignment control region are alternately patterned.

In the laminate of the invention, preferably, the first alignment control region and the second alignment control region are processed in the same direction. More preferably, the first alignment control region and the second alignment control region are rubbed alignment films that have been rubbed in the same direction.

In this description, “alignment film” means a film that has been processed to have an alignment control capability for liquid-crystal molecules. The alignment film can be classified into a rubbed alignment film, a photoalignment film, and a film given liquid crystal alignability through any other treatment such as electric field impartation or magnetic field impartation, depending on the method of processing the film for giving alignability thereto. In the laminate of the invention, a rubbed alignment film is preferably used from the viewpoint of increasing the production speed to enhance the productivity. Accordingly, the rubbed alignment film is mainly described below; however, the invention is not limited to the embodiment with such a rubbed alignment film mentioned below.

The alignment film may be further classified into a parallel alignment film and a vertical alignment film. For example, the rubbed alignment film has an alignment axis for controlling the alignment of liquid-crystal molecules, and in case where a composition containing liquid-crystal molecules is laminated on the rubbed alignment film, the liquid-crystal molecules are aligned in accordance with the alignment axis of the rubbed alignment film.

The conceptual description of the parallel alignment film and the vertical alignment film as referred to herein is as follows.

Control of liquid crystal alignment with a molecular-aligned monomolecular film or polymer thin film depends on a molecular level atomic group or a partial atomic group that forms a molecular skeleton. A rubbed alignment film comes to exhibit its alignment-controlling capability through rubbing treatment, and in view of the production method thereof, the alignment axis of the film is determined depending on the rubbing direction and the heating condition. In general, when a liquid crystal is aligned on an alignment film rubbed in one direction, then the liquid crystal is aligned with its long axis kept in parallel or vertical to the rubbing direction. One example is described below. When a polyvinyl alcohol is applied onto a glass substrate and rubbed, and thereafter a rod-shaped liquid crystal is sandwiched between those two substrates to construct a liquid-crystal cell, then the rod-shaped liquid-crystal molecules are aligned parallel to the rubbing direction. Different from the case, when a polystyrene film is used in place of the polyvinyl alcohol film, then the rod-shaped liquid-crystal molecules are aligned vertically to the rubbing direction.

Through rubbing, a processed layer is formed in a region to a specific depth from the surface of the polymer film. There are formed grooves generated in the rubbing direction and the refractivity anisotropy. The anisotropic optical axis is parallel to the rubbing direction in polyimide, but is vertical thereto in polystyrene. Regarding the mechanism of unidirectional alignment of liquid-crystal molecules through rubbing, there are known a theory indicating that rod-shaped molecules are aligned along grooves, and a theory based on anisotropic dispersion power. Concretely, the rubbing treatment has the same effect as that of stretching the polymer chains on a surface layer, and in both cases, the polymer main chains are rearranged in the rubbing direction. With that, the hydroxyl group in the side chain of polyvinyl alcohol becomes vertical to the rubbing direction, and in the case of a polystyrene film, not the main chain but the phenyl group in the side chain becomes vertical thereto. In other words, it may be considered that the alignment direction of liquid-crystal molecules by the action of the polymer film that has been processed by rubbing could be determined by any of the monoaxially-aligned polymer main chain and/or the substituent of the polymer extending in the vertical direction to the main chain thereof.

In liquid crystal alignment by a vertical alignment film of polyimide which is now put in practical use, it is suggested that extremely fine grooves formed on the film through rubbing treatment thereon play an important role in alignment control, and it is considered that the effect of the polymer main chain aligned in the rubbing direction would similarly participate in the alignment mode. It may be considered that even a polystyrene film could undergo some physical surface profile change, or that is, fine grooves would be formed thereon, however, in the case, the phenyl group in the side chain and the interaction of liquid-crystal molecules would be hold a predominant position. Specifically, in polyimide, the two could act as coordinating parallel, but in polystyrene, the mechanism based on anisotropic dispersion power is in a predominant state, and therefore the two polymers are grouped into a parallel alignment film and a vertical alignment film.

In this description, “alignment control layer” means a film that has been processed to have an alignment-controlling capability for liquid-crystal molecules. The alignment control layer may be a single layer, or may be composed of two or more layers. The alignment control layer may be broadly divided into two categories, an alignment film such as a rubbed alignment film and a photoalignment film, and a film comprising, as the main ingredient thereof, an alignment-controlling agent capable of controlling the alignment of liquid-crystal molecules at the interface thereof.

Which type of alignment state the liquid-crystal molecules laminated on the alignment film could take would be determined depending on the condition of the production method to be mentioned below, the material of the alignment film, the type of the liquid-crystal molecules, the type of the alignment-controlling and others. These are described in detail hereinunder.

### (Material to Constitute Alignment Control Region)

Preferably, the alignment control region is an alignment film. The alignment film generally comprises a polymer as the main ingredient thereof. Polymer materials for alignment film are described in many publications, and many commercial products are available. Of those, the following materials are preferably used for rubbed alignment films.

In the invention, preferably, the first alignment control region and the second alignment control region each are any of a film containing a modified or unmodified polyvinyl alcohol as the main ingredient thereof; a film containing a modified or unmodified polyacrylic acid; a film containing, as the main ingredient thereof, a (meth)acrylic acid copolymer that contains a recurring unit represented by the following general formula (I) or a recurring unit represented by the following general formula (II) or (III); or a film containing, as the main ingredient thereof, a polymer that has at least one structural unit represented by any of the following general formulae (I-TH), (II-TH) and (III-TH):

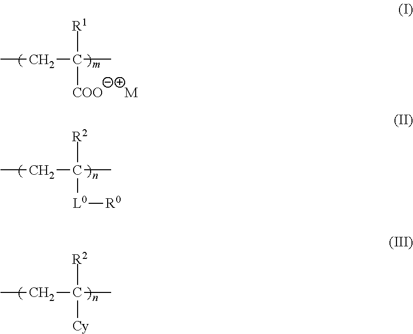

In the general formulae (I) to (III);

R¹ and R² each independently represent a hydrogen atom, a halogen atom or an alkyl group having from 1 to 6 carbon atoms;
M represents a proton, an alkali metal ion or an ammonium ion;
L⁰ represents a divalent linking group selected from the group consisting of —O—, —CO—, —NH—, —SO₂—, an alkylene group, an alkenylene group, an arylene group and a combination thereof;
R⁰ represents a hydrocarbon group having from 10 to 100 carbon atoms, or a fluorine atom-substituted hydrocarbon group having from 1 to 100 carbon atoms;
Cy represents an aliphatic cyclic group, an aromatic group or a heterocyclic group;
m indicates from 10 to 99 mol %; and n indicates from 1 to 90 mol %.

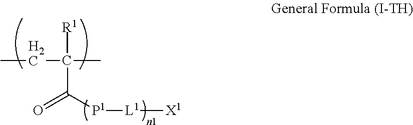

In the formula, R¹ represents a hydrogen atom, a methyl group, a halogen atom or a cyano group, P¹ represents an oxygen atom, —CO— or —NR¹²—, R¹² represents a hydrogen atom, or a substituted or unsubstituted alkyl group having from 1 to 6 carbon atoms, L¹ represents a divalent linking group selected from the group consisting of a substituted or unsubstituted, alkylene group, divalent cyclic aliphatic group, divalent aromatic group or divalent heterocyclic group, or a combination thereof, X¹ represents a hydrogen-bonding group, n1 indicates an integer of from 1 to 3.

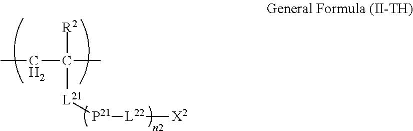

In the formula, R² represents a hydrogen atom, a methyl group, a halogen atom or a cyano group, L²¹ represents a substituted or unsubstituted, divalent aromatic group or divalent heterocyclic group, P²¹ represents a single bond, or a divalent linking group selected from the group consisting of —O—, —NR²¹—, —CO—, —S—, —SO—, —SO₂— and a combination thereof, R²¹ represents a hydrogen atom, or a substituted or unsubstituted alkyl group having from 1 to 6 carbon atoms, L²² represents a divalent linking group selected from the group consisting of a substituted or unsubstituted, alkylene group, divalent cyclic aliphatic group, divalent aromatic group or divalent heterocyclic group, or a combination thereof; X² represents a hydrogen-bonding group; n2 indicates an integer of from 0 to 3.

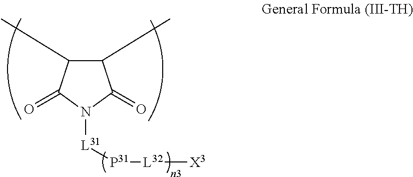

In the formula, L³¹ represents a substituted or unsubstituted, divalent aromatic group or divalent heterocyclic group, P³¹ represents a single bond, or a divalent linking group selected from the group consisting of —O—, —NR³¹—, —CO—, —S—, —SO—, —SO₂— and a combination thereof, R³¹ represents a hydrogen atom, or a substituted or unsubstituted alkyl group having from 1 to 6 carbon atoms, L³² represents a divalent linking group selected from the group consisting of a substituted or unsubstituted, alkylene group, divalent cyclic aliphatic group, divalent aromatic group or divalent heterocyclic group, or a combination thereof; X³ represents a hydrogen-bonding group; n3 indicates an integer of from 0 to 3.

The alignment film comprising the above-mentioned alignment film material as the main ingredient thereof can be a vertical alignment film or a parallel alignment film depending on the type of the liquid crystal to be combined with the film and on the presence or absence of a predetermined additive thereto, and therefore the alignment film may be suitably selected so as to satisfy the requirement for the first and second alignment control regions in accordance with the type of the liquid-crystal compound to be combined with the film.

Examples of the vertical alignment film include a copolymer that comprises a recurring unit necessary for vertical alignment and a recurring unit necessary for solubility thereof insolvent for preparing coating liquid, etc. The molar ratio of the recurring unit necessary for vertical alignment is preferably from 1 to 90%, more preferably from 5 to 70%, even more preferably from 10 to 50%. The molar ratio of the recurring unit necessary for solubility is preferably from 99% to 1%, more preferably from 95% to 10%, most preferably from 90% to 5%. Preferably, the two recurring units simultaneously satisfy the respective numeral ranges. However, in case where the ingredient necessary for vertical alignment and the ingredient necessary for solubility are contained in one and the same structure, there may be some other cases to which the above-mentioned numerical ranges do not apply but which are preferred here.

Examples of vertical alignment films usable in the invention are shown in the following Tables 1 to 27; however, the invention is not limited to these embodiments.

In the following Tables 1 to 6, 9 to 12, 14, and 21 to 27, the ingredients necessary for vertical alignment are those in which the recurring number is a, and the ingredients necessary for solubility in alcohol solvent are those in which the recurring number is b. In Tables 7, 8 and 13, the ingredients necessary for vertical alignment are those in which the recurring number is a and those in which the recurring number is c, and the ingredients necessary for solubility in alcohol solvent are those in which the recurring number is b. In the skeleton of Compound Numbers 30 to 42 in Tables 15 to 20, both the ingredient necessary for alignment and the ingredient for imparting solubility have a recurring number of a, and are the same.

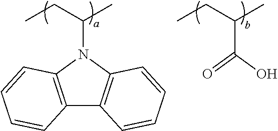

TABLE 1

| | Compositional Ratio, | | | | | | |
|---|---|---|---|---|---|---|---|
| | by mol | | | | GPC (UV) | | |
| Number | a | b | c | d | Mn | Mw | Mw/Mn |
| 1 | 10 | 90 | 0 | 0 | 9986 | 21005 | 2.103 |
| 2 | 20 | 80 | 0 | 0 | 12664 | 39418 | 3.118 |
| 3 | 25 | 75 | 0 | 0 | 14348 | 46384 | 3.233 |
| 4 | 30 | 70 | 0 | 0 | 14125 | 39286 | 2.781 |
| 5 | 40 | 60 | 0 | 0 | 9298 | 24249 | 2.608 |

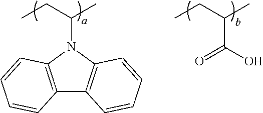

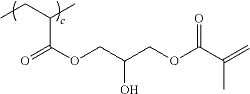

TABLE 2

| | Compositional Ratio, | | | | | | |
|---|---|---|---|---|---|---|---|
| | by mol | | | | GPC (UV) | | |
| Number | a | b | c | d | Mn | Mw | Mw/Mn |
| 6 | 10 | 80 | 10 | 0 | 17192 | 51578 | 3.000 |
| 7 | 20 | 68 | 12 | 0 | 13099 | 36834 | 2.812 |
| 8 | 30 | 58 | 12 | 0 | 13689 | 39478 | 2.884 |
| 9 | 40 | 48 | 12 | 0 | 12653 | 49789 | 3.935 |

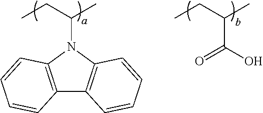

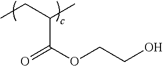

TABLE 3

| | Compositional Ratio, | | | | | | |
|---|---|---|---|---|---|---|---|
| | by mol | | | | GPC (UV) | | |
| Number | a | b | C | d | Mn | Mw | Mw/Mn |
| 10 | 10 | 40 | 50 | 0 | 5412 | 18285 | 3.379 |
| 11 | 20 | 40 | 40 | 0 | 7932 | 31684 | 3.990 |
| 12 | 30 | 20 | 50 | 0 | 12712 | 67569 | 5.315 |
| 13 | 40 | 40 | 20 | 0 | 17017 | 144120 | 8.469 |

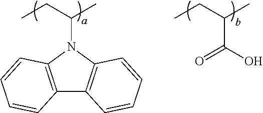

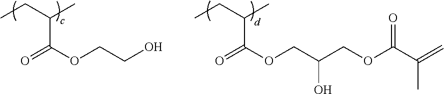

TABLE 4

| | Compositional Ratio, | | | | | | |
|---|---|---|---|---|---|---|---|
| | by mol | | | | GPC (UV) | | |
| Number | a | b | C | d | Mn | Mw | Mw/Mn |
| 14 | 30 | 8 | 50 | 12 | 13763 | 74344 | 5.402 |
| 15 | 40 | 28 | 20 | 12 | 14796 | 74196 | 5.014 |

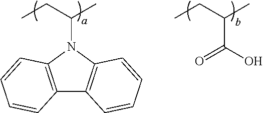

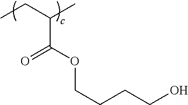

TABLE 5

| | Compositional Ratio, | | | | | | |
|---|---|---|---|---|---|---|---|
| | by mol | | | | GPC (UV) | | |
| Number | a | b | C | d | Mn | Mw | Mw/Mn |
| 16 | 40 | 55 | 5 | 0 | 15179 | 71156 | 4.688 |
| 17 | 40 | 50 | 10 | 0 | 14990 | 107328 | 7.160 |

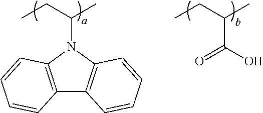

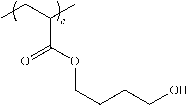

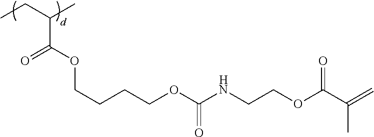

TABLE 6

| | Compositional Ratio, | | | | | | |
|---|---|---|---|---|---|---|---|
| | by mol | | | | GPC (UV) | | |
| Number | a | b | C | d | Mn | Mw | Mw/Mn |
| 18 | 40 | 55 | 2.5 | 2.5 | 16046 | 78665 | 4.902 |
| 19 | 40 | 55 | 0 | 5 | 17525 | 90598 | 5.170 |

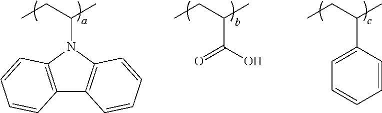

TABLE 7

| | Compositional Ratio, | | | | | | |
|---|---|---|---|---|---|---|---|
| | by mol | | | | GPC (UV) | | |
| Number | a | b | C | d | Mn | Mw | Mw/Mn |
| 20 | 10 | 70 | 20 | 0 | 10871 | 26462 | 2.434 |
| 21 | 20 | 70 | 10 | 0 | 10600 | 32208 | 3.038 |
| 22 | 30 | 40 | 30 | | 5506 | 11290 | 2.051 |

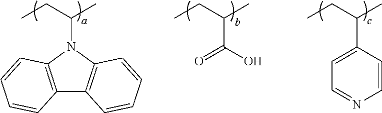

TABLE 8

| | Compositional Ratio, | | | | | | |
|---|---|---|---|---|---|---|---|
| | by mol | | | | GPC (UV) | | |
| Number | a | b | C | d | Mn | Mw | Mw/Mn |
| 23 | 20 | 70 | 10 | 0 | 10051 | 24568 | 2.444 |

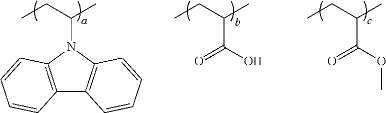

TABLE 9

| | Compositional Ratio, | | | | | | |
|---|---|---|---|---|---|---|---|
| | by mol | | | | GPC (UV) | | |
| Number | a | b | C | d | Mn | Mw | Mw/Mn |
| 24 | 20 | 70 | 10 | 0 | 10458 | 29856 | 2.854 |

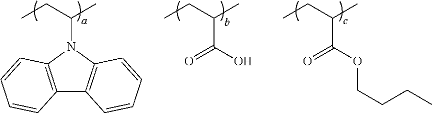

TABLE 10

| | Compositional Ratio, | | | | | | |
|---|---|---|---|---|---|---|---|
| | by mol | | | | GPC (UV) | | |
| Number | a | b | C | d | Mn | Mw | Mw/Mn |
| 25 | 20 | 70 | 10 | 0 | 12365 | 27609 | 2.232 |

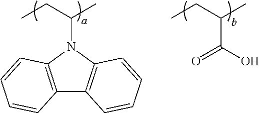

TABLE 11

| | Compositional Ratio, | | | | | | |
|---|---|---|---|---|---|---|---|
| | by mol | | | | GPC (UV) | | |
| Number | a | b | C | d | Mn | Mw | Mw/Mn |
| 26 | 30 | 70 | 0 | 0 | 26392 | 59473 | 2.253 |

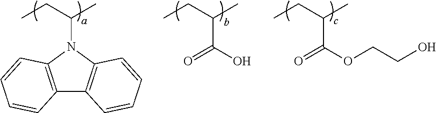

TABLE 12

| | Compositional Ratio, | | | | | | |
|---|---|---|---|---|---|---|---|
| | by mol | | | | GPC (UV) | | |
| Number | a | b | C | d | Mn | Mw | Mw/Mn |
| 27 | 30 | 20 | 50 | 0 | 9552 | 36652 | 3.837 |

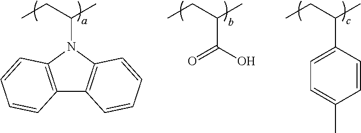

TABLE 13

| | Compositional Ratio, | | | | | | |
|---|---|---|---|---|---|---|---|
| | by mol | | | | GPC (UV) | | |
| Number | a | b | C | d | Mn | Mw | Mw/Mn |
| 28 | 30 | 40 | 30 | 0 | 5626 | 9604 | 1.446 |

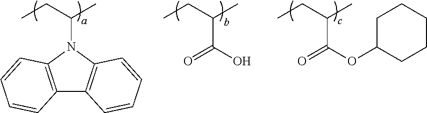

TABLE 14

| | Compositional Ratio, by mol | | | | GPC (UV) | | |
|---|---|---|---|---|---|---|---|
| Number | a | b | C | d | Mn | Mw | Mw/Mn |
| 29 | 20 | 70 | 10 | 0 | 9552 | 36652 | 3.837 |

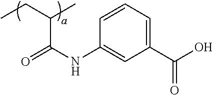

TABLE 15

| | Compositional Ratio, by mol | | | | GPC (UV) | | |
|---|---|---|---|---|---|---|---|
| Number | a | b | C | d | Mn | Mw | Mw/Mn |
| 30 | 100 | 0 | 0 | 0 | 6631 | 12286 | 1.853 |
| 31 | 100 | 0 | 0 | 0 | 12426 | 19556 | 1.574 |
| 32 | 100 | 0 | 0 | 0 | 33090 | 38517 | 1.164 |

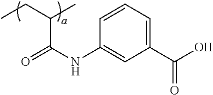

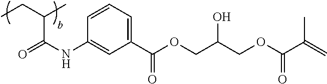

TABLE 16

| | Compositional Ratio, by mol | | | | GPC (UV) | | |
|---|---|---|---|---|---|---|---|
| Number | a | b | C | d | Mn | Mw | Mw/Mn |
| 33 | 82 | 18 | 0 | 0 | 5660 | 8051 | 1.422 |
| 34 | 70 | 30 | 0 | 0 | 5451 | 9142 | 1.677 |
| 35 | 60 | 40 | 0 | 0 | 5231 | 8553 | 1.631 |

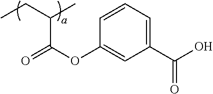

TABLE 17

| | Compositional Ratio, by mol | | | | GPC (UV) | | |
|---|---|---|---|---|---|---|---|
| Number | a | b | C | d | Mn | Mw | Mw/Mn |
| 36 | 100 | 0 | 0 | 0 | 6914 | 17378 | 2.513 |

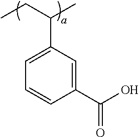

TABLE 18

| | Compositional Ratio, by mol | | | | GPC (UV) | | |
|---|---|---|---|---|---|---|---|
| Number | a | b | C | d | Mn | Mw | Mw/Mn |
| 37 | 100 | 0 | 0 | 0 | 15506 | 28054 | 1.809 |

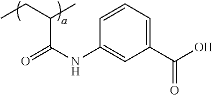

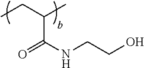

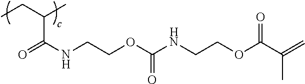

TABLE 19

| | Compositional Ratio, by mol | | | | GPC (UV) | | |
|---|---|---|---|---|---|---|---|
| Number | a | b | C | d | Mn | Mw | Mw/Mn |
| 38 | 95 | 5 | 0 | 0 | 14171 | 24765 | 1.748 |
| 39 | 90 | 10 | | | 15237 | 25119 | 1.649 |
| 40 | 70 | 30 | | | 10019 | 15050 | 1.502 |
| 41 | 50 | 50 | | | 6914 | 10080 | 1.458 |

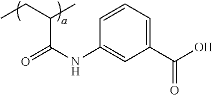

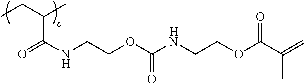

TABLE 20

| | Compositional Ratio, by mol | | | | GPC (UV) | | |
|---|---|---|---|---|---|---|---|
| Number | a | b | C | d | Mn | Mw | Mw/Mn |
| 42 | 95 | 5 | 0 | 0 | 14587 | 25478 | 1.747 |

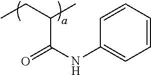

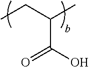

TABLE 21

| | Compositional Ratio, by mol | | | | GPC (UV) | | |
|---|---|---|---|---|---|---|---|
| Number | a | b | C | d | Mn | Mw | Mw/Mn |
| 43 | 50 | 50 | 0 | 0 | 19551 | 51333 | 2.626 |

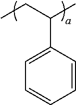

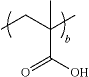

TABLE 22

| | Compositional Ratio, by mol | | | | GPC (UV) | | |
|---|---|---|---|---|---|---|---|
| Number | a | b | C | d | Mn | Mw | Mw/Mn |
| 44 | 50 | 50 | 0 | 0 | 9359 | 20297 | 2.160 |
| 45 | 60 | 40 | 0 | 0 | 9552 | 24896 | 2.602 |

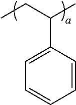

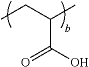

TABLE 23

| | Compositional Ratio, by mol | | | | GPC (UV) | | |
|---|---|---|---|---|---|---|---|
| Number | a | b | C | d | Mn | Mw | Mw/Mn |
| 46 | 50 | 50 | 0 | 0 | 13240 | 24108 | 1.821 |
| 47 | 70 | 30 | 0 | 0 | 8384 | 16632 | 1.984 |

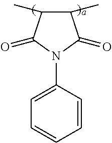

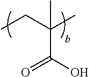

TABLE 24

| | Compositional Ratio, by mol | | | | GPC (UV) | | |
|---|---|---|---|---|---|---|---|
| Number | a | b | C | d | Mn | Mw | Mw/Mn |
| 48 | 50 | 50 | 0 | 0 | 3571 | 10032 | 2.810 |

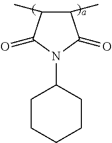

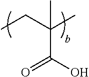

TABLE 25

| | Compositional Ratio, by mol | | | | GPC (UV) | | |
|---|---|---|---|---|---|---|---|
| Number | a | b | C | d | Mn | Mw | Mw/Mn |
| 49 | 50 | 50 | 0 | 0 | 8873 | 18168 | 2.048 |

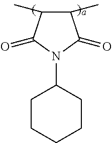

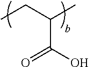

TABLE 26

| | Compositional Ratio, by mol | | | | GPC (UV) | | |
|---|---|---|---|---|---|---|---|
| Number | a | b | C | d | Mn | Mw | Mw/Mn |
| 49 | 50 | 50 | 0 | 0 | 2213 | 6079 | 2.747 |

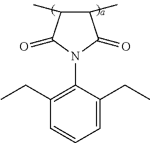 [SMILES: CCc1cccc(CC)c1N1C(=O)C(C)C(C)C1=O]

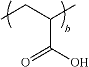

TABLE 27

| | Compositional Ratio, by mol | | | | GPC (UV) | | |
|---|---|---|---|---|---|---|---|
| Number | a | b | C | d | Mn | Mw | Mw/Mn |
| 51 | 50 | 50 | 0 | 0 | 1460 | 2773 | 1.899 |

The above-mentioned polymers for alignment films can be prepared by synthesis. For example, these may be synthesized according to the methods described in JP-A 2006-276203 and JP-A 2005-99228. One example is mentioned below.

### (Method for Synthesis of Compound Number 5 in Table 1)

1.83 g of a solvent, NEP (N-ethylpyrrolidone) was put into a three-neck flask. A solution prepared by dissolving 9.62 g of 9-vinyl-carbazole, 5.38 g of acrylic acid and 409 mg of AIBN in 10.08 g of NEP was filtered with pyrene, and washed with 2.75 g of NEP, and the resulting solution was dropwise added to the flask with a syringe pump, taking 2 hours. At an inner temperature of 75° C. in a nitrogen flow (10 ml/min), this was stirred and polymerized at a stirring rate of 350 rpm. After the addition, the inside of the syringe pump was washed with 3.3 g of NEP. Further, a solution prepared by dissolving 163 mg of AIBN in 367 mg of NEP was dropwise added, and at an inner temperature of 75° C. in a nitrogen flow (10 ml/min), this was stirred and polymerized at a stirring rate of 350 rpm for 3 hours. The inner temperature was lowered to room temperature, and 30 ml of THF was added. The reaction liquid was put into 600 ml of methanol/water (=9/1) for reprecipitation therein, and the solvent was removed through decantation. Further, 300 ml of methanol/water (=9/1) was added and stirred for 30 minutes, and the solvent was removed through decantation. Finally, 400 ml of methanol/water (=1/1) was added and stirred for 30 minutes, and the solid was collected through suction filtration. Subsequently, this was dried in vacuum (40° C.) to give 15.79 g of a white solid.

Preferably, the first alignment control region and the second alignment control region both comprise a non-developing resin as the main ingredient thereof. In this, the non-developing resin means a resin which, after exposed to light and developed and optionally cured, solidifies and may remain as a solid only in the exposed area thereof and in which the other part can be readily removed. Concretely, there may be mentioned other resins than known developing resins for use in photolithography, and for example, known developing resins for photosensitive polyimide films and others are not within the range of the non-developing resin. When such a developing resin is used to produce a patterned alignment film through exposure followed by development, a photomask is necessary for the area to be exposed to light; and consequently, like in the case where two types of photoalignment films are produced by the use of different polarization, there occurs a problem of positioning. One characteristic feature of the invention is that the first alignment control region and the second alignment control region are formed not using a photomask, and therefore it is desirable that these regions each comprise a non-developing resin as the main ingredient thereof.

The first alignment control region and the second alignment control region each may comprise a different resin as the main ingredient thereof. For example, one may be a parallel alignment film comprising a predetermined polymer as the main ingredient thereof, and the other may be formed as a vertical alignment film comprising any other polymer as the main ingredient. Both the first alignment control region and the second alignment control region may comprise the same resin as the main ingredient. Depending on the combination of the alignment film and the additive therein, the two regions may strongly interact with each other, and depending on the presence or absence of the additive therein, the alignment behavior of liquid-crystal molecules may differ. The invention may be an embodiment that utilizes this phenomenon.

In the invention, as the additive that may be used in the first alignment control region and the second alignment control region, there may be mentioned a pyridinium compound and an imidazolium compound. As the case may be, it is desirable that any one region of the first alignment control region and the second alignment control region contains at least one of a pyridinium compound and an imidazolium compound.

In particular, in case where both the first alignment control region and the second alignment control region contain the same resin (for example, polyacrylic acid) as the main ingredient, it is desirable that at least one region of the two contains at least one of a pyridinium compound and an imidazolium compound.

### (Alignment-Controlling Agent: Pyridinium Compound and Imidazolium Compound)

The pyridinium compound and the imidazolium compound that are usable as an alignment-controlling agent in the invention may be liquid-crystalline or non-liquid-crystalline, and in both cases, the compound may interact with a predetermined alignment film material to thereby control the alignment direction of discotic liquid-crystal molecules contained in an optical anisotropic layer. Above all, the pyridinium compound and the imidazolium compound are preferably liquid-crystalline ones from the viewpoint of enhancing the alignment-controlling capability of the alignment film for discotic liquid crystals; and of those, more preferred are the pyridinium compounds represented by the following general formula (2a) and the imidazolium compounds represented by the following general formula (2b). The pyridinium compound and the imidazolium compound represented by the following general formulae (2a) and (2b), respectively, each can interact with a predetermined alignment film material to thereby control the alignment of liquid-crystal molecules and to determine the long-axis direction of the molecules; and especially for discotic liquid crystals (in particular, liquid crystals represented by the general formulae (I) to (IV) to be mentioned below), the compounds have an additional effect of controlling the alignment of the liquid crystals at the interface to alignment film. More concretely, the compounds have an effect of increasing the tilt angle of discotic liquid-crystal molecules near the interface to alignment film.

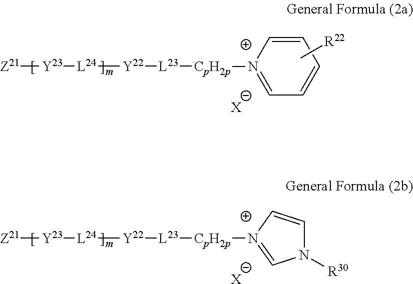

In the formulae, L²³ and L²⁴ each represent a divalent linking group.

L²³ is preferably a single bond, —O—, —O—CO—, —CO—O—, —C≡C—, —CH═CH—, —CH═N—, —N═CH—, —N═N—, —O-AL-O—, —O-AL-O—CO—, —O-AL-CO—O—, —CO—O-AL-O—, —CO—O-AL-O—CO—, —CO—O-AL-CO—O—, —O—CO-AL-O—, —O—CO-AL-O—CO— or —O—CO-AL-CO—O—; AL is an alkylene group having from 1 to 10 carbon atoms. More preferably, L²³ is a single bond, —O—, —O-AL-O—, —O-AL-O—CO—, —O-AL-CO—O—, —CO—O-AL-O—, —CO—O-AL-O—CO—, —CO—O-AL-CO—O—, —O—CO-AL-O—, —O—CO-AL-O—CO— or —O—CO-AL-CO—O—, even more preferably a single bond or —O—, and most preferably —O—.

L²⁴ is preferably a single bond, —O—, —O—CO—, —CO—O—, —C≡C—, —CH═CH—, —CH═N—, —N═CH— or —N═N—, and more preferably —O—CO— or —CO—O—. When m is 2 or more, more preferably, multiple L²⁴'s are alternately —O—CO— and —CO—O—.

R²² represents a hydrogen atom, an unsubstituted amino group, or a substituted amino group having from 1 to 20 carbon atoms.

When R²² is a dialkyl-substituted amino group, the two alkyl groups may bond to each other to form a nitrogen-containing hetero ring. The nitrogen-containing hetero ring to be formed in the case is preferably a 5-membered ring or a 6-membered ring. R²² is more preferably a hydrogen atom, an unsubstituted amino group, or a dialkyl-substituted amino group having from 2 to 12 carbon atoms, and even more preferably a hydrogen atom, an unsubstituted amino group or a dialkyl-substituted amino group having from 2 to 8 carbon atoms. In case where R²² is an unsubstituted amino group or a substituted amino group, preferably, the group is at the 4-position of the pyridinium ring.

X is an anion.

X is preferably a monovalent anion. Examples of the anion include halide ions (fluoride ion, chloride ion, bromide ion, iodide ion) and sulfonate ions (e.g., methanesulfonate ion, p-toluenesulfonate ion, benzenesulfonates ion).

Y²² and Y²³ each represent a divalent linking group having a 5- or 6-membered ring as the partial structure thereof.

The 5- or 6-membered ring may have a substituent. Preferably, at least one of Y²² and Y²³ is a divalent linking group having a substituent-having, 5- or 6-membered ring as the partial structure thereof. Preferably, Y²² and Y²³ each are independently a divalent linking group having an optionally-substituted 6-membered ring as the partial structure thereof. The 6-membered ring includes an aliphatic ring, an aromatic ring (benzene ring) and a hetero ring. Examples of the 6-membered aliphatic ring include a cyclohexane ring, a cyclohexene ring and a cyclohexadiene ring. Examples of the 6-membered hetero ring include a pyran ring, a dioxane ring, a dithiane ring, a thiine ring, a pyridine ring, a piperidine ring, an oxazine ring, a morpholine ring, a thiazine ring, a pyridazine ring, a pyrimidine ring, a pyrazine ring, a piperazine ring and a triazine ring. The 6-membered ring may be condensed with any other 6-membered ring or 5-membered ring.

Examples of the substituent include a halogen atom, a cyano group, an alkyl group having from 1 to 12 carbon atoms, and an alkoxy group having from 1 to 12 carbon atoms. The alkyl group and the alkoxy group each may be substituted with an acyl group having from 2 to 12 carbon atoms or an acyloxy group having from 2 to 12 carbon atoms. The substituent is preferably an alkyl group having from 1 to 12 (more preferably from 1 to 6, even more preferably from 1 to 3) carbon atoms. The compound may have two or more substituents, and for example, in case where Y²² and Y²³ each are a phenylene group, the group may be substituted with from 1 to 4 alkyl groups each having from 1 to 12 (more preferably from 1 to 6, even more preferably from 1 to 3) carbon atoms.

m is 1 or 2, and is preferably 2. When m is 2, multiple Y²³'s and L²⁴'s may be the same or different.

Z²¹ represents a monovalent group selected from a group comprising a halogen-substituted phenyl group, a nitro-substituted phenyl group, a cyano-substituted phenyl group, a phenyl group substituted with an alkyl group having from 1 to 10 carbon atoms, a phenyl group substituted with an alkoxy group having from 2 to 10 carbon atoms, an alkyl group having from 1 to 12 carbon atoms, an alkynyl group having from 2 to 20 carbon atoms, an alkoxy group having from 1 to 12 carbon atoms, an alkoxycarbonyl group having from 2 to 13 carbon atoms, an aryloxycarbonyl group having from 7 to 26 carbon atoms, and an arylcarbonyloxy group having from 7 to 26 carbon atoms.

When m is 2, Z²¹ is preferably a cyano group, an alkyl group having from 1 to 10 carbon atoms, or an alkoxy group having from 1 to 10 carbon atoms, more preferably an alkoxy group having from 4 to 10 carbon atoms.

When m is 1, Z²¹ is preferably an alkyl group having from 7 to 12 carbon atoms, an alkoxy group having from 7 to 12 carbon atoms, an acyl-substituted alkyl group having from 7 to 12 carbon atoms, an acyl-substituted alkoxy group having from 7 to 12 carbon atoms, an acyloxy-substituted alkyl group having from 7 to 12 carbon atoms, or an acyloxy-substituted alkoxy group having from 7 to 12 carbon atoms.

The acyl group is represented by —CO—R, and the acyloxy group is by —O—CO—R, in which R represents an aliphatic group (alkyl group, substituted alkyl group, alkenyl group, substituted alkenyl group, alkynyl group, substituted alkynyl group), or an aromatic group (aryl group, substituted aryl group). R is preferably an aliphatic group, more preferably an alkyl group or an alkenyl group.

p indicates an integer of from 1 to 10, and is especially preferably 1 or 2. CₚH₂ₚ means a linear alkylene group optionally having a branched structure. CₚH₂ₚ is preferably a linear alkylene group (—(CH₂)ₚ—).

In the formula (2b), R³⁰ represents a hydrogen atom, or an alkyl group having from 1 to 12 (more preferably from 1 to 6, even more preferably from 1 to 3) carbon atoms.

Of the compounds represented by the above-mentioned formula (2a) or (2b), preferred are the compounds represented by the following formula (2a′) or (2b′).

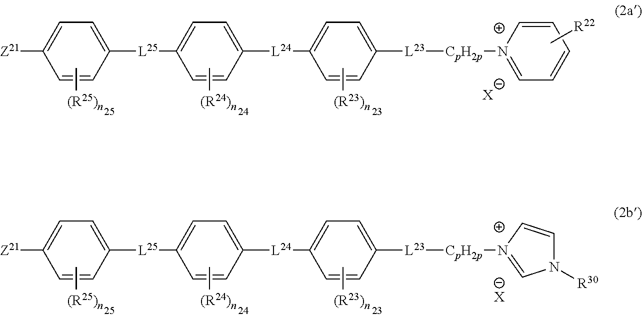

In the formulae (2a′) and (2b′), the same symbols as those in the formula (2) have the same meanings as in the latter, and the preferred ranges thereof are also the same as in the latter. L²⁵ has the same meaning as L²⁴, and the preferred range thereof is also the same as that of the latter. L²⁴ and L²⁵ each are preferably —O—CO— or —CO—O—, and more preferably, L²⁴ is —O—CO— and L²⁵ is —CO—O—.

R²³, R²⁴ and R²⁵ each represent an alkyl group having from 1 to 12 (more preferably from 1 to 6, even more preferably from 1 to 3) carbon atoms. n₂₃ indicates from 0 to 4, n₂₄ indicates from 1 to 4, and n₂₅ indicates from 0 to 4. Preferably, n₂₃ and n25 are 0, and n24 is from 1 to 4 (more preferably from 1 to 3).

R³⁰ is preferably an alkyl group having from 1 to 12 (preferably from 1 to 6, more preferably from 1 to 3) carbon atoms.

As specific examples of the compound represented by the general formula (2), there are mentioned the compounds described in JP-A 2006-113500, [0058] to [0061].

Specific examples of the compound represented by the general formula (2′) are shown below. In the following formulae, the anion (X⁻) is omitted.

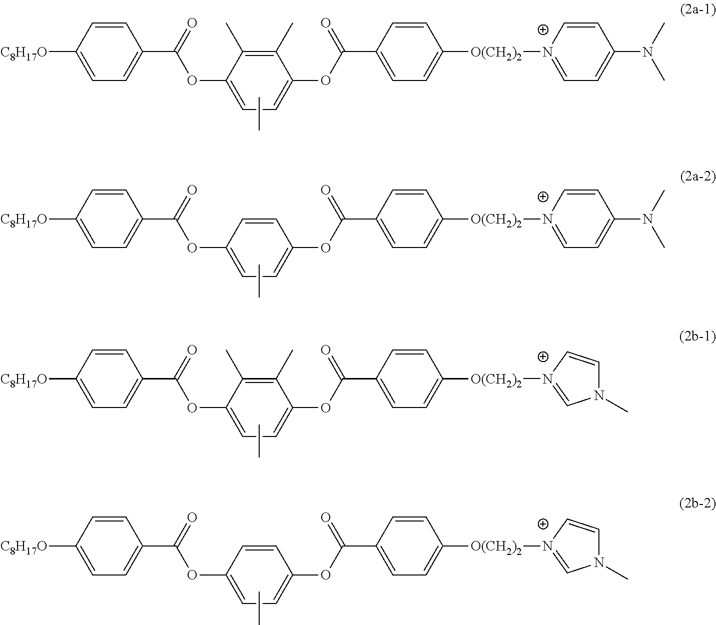

The compounds of the formulae (2a) and (2b) can be produced according to any ordinary method. For example, the pyridinium derivatives of the formula (2a) can be obtained by alkylating a pyridine ring (through Menschutkin reaction).

Preferably, the amount of the pyridinium compound and the imidazolium compound to be added is from 0.01 to 20% by mass relative to the main ingredient resin in the alignment control layer, more preferably from 0.1 to 2% by mass or so.

One example of the action of the pyridinium compound and the imidazolium compound represented by the above-mentioned general formulae (2a) and (2b) is considered to be as follows; however, their action is not limited to the embodiment mentioned below.

In the pyridinium compound and the imidazolium compound represented by the general formulae (2a) and (2b), the pyridinium group or the imidazolium group is hydrophilic, and therefore the compound is eccentrically located in the surface of the hydrophilic polyvinyl alcohol alignment film. In particular, in case where the pyridinium group, and further the amino group that is the acceptor of the hydrogen atom (in general formulas (2a) and (2a′) where R²² is an unsubstituted amino group or a substituted amino group having from 1 to 20 carbon atoms) are substituted, an intermolecular hydrogen bond is formed between the compound and polyvinyl alcohol, and therefore the compound can be eccentrically located at a higher density in the surface of the alignment film, and moreover, owing to the effect of the hydrogen bond, the pyridinium derivative is aligned in the direction vertical to the main chain of polyvinyl alcohol to thereby further promote the vertical alignment of liquid crystal in the rubbing direction. The pyridinium derivative has multiple aromatic rings in the molecule, and therefore provides an intermolecular π-π interaction with the above-mentioned liquid crystal, especially with the discotic liquid crystal, thereby induces vertical alignment of the discotic liquid crystal in the vicinity of the interface to the alignment film. In particular, in case where a hydrophobic aromatic ring bonds to the hydrophilic pyridinium group, as shown in the general formula (2a′), the compound exhibits an additional effect of inducing vertical alignment owing to the effect of the hydrophobicity thereof.

Further, when the pyridinium compound and the imidazolium compounds represented by the general formulae (2a) and (2b) are used together, then they may promote parallel alignment of liquid crystal of such that the liquid crystal heated at a temperature higher than a predetermined level is aligned with the long axis thereof kept in parallel to the rubbing direction. This is because the hydrogen bond to polyvinyl alcohol is cut by thermal energy and the pyridinium compound and the imidazolium compound are uniformly dispersed in the alignment film so that their density in the surface of the alignment film is lowered and, owing to the control force of the rubbed alignment film itself, the liquid crystal is aligned.

### (Alignment-Controlling Capability for Rod-Shaped Liquid-Crystal Compound)

As described above, one embodiment of the laminate of the invention comprises the first and second alignment control regions enabling horizontal alignment of rod-shaped liquid crystal molecules with their long axes kept vertical to each other.

One example of this embodiment uses a parallel alignment film in one of the first alignment control region and the second alignment control region and a vertical alignment film is in the other thereof.

The alignment film mentioned below has the function of aligning rod-shaped liquid-crystal molecules with their long axes kept parallel to the alignment axis of the film (in general, the rubbing axis of the film). The polymer material to be used for the parallel alignment film includes polyvinyl alcohol, polyacrylic acid or polyimide and their derivatives. More preferably, the parallel alignment film contains a modified or unmodified polyvinyl alcohol or a modified or unmodified polyacrylic acid as the main ingredient thereof. In this connection, there are known various polyvinyl alcohols each having a different degree of saponification. In the invention, preferably used are those having a degree of saponification of from 85 to 99 or so. Commercial products may also be used, and for example, “PVA103” and “PVA203” (by Kuraray) are PVA's each having a degree of saponification falling within the above range. For the rubbed alignment film, the modified polyvinyl alcohols described in WO01/88574A1, from page 43, line 24 to page 49, line 8, and Japanese Patent 3907735, paragraphs [0071] to [0095] may be referred to. The modified or unmodified polyacrylic acid means a poly(meth)acrylic acid copolymer, and may be good to contain acrylic acid or methacrylic acid. The content of acrylic acid or methacrylic acid in the polymer chain may be from 1% to 100% by mol, preferably from 10% to 100%, more preferably from 30% to 100%. The weight-average molecular weight of the polymer may be from 1000 to 1000000, preferably from 3000 to 100000, more preferably from 5000 to 50000.

The alignment film mentioned below has the function of aligning rod-shaped liquid-crystal molecules with their long axes kept vertical to the alignment axis of the film (in general, the rubbing axis of the film). For the vertical alignment film, for example, there may be mentioned the polymers reported in JP-A 2002-268068 and 2002-62427, and the above-mentioned polystyrenes. Further, also preferably used are an acrylic acid copolymer or a methacrylic acid copolymer containing a recurring unit represented by the above-mentioned general formula (I) and a recurring unit represented by the above-mentioned general formula (II) or (III), and a polymer having at least one recurring unit represented by any of the above-mentioned general formulae (I-TH), (II-TH) and (III-TH); and these are more preferred for use herein than the polymers described in the above-mentioned patent publications and the above-mentioned polystyrenes.

In this embodiment, or that is, in the embodiment of the laminate of the invention where the first alignment control region and the second alignment control region in the alignment control layer each comprise a different resin as the main ingredient thereof and are the parallel alignment film and the vertical alignment film, respectively, for rod-like liquid-crystal molecules, preferably, the parallel alignment film and the vertical alignment film are processed in one direction. In particular, it is more desirable that the parallel alignment film and the vertical alignment film are rubbed alignment films. For example, in FIG. 4, when the first alignment control region 22a is a parallel alignment film and the second alignment control region 22b is a vertical alignment film and when the two are both processed for alignment treatment in one direction, then the liquid-crystal molecules laminated on the first alignment control region 22a and the second alignment control region 22b can be aligned vertically to each other, therefore providing the optical film of the invention with patterned optical anisotropy to be mentioned below as one preferred embodiment of the invention.

### (Alignment-Controlling Capability for Discotic Liquid-Crystal Compound)

As described above, another embodiment of the laminate of the invention comprises the first and second alignment control regions capable of aligning discotic liquid-crystal molecules with their discotic surfaces kept vertical to the region and with their long axes kept vertical to each other.

In one example of this embodiment, preferably, at least one of the first alignment control region and the second alignment control region is a film that contains a modified or unmodified polyacrylic acid as the main ingredient thereof. More concretely, unmodified PAA (polyacrylic acid) enables parallel/vertical alignment of discotic liquid-crystal compounds. Accordingly, unmodified PAA can be used as the material for the alignment control region for parallel/vertical alignment of discotic liquid-crystal compounds.

On the other hand, at least one of the first alignment control region and the second alignment control region is preferably a film containing, as the main ingredient thereof, a (meth)acrylic acid copolymer that contains a recurring unit represented by the following general formula (I) and a recurring unit represented by the following general formula (II) or (III); or a film containing, as the main ingredient thereof, a polymer that has at least one structural unit represented by any of the following general formulae (I-TH), (II-TH) and (III-TH). Of those, for example, PSt(polystyrene)/PAA can be used as a material for the alignment control region for orthogonal/vertical alignment of discotic liquid-crystal compounds.

In another example of this embodiment, at least one region of the first alignment control region and the second alignment control region contains at least one of a pyridinium compound and an imidazolium compound. In this example, the pyridinium compound and the imidazolium compound contribute toward alignment control for liquid-crystal molecules, and therefore different types of combination of resins for the main ingredients of the alignment film are employable here. For example, the embodiment may be so designed that the first and second alignment control regions are formed of the same or different films selected from a film containing the above-mentioned modified or unmodified polyacrylic acid as the main ingredient thereof; or a film containing, as the main ingredient thereof, a (meth)acrylic acid copolymer that contains a recurring unit represented by the general formula (I), and a recurring unit represented by the general formula (II) or (III); or a film containing, as the main ingredient thereof, a polymer that has at least one structural unit represented by any of the general formulae (I-TH), (II-TH) and (III-TH), that at least one of a pyridinium compound and an imidazolium compound is added to at least one of those regions (in case where the compound is added to both the two, the main ingredient resin of the alignment film shall differ, or the amount of the compound to be added shall differ), and that any one of the first and second alignment control region is a region in which discotic liquid-crystal molecules are kept in orthogonal/vertical alignment while the other is a region in which discotic liquid-crystal molecules are kept in parallel/vertical alignment.

The above-mentioned alignment film includes those having the function of attaining orthogonal/vertical alignment at an ordinary alignment temperature for discotic liquid-crystal molecules in the presence of a pyridinium compound or an imidazolium compound, but includes any others capable of changing into alignment films having the function of vertical-parallel alignment depending on the temperature condition for alignment of discotic liquid-crystal molecules. For example, the alignment film that comprises, as the main ingredient thereof, a modified or unmodified polyvinyl alcohol, or PSt-PAA is one example that exhibits the behavior of the type. On the contrary, the above-mentioned alignment film includes those having the function of vertical-parallel alignment at an ordinary alignment temperature for discotic liquid-crystal molecules in the presence of a pyridinium compound or an imidazolium compound, but includes any others capable of changing into alignment films having the function of orthogonal/vertical alignment depending on the temperature condition for alignment of discotic liquid-crystal molecules. For example, the alignment film containing polyacrylic acid as the main ingredient thereof is one example that exhibits the behavior of the type. The matter as to which function of orthogonal/vertical alignment or vertical-parallel alignment those alignment films could exhibit can be determined by the temperature condition for liquid crystal alignment as to whether the liquid crystal is aligned at a temperature lower than the isotropic phase temperature thereof, or whether the liquid crystal is once heated up to the isotropic phase temperature thereof or a temperature higher than it, and thereafter lowered to the alignment temperature. However, depending on the liquid crystal, the alignment film material and the additive to be used, the alignment control function may be changed by any other temperature conditions, and the alignment control is not limited to the mode depending on temperature condition as above.

In the embodiment where at least one region of the first alignment control region and the second alignment control region contains at least one of a pyridinium compound and an imidazolium compound, the two regions may contain the same resin as the main ingredient thereof. The embodiment where the first alignment control region and the second alignment control region both contain the same region as the main ingredient thereof and where at least one region alone contains at least one of a pyridinium compound and an imidazolium compound is preferred from the viewpoint of production cost and production aptitude. As described above, even when the same resin is used as the main ingredient of both the first alignment control region and the second alignment control region, the alignment-controlling capability for discotic liquid-crystal molecules may differ between the two regions merely by adding a pyridinium compound or an imidazolium compound as the additive to only one alignment control region so as to change a little the compositions of the two regions.

In one concrete method, the first alignment control region and the second alignment control region each use any of a film that contains a modified or unmodified polyvinyl alcohol as the main ingredient thereof; a film that contains a modified or unmodified polyacrylic acid as the main ingredient thereof; a film that contains, as the main ingredient thereof, a (meth)acrylic acid copolymer containing a recurring unit represented by the above-mentioned general formula (I) and a recurring unit represented by the above-mentioned general formula (II) or (III); or a film that contains, as the main ingredient thereof, a polymer containing at least one structural unit represented by any of the above-mentioned general formulae (I-TH), (II-TH) and (III-TH).

In this case, regarding the timing at which a pyridinium compound or an imidazolium compound is added, the compound may be added to the composition of forming each alignment control region and then the alignment control region may be formed of the composition to provide the laminate; or after one alignment control region is formed and then the compound is added to a part of the region (for example, by coating or printing), and thereafter the other alignment control region may be formed to provide the laminate.

### <Transparent Support>

For the transparent support for use in the laminate of the invention, any known transparent support for alignment film can be used with no specific limitation. Above all, as the transparent support, preferred is an embodiment of using a film with little in-plane and thickness-direction retardation.

In the laminate of the invention, preferably, Re(550) of the transparent support is from 0 to 10 nm, from the viewpoint that Re of all the first retardation region and the second retardation region contained in the optical film of the invention to be mentioned below can be controlled to fall within a preferred range while the optical characteristics of the support have few influence on the film.

In this, Re(550) means a front retardation value (unit: nm) at a wavelength of 550 nm.

By controlling the amount of the additive to be added to the transparent support, which will be mentioned below, Re(550) of the transparent support can be controlled to fall within the preferred range.

Regarding the relationship to the optical anisotropic layer to be mentioned below, preferably, the transparent support satisfies −150≦Rth(630)≦100 in order that the total of Rth of the transparent support and Rth of the optical anisotropic layer (λ/4 plate) could satisfy |Rth|≦20.

In this, Re(λ) means a front retardation value (unit: nm) at a wavelength of λ nm, and Rth(λ) means a retardation value (unit: nm) in the film thickness direction at a wavelength of λ nm.

### (Material of Transparent Support)

As the material of forming the transparent support, preferred is a polymer excellent in optical transparency, mechanical strength, thermal stability, water shieldability, isotropy, etc., however any material of which Re and Rth each fall within the range satisfying the above-mentioned formula (I) is usable. For example, there are mentioned polycarbonate polymers; polyester polymers such as polyethylene terephthalate and polyethylene naphthalate; acrylic polymers such as polymethyl methacrylate; styrenic copolymers such as polystyrene and acrylonitrile/styrene copolymer (AS resin); etc. As examples of the material, also mentioned are polyolefins such as polyethylene and polypropylene; polyolefinic polymers such as ethylene/propylene copolymer; vinyl chloride-based polymers; amide polymers such as nylon and aromatic polyamide; imide polymers, sulfone polymers, polyether sulfone polymers, polyether ether ketone polymers, polyphenylene sulfide polymers, vinylidene chloride polymers, vinyl alcohol polymers, vinyl butyral polymers, arylate polymers, polyoxymethylene polymers, epoxy polymers; and mixtures of the above-mentioned polymers. The polymer film in the invention may also be formed as a cured layer of a UV-curable or thermosetting resin such as acrylic resin, urethane resin, acrylurethane resin, epoxy resin, silicone resin, etc.

As the material to form the transparent support, preferably used is a thermoplastic norbornene resin. The thermoplastic norbornene resin includes Nippon Zeon's ZEONEX, ZEONOR; JSR's ARTON; etc.

As the material to form the transparent support, also preferably used is a cellulose polymer such as typically triacetyl cellulose (hereinafter referred to as cellulose acylate) heretofore generally used as a transparent protective film for polarizing plates. As an example of the transparent support in the invention, cellulose acylate is mainly described in detail hereinunder, and it is obvious that the technical matters thereof shall apply similarly to any other polymer films.

### (Cellulose Acylate Film)

The starting cellulose for the cellulose acylate includes cotton linter and wood pulp (hardwood pulp, softwood pulp), etc., and any cellulose acylate obtained from any starting cellulose can be used herein. As the case may be, different starting celluloses may be mixed for use herein. The starting cellulose materials are described in detail, for example, in Marusawa & Uda's “Plastic Material Lecture (17), Cellulosic Resin” (by Nikkan Kogyo Shinbun, 1970), and in Hatsumei Kyokai Disclosure Bulletin No. 2001-1745, pp. 7-8; however, the invention is not limited by these descriptions.

Next described is the cellulose acylate to be produced from the above-mentioned starting cellulose. The cellulose acylate is one produced through acylation of the hydroxyl group in cellulose acylate, in which the substituent may be any acyl group including an acetyl group having 2 carbon atoms and others each having up to 22 carbon atoms. In the cellulose acylate, the degree of substitution of the hydroxyl group in cellulose is not specifically defined. The degree of substitution may be determined through calculation after measurement of the bonding degree of acetic acid and/or the fatty acid having from 3 to 22 carbon atoms substituting for the hydroxyl group in cellulose. For the measurement method, referred to is ASTM D-817-91.

As described above, the degree of substitution of the hydroxyl group in cellulose to give the cellulose acylate is not specifically defined. Preferably, the degree of acyl substitution of the hydroxyl group in cellulose is from 2.50 to 3.00. More preferably, the degree of substitution is from 2.75 to 3.00, even more preferably from 2.85 to 3.00.

Of acetic acid and/or the fatty acid having from 3 to 22 carbon atoms substituting for the hydroxyl group in cellulose, the acyl group having from 2 to 22 carbon atoms may be any of an aliphatic group or an aromatic group with no specific limitation thereon, and the acyl group may be a single group or may also be a mixture of two or more different types of groups. These include, for example, alkylcarbonyl esters, alkenylcarbonyl esters, aromatic carbonyl esters, aromatic alkylcarbonyl esters and the like of cellulose, and these may be further substituted with any other substituent. Preferred examples of the acyl group include acetyl, propionyl, butanoyl, heptanoyl, hexanoyl, octanoyl, decanoyl, dodecanoyl, tridecanoyl, tetradecanoyl, hexadecanoyl, octadecanoyl, iso-butanoyl, t-butanoyl, cyclohexanecarbonyl, oleoyl, benzoyl, naphthylcarbonyl, cinnamoyl groups, etc. Of those, preferred are acetyl, propionyl, butanoyl, dodecanoyl, octadecanoyl, t-butanoyl, oleoyl, benzoyl, naphthylcarbonyl, cinnamoyl, etc.; and more preferred are acetyl, propionyl and butanoyl.

As a result of assiduous studies, the present inventors have found that, when the acyl substituent for the hydroxyl group in cellulose comprises substantially at least two groups of acetyl group/propionyl group/butanoyl group and when the degree of substitution thereof is from 2.50 to 3.00, then the optical anisotropy of the cellulose acylate film can be reduced. More preferably, the degree of acyl substitution is from 2.60 to 3.00, and even more preferably from 2.65 to 3.00. In case where the acyl substituent for the hydroxyl group in cellulose is an acetyl group alone, the degree of substitution is preferably from 2.80 to 2.99, more preferably from 2.85 to 2.95 from the viewpoint that the optical anisotropy of the cellulose acylate film can be reduced and, in addition, the compatibility of the cellulose acylate with any other additive thereto as well as the solubility thereof in organic solvent to be used can be bettered.

The degree of polymerization of the cellulose acylate preferably used in the invention is preferably from 180 to 700 in terms of the viscosity-average degree of polymerization thereof. The degree of polymerization of cellulose acylate for use herein is preferably from 180 to 550, more preferably from 180 to 400, even more preferably from 180 to 350. When the degree of polymerization is too high, then the viscosity of the dope of the cellulose acylate may be high, and film formation with the dope through casting would be difficult. When the degree of polymerization is too low, then the strength of the formed film may be low. The mean degree of polymerization may be measured according to Uda et al's limiting viscosity method (by Kazuo Uda and Hideo Saito, the Journal of Society of Fiber Science and Technology, Japan, Vol. 18, No. 1, pp. 105-120, 1962). This is described in detail in JP-A 9-95538.

The molecular weight distribution of the cellulose acylate favorably used in the invention may be evaluated through gel permeation chromatography, and preferably, the polydispersiveness index Mw/Mn thereof (Mw indicates a mass-average molecular weight, and Mn indicates a number-average molecular weight) is small and the molecular weight distribution thereof is narrow. Concretely, the value of Mw/Mn is preferably from 1.0 to 3.0, more preferably from 1.0 to 2.0, most preferably from 1.0 to 1.6.

When a low-molecular-weight component is removed from the polymer, then the mean molecular weight (degree of polymerization of the polymer increases, however, the viscosity thereof is lower than that of any ordinary cellulose acylate; and therefore, the cellulose acylate of the type is favorable herein. The cellulose acylate in which the content of a low-molecular-weight component is small can be obtained by removing the low-molecular-weight component from the cellulose acylate produced according to an ordinary method. For removing the low-molecular-weight component, the cellulose acylate may be washed with a suitable organic solvent. In case where such a cellulose acylate in which the content of a low-molecular-weight component is small is produced, preferably, the amount of the sulfuric acid catalyst in the acylation is controlled to be from 0.5 to 25 parts by mass relative to 100 parts by mass of cellulose. When the amount of the sulfuric acid catalyst is controlled to fall within the above range, a cellulose acylate favorable in point of the molecular weight distribution (or that is, having a uniform molecular weight distribution) can be produced. The water content of the cellulose acylate to be used here is preferably at most 2% by mass, more preferably at most 1% by mass, even more preferably at most 0.7% by mass. In general, cellulose acylate contains water, and is known to have a water content of from 2.5 to 5% by mass. In order that the water content in the cellulose acylate for use in the invention is controlled to fall within the range, the cellulose acylate must be dried, and the drying method is not specifically defined so far as the dried cellulose acylate could have the intended water content. The production method for cellulose acylate for use in the invention is described in detail in Hatsumei Kyokai's Disclosure Bulletin (No. 2001-1745, published on Mar. 15, 2001, by Hatsumei Kyokai), pp. 7-12.

One alone or two or more different types of the above-mentioned cellulose acylates may be used here either singly or as combined, so far as the substituent, the degree of substitution, the degree of polymerization and the molecular weight distribution thereof fall within the above-mentioned ranges.

The thickness of the transparent support is preferably from 10 to 120 μm, more preferably from 20 to 100 μm, even more preferably from 30 to 90 μm.

Preferred properties of the polymer film for use as the transparent support in the invention are described below.

In this description, Re(λ) and Rth(λ) mean the in-plane retardation and the thickness-direction retardation, respectively, at a wavelength of λ. Re(λ) may be measured by applying a light having a wavelength of λ nm in the normal direction of the film being analyzed, using KOBRA 21ADH or WR (by Oji Scientific Instruments). In selecting the measurement wavelength λ nm, the wavelength selection filter to be used is changed by manual, or the measured data may be converted through programming or the like.

In case where the film to be analyzed is expressed as a monoaxial or biaxial index ellipsoid, Rth(λ) thereof may be computed as follows:

With the in-plane slow axis (determined by KOBRA 21ADH or WR) taken as the tilt axis (rotation axis) of the film (in case where the film has no slow axis, the rotation axis of the film may be in any in-plane direction of the film), Re(λ) of the film is measured at 6 points in all thereof, from the normal direction of the film up to 50 degrees on one side relative to the normal direction thereof at intervals of 10 degrees, by applying a light having a wavelength of λ nm from the tilted direction of the film. Based on the thus-determined retardation data, the assumptive mean refractive index and the inputted film thickness, Rth(λ) of the film is computed with KOBRA 21ADH or WR.

In the above, when the film has a direction in which the retardation thereof is zero at a certain tilt angle relative to the in-plane slow axis thereof in the normal direction taken as a rotation axis, the sign of the retardation value of the film at the tilt angle larger than that tilt angle is changed to negative prior to computation with KOBRA 21ADH or WR.

With the slow axis taken as the tilt axis (rotation axis) of the film (in case where the film has no slow axis, the rotation axis of the film may be in any in-plane direction of the film), the retardation is measured in any desired tilted two directions, and based on the thus-determined retardation data, the assumptive mean refractive index and the inputted film thickness, Rth may also be computed according to the following formulae (11) and (12).

$$Re ( θ ) = [ nx - \frac{ny \times nz}{\sqrt{\begin{matrix}{( ny sin ( {sin}^{- 1} ( \frac{sin ( - θ )}{nx} ) ) )}^{2} + \\ {( nz cos ( {sin}^{- 1} ( \frac{sin ( - θ )}{nx} ) ) )}^{2}\end{matrix}}} ] \times \frac{d}{cos ( {sin}^{- 1} ( \frac{sin ( - θ )}{nx} ) )} \qquad Formula ( 11 )$$

The above Re(θ) means the retardation of the film in the direction tilted by an angle θ from the normal direction to the film.

In the formula (11), nx means the in-plane refractive index of the film in the slow axis direction; ny means the in-plane refractive index of the film in the direction vertical to nx; nz means the refractive index in the direction vertical to nx and ny. d means the film thickness.

Rth=((nx+ny)/2−nz)×d Formula (12)

In the formula (12), nx means the in-plane refractive index of the film in the slow axis direction; ny means the in-plane refractive index of the film in the direction vertical to nx; nz means the refractive index in the direction vertical to nx and ny. d means the film thickness.

In case where the film to be analyzed could not be expressed as a monoaxial or biaxial index ellipsoid, or that is, when the film does not have an optical axis, Rth(λ) thereof may be computed as follows:

With the in-plane slow axis (determined by KOBRA 21ADH or WR) taken as the tilt axis (rotation axis) of the film, Re(λ) of the film is measured at 11 points in all thereof, in a range of from −50 degrees to +50 degrees relative to the film normal direction thereof at intervals of 10 degrees, by applying a light having a wavelength of λ nm from the tilted direction of the film. Based on the thus-determined retardation data, the assumptive mean refractive index and the inputted film thickness, Rth(λ) of the film is computed with KOBRA 21ADH or WR.

In the above measurement, for the assumptive mean refractive index, referred to are the data in Polymer Handbook (John Wiley & Sons, Inc.) or the data in the catalogues of various optical films. Films of which the mean refractive index is unknown may be analyzed with an Abbe's refractiometer to measure the mean refractive index thereof. Data of the mean refractive index of some typical optical films are mentioned below: Cellulose acylate (1.48), cycloolefin polymer (1.52), polycarbonate (1.59), polymethyl methacrylate (1.49), polystyrene (1.59). With the assumptive mean refractive index and the film thickness inputted thereinto, KOBRA 21ADH or WR can compute nx, ny and nz. From the thus-computed data of nx, ny and nz, Nz=(nx−nz)/(nx−ny) is further computed.

One preferred example of the polymer film to be used as the transparent support is a low-retardation film of which Re is from 0 to 10 nm and the absolute value of Rth is at most 20 nm.

### <Use of Laminate>

Preferably, the laminate of the invention is used as the support of a patterned optical anisotropic layer. In more detail, the laminate is preferably used as the alignment film for the patterned optical anisotropic layer to be arranged on the front side of the front-side polarizing plate in a liquid-crystal display device. Using the laminate facilitates the production of a patterned retardation plate for 3D image display devices.

### (Black Matrix)

Preferably, a black matrix is arranged between the first alignment control region and the second alignment control region in the laminate of the invention from the viewpoint that, when the laminate of the invention is used as the alignment film for the patterned retardation plate of a 3D image display device, the black matrix is effective for crosstalk reduction. The configuration where such a black matrix is arranged between the first alignment control region and the second alignment control region includes both the embodiment where the black matrix is so arranged as to partition the first alignment control region and the second alignment control region from each other and the embodiment where the black matrix is laminated on the boundary between the first alignment control region and the second alignment control region.

### [Method for Producing Laminate]

The method for producing the laminate of the invention comprises at least a first alignment control region-forming step of forming a first alignment control region of a first composition on a transparent support, and a second alignment control region-forming step of pattern-like printing a second alignment control region of a second composition that differ from the first composition.

The production method comprising the constitution gives the laminate of the invention.

The production method for the laminate of the invention is described in order of the formation of a transparent support and lamination with an alignment control layer.

### <Formation of Transparent Support>

The production method for the transparent support is not specifically defined, for which is employable any known method.

To the transparent support (preferably cellulose acylate), various additives (for example, compound capable of reducing optical anisotropy, wavelength dispersion regulator, fine particles, plasticizer, UV absorbent, antioxidant, release agent, optical characteristics regulator, etc.) may be added. These are described below. The time at which the additive is added may be any time in the process of dope production (process of producing cellulose acylate solution), but in the last of the dope production process, an additional step of adding the additive may be provided.

The embodiment of adding at least one compound capable of reducing the optical anisotropy of cellulose acylate film is preferred here.

The compound capable of reducing the optical anisotropy of cellulose acylate film is described. As a result of assiduous studies, the present inventors have succeeded in fully reducing the optical anisotropy of a cellulose acylate film to thereby make Re and Rth of the film nearly zero, by using a compound capable of inhibiting the in-plane and thickness-direction alignment of the cellulose acylate in the film. For this, it is advantageous that the compound for reducing optical anisotropy is fully miscible with cellulose acylate and the compound itself does not have a rod-shaped structure or a planar structure. Concretely, in case where the compound has multiple planar functional groups such as aromatic groups, it is desirable that the functional groups are not in one and the same plane but are so designed to be in a non-plane configuration.

In producing the cellulose acylate film, preferably used are those having an octanol/water distribution coefficient (log P value) of from 0 to 7 among the compounds capable of retarding the alignment of cellulose acylate in the film in the in-plane direction and in the thickness-direction to thereby lower the optical anisotropy of the film as described above. The compounds of which the log P value is more than 7 are poorly miscible with cellulose acylate and may often cause whitening and powdering of the film. On the other hand, the compound of which the log P value is less than 0 are highly hydrophilic and may therefore often worsen the water resistance of the cellulose acetate film. More preferably, the log P value falls within a range of from 1 to 6, even more preferably from 1.5 to 5.

The octanol/water distribution coefficient (log P value) may be determined according to the flask immersion method described in JIS, Japanese Industrial Standards, Z7260-107 (2000). In place of actual measurement therefor, the octanol/water distribution coefficient (log P value) may be estimated according to a computational chemical method or according to an experimental method. As the computation method, preferably employed are Crippen's fragmentation method (J. Chem. Inf. Comput. Sci., 27, 21 (1987)), Viswanadhan's fragmentation method (J. Chem. Inf. Comput. Sci., 29, 163 (1989)), Broto's fragmentation method (Eur. J. Med. Chem.-Chim. Theor., 19, 71 (1984)), etc.; and more preferred is Crippen's fragmentation method (J. Chem. Inf. Comput. Sci., 27, 21 (1987)). In case where the log P value of a certain compound differs depending on the measurement method or the computation method, the matter as to whether or not the compound falls within the scope of the present invention is preferably determined according to Crippen's fragmentation method. The log P value shown in this description is one determined according to Crippen's fragmentation method (J. Chem. Inf. Comput. Sci., 27, 21 (1987)).

The compound capable of reducing optical anisotropy may contain an aromatic group, or may be good not to contain it. Preferably, the compound capable of reducing optical anisotropy has a molecular weight of from 150 to 3000, more preferably from 170 to 2000, even more preferably from 200 to 1000. So far as its molecular weight falls within the range, the compound may have a specific monomer structure, or may have an oligomer structure or a polymer structure with a plurality of such monomer units bonding to each other.

The compound capable of reducing optical anisotropy is preferably a liquid at 25° C. or a solid having a melting point of from 25 to 250° C., and more preferably the compound is a liquid at 25° C. or a solid having a melting point of from 25 to 200° C. Preferably, the compound capable of reducing optical anisotropy does not evaporate away in the process of dope casting and drying for cellulose acylate film production.

The amount to be added of the compound capable of reducing optical anisotropy is preferably from 0.01 to 30% by mass relative to cellulose acylate, more preferably from 1 to 25% by mass, even more preferably from 5 to 20% by mass.

One or more different types of the compounds capable of reducing optical anisotropy may be used here either singly or as combined in any desired ratio.

The time at which the compound capable of reducing optical anisotropy is added may be any time during the dope production process, or the compound may be added in the final stage of the dope production process.

Regarding the content of the compound capable of reducing optical anisotropy in the cellulose acylate film, the mean content of the compound in the part from at least one surface of the film to 10% of the total film thickness is from 80 to 99% of the mean content of the compound in the center part of the film. The abundance of the compound can be determined by measuring the amount of the compound in the surface and in the center part of the film, for example, according to the method of IR spectrometry described in JP-A 8-57879.

As specific examples of the compound for reducing optical anisotropy preferably used in the cellulose acylate film of the invention, for example, there are mentioned the compounds described in JP-A 2006-199855, [0035] to [0058]; however, the invention is not limited to these compounds.

A case of applying the laminate of the invention or the optical film of the invention to be mentioned below to image display devices is described. When used in an ordinary liquid-crystal display device, the laminate or the optical film is arranged nearer to the viewers' side than the polarizing plate in the device, and therefore it may be readily influenced by external light, especially by UV rays. Consequently, it is desirable that a UV absorbent is added to any part constituting the laminate or the optical film of the invention, and more preferably, a UV absorbent is added to the transparent support.

As the UV absorbent, preferred is a compound having an absorption in the UV range of from 200 to 400 nm and capable of reducing both |Re(400)-Re(700)| and |Rth(400)-Rth(700)| of the film, and preferably, the compound is added to the film in an amount of from 0.01 to 30% by mass of the cellulose acylate solid content in the film.

Recently, the optical parts for use in liquid-crystal display devices such as television, notebook-size personal computers, mobile terminals and others are required to have high transmittance in order to increase the brightness of the devices with smaller power. To that effect, when the compound having an absorption in the UV range of from 200 to 400 nm and capable of reducing |Re(400)-Re(700)| and |Rth(400)-Rth(700)| is added to the cellulose acylate film, the film is required to have good spectral transmittance. Preferably, the cellulose acylate film is desired to have a spectral transmittance at a wavelength of 380 nm of from 45% to 95% and a spectral transmittance at a wavelength of 350 nm of at most 10%.

Preferably, the UV absorbent favorably used in the invention as described above has a molecular weight of from 250 to 1000 from the viewpoint of the volatility thereof. More preferably, the molecular weight is from 260 to 800, even more preferably from 270 to 800, still more preferably from 300 to 800. Having a molecular weight that falls within the range, the UV absorbent may have a specific monomer structure, or may have an oligomer structure or a polymer structure with a plurality of such monomer units bonding to each other.

Preferably, the UV absorbent does not evaporate during the process of dope casting and drying for cellulose acylate film production.

As specific examples of the UV absorbent for cellulose acylate film favorably used in the invention, for example, there are mentioned the compounds described in JP-A 2006-199855, [0059] to [0135].

Preferably, fine particles as a mat agent are added to the cellulose acylate film. The fine particles usable in the invention include silicon dioxide, titanium dioxide, aluminium oxide, zirconium oxide, calcium carbonate, calcium carbonate, talc, clay, fired kaolin, fired calcium silicate, hydrated calcium silicate, aluminium silicate, magnesium silicate and calcium phosphate. Preferably, the fine particles are those containing silicon from the viewpoint that they do not increase haze, and more preferred is silicon dioxide. Preferably, the fine particles of silicon dioxide have a primary mean particle size of at most 20 nm and an apparent specific gravity of at least 70 g/liter. More preferred are those having a primary mean particle size of from 5 to 16 nm, as not increasing the haze of the film. The apparent specific gravity of the particles is more preferably from 90 to 200 g/liter, even more preferably from 100 to 200 g/liter. Those having a higher apparent specific gravity provide a dispersion having a higher concentration, and are therefore preferred since the film containing them is free from problems of haze and fish eyes.

The fine particles form secondary particles generally having a mean particle size of from 0.1 to 3.0 μm, and in the film, the fine particles exist as aggregates of primary particles and form irregularities of from 0.1 to 3.0 μm on the film surface. The secondary mean particle size is preferably from 0.2 μm to 1.5 μm, more preferably from 0.4 μm to 1.2 μm, most preferably from 0.6 μm to 1.1 μm. Regarding the size of the primary and secondary particles, the particles in the film were observed with a scanning electronic microscope, and the diameter of the circumscribed circle around each particle was measured to be the diameter thereof. At different sites, 200 particles were thus analyzed, and the found data were averaged to give the mean particle size.

As the fine particles of silicon dioxide, for example, commercial products such as AEROSIL R972, R972V, R974, R812, 200, 200V, 300, R202, OX50 and TT600 (all by Nippon Aerosil) are usable here. As the fine particles of zirconium oxide, for example, commercial products such as AEROSIL R976 and R811 (both by Nippon Aerosil) are available and usable here.

Of the above, AEROSIL 200V and AEROSIL R972V are fine particles of silicon dioxide having a primary mean particle size of at most 20 nm and an apparent specific gravity of at least 70 g/liter, and are therefore especially preferred here since these are effective for reducing the friction coefficient of the film while keeping low the haze of the optical film.

For obtaining a cellulose acylate film that contains particles having a small secondary mean particle size in the invention, some methods may be taken into consideration for preparing the dispersion of fine particles. For example, there is mentioned a method in which a fine particle dispersion is previously prepared by mixing a solvent and fine particles with stirring, the fine particle dispersion is added to a small amount of a cellulose acylate solution separately prepared and dissolved with stirring, and further this is mixed with a main cellulose acylate solution (dope). The method is favorable in that the silicon dioxide particles can be well dispersed and that the silicon dioxide particles hardly reaggregate. Apart from this, there is also mentioned a method in which a small amount of a cellulose ester is added to a solvent and dissolved with stirring, and fine particles are added thereto and dispersed with a disperser to give a fine particle additive liquid, and the fine particle additive liquid is well mixed with a dope with an in-line mixer. The invention is not limited to these methods, but preferably, the concentration of silicon dioxide in mixing silicon dioxide fine particles with a solvent and dispersing them is from 5 to 30% by mass, more preferably from 10 to 25% by mass, most preferably from 15 to 20% by mass. The dispersion concentration is preferably higher since the liquid turbidity relative to the amount of the particles added thereto could be lower and the film could be free from problems of haze and fish eyes. The final amount of the mat agent particles to be in the cellulose acylate dope is preferably from 0.01 to 1.0 g/m³, more preferably from 0.03 to 0.3 g/m³, most preferably from 0.08 to 0.16 g/m³.

Lower alcohols are usable as the solvent, and their preferred examples are methyl alcohol, ethyl alcohol, propyl alcohol, isopropyl alcohol, butyl alcohol, etc. Other solvents than lower alcohols are not specifically defined, but preferred are solvents used in cellulose ester film production.

Apart from the compound capable of reducing optical anisotropy and the UV absorbent, other various additives (for example, plasticizer, UV inhibitor, antioxidant, release agent, IR absorbent, etc.) may be added to the cellulose acylate film in accordance with the use thereof, and they may be solid or oily. In other words, they are not specifically defined in point of their melting point and boiling point. For example, UV absorbing materials with 20° C. or lower and with 20° C. or higher may be mixed, or similarly, plasticizers may also be mixed, and for example, these are described in JP-A 2001-151901. IR absorbents are described in, for example, JP-A 2001-194522. The time for addition may be any time in the dope production process, but the additives are preferably added after the dope production process. The amount of the additive to be added is not specifically defined so far as the additive can exhibit its function. In case where the cellulose acylate film has a multilayer configuration, the type and the amount of the additive to be added to each layer may differ. For example, as described in JP-A 2001-151902, the technique is a known one in the art. Its details are described in Hatsumei Kyokai Disclosure Bulletin (No. 2001-1745, published on Mar. 15, 2001 by Hatsumei Kyokai), pp. 16-22; and the materials described in these therein are favorably used here.

The plasticizer is described. A plasticizer is added to some cases but is not added to some other cases in Examples given hereinunder. In case where the compound capable of reducing optical anisotropy also has the effect of plasticizer, it is needless to say that any additional plasticizer is not needed here.

Preferably, the cellulose acylate film is produced according to a solution casting method using a cellulose acylate solution. In preparing the cellulose acylate solution (dope), the dissolution method is not specifically defined. The materials may be dissolved at room temperature or according to a cooling dissolution method or a high-temperature dissolution method, or even according to a combination of these. Regarding the preparation of the cellulose acylate solution in the invention, and further the solution concentration and filtration steps followed by the dissolution step, preferably employed here is the production process described in detail in Hatsumei Kyokai Disclosure Bulletin (No. 2001-1745, published on Mar. 15, 2001 by Hatsumei Kyokai), pp. 22-25.

Preferably, the dope transparency of the cellulose acylate solution is at least 85%. More preferably, it is at least 88%, and even more preferably at least 90%. In the invention, it has been confirmed that various additives fully dissolved in the cellulose acylate dope solution. A concrete computation method for the dope transparency is described. A dope solution is put in a glass cell having a size of 1 cm square, and its absorbance at 550 nm is measured with a spectrophotometer (UV-3150, by Shimadzu). The solvent alone was measured as a blank. From the absorbance ratio to the blank, the transparency of the cellulose acylate solution is computed.

For the method and the apparatus for producing the cellulose acylate film, any conventional solution casting method and solution casting apparatus heretofore used for cellulose acylate film production are usable. The dope (cellulose acylate solution) prepared in a dissolver (tank) is once stored in a reservoir and defoamed therein to finally prepare the dope. The dope is discharged from the discharge port, and fed to a pressure die, for example, via a pressured metering gear pump that enables constant liquid feeding at high accuracy depending on the rotation number thereof, and the dope is thus uniformly cast on a metal support in the casting zone that endlessly running from the slit of the pressure die. At the peeling point at which the metal support goes round nearly once, the wet dope film (referred to as web) is peeled from the metal support. The web is clipped on both sides thereof, and conveyed with a tenter while its width is kept as such, and dried, and subsequently, the obtained film is chemically conveyed into a drying unit with the rolls therein; and after completely dried, the film is wound up for a predetermined length to be a roll with a winder. The combination of the tenter, the rolls and the drying unit may vary depending on the intended object. In the solution casting film formation method for the functional protective film that is an optical part for electronic displays as one main use of the cellulose acylate film, coating units may be additionally provided in many cases in addition to the solution casting film formation unit, for surface treatment of the film for forming thereon a subbing layer, an antistatic layer, an antihalation layer, a protective layer and others. These are described in detail in Hatsumei Kyokai Disclosure Bulletin (No. 2001-1745, published on Mar. 15, 2001 by Hatsumei Kyokai), pp. 25-30, as divided into categories of metal support, drying, peeling and others, and are preferably employed in the invention.

<Lamination with Alignment Control Layer>

The production method for the laminate of the invention preferably includes a first alignment control region forming step of forming the above-mentioned first alignment control region according to the following method (I) or (II), on the transparent support produced according to the above-mentioned method.

Method (I): The first alignment control region is formed on the entire surface of the transparent support.

Method (II): The first alignment control region is formed on a part of the transparent support.

Forming the first alignment control region according to any of these methods gives the laminate of the invention shown in FIG. 4 or FIG. 5.

### (Printing)

The production method for the laminate of the invention preferably includes a step of forming the alignment control layer that contains the first alignment control region and the second alignment control region, according to any one of the following printing steps of (I-A), (I-B) and (II-A).

Printing Step (I-A): The first alignment control region is printed on the transparent support, then the second alignment control region is printed on a part of the first alignment control region, and both the first alignment control region and the second alignment control region are simultaneously processed in one direction.

Printing Step (I-B): The first alignment control region is printed on the transparent support, then the first alignment control region is processed in one direction, and thereafter the second alignment control region is printed on a part of the processed surface of the first alignment controlled region.

Printing Step (II-A): The first alignment control region is printed on a part of the transparent support, the second alignment control region is printed on the other region of the transparent support on which the first alignment control region is not printed, and the first alignment control region and the second alignment control region are simultaneously processed in one direction.

These printing methods are described in order.

In the production method for the laminate of the invention, the printing method for the printing step is not specifically defined, for which is employable any known method. The method of pattern-like printing the alignment film on the support is not specifically defined, for which is employable any method of gravure printing, screen printing, spray coating, spin coating, comma coating, bar coating, knife coating, offset printing, flexographic printing, inkjet printing, dispenser printing or the like. Of those, preferred are flexographic printing and inkjet printing from the viewpoint of the ability to attain micropatterning. In the production method for the laminate of the invention, preferably employed is flexographic printing.

### (Flexographic Printing)

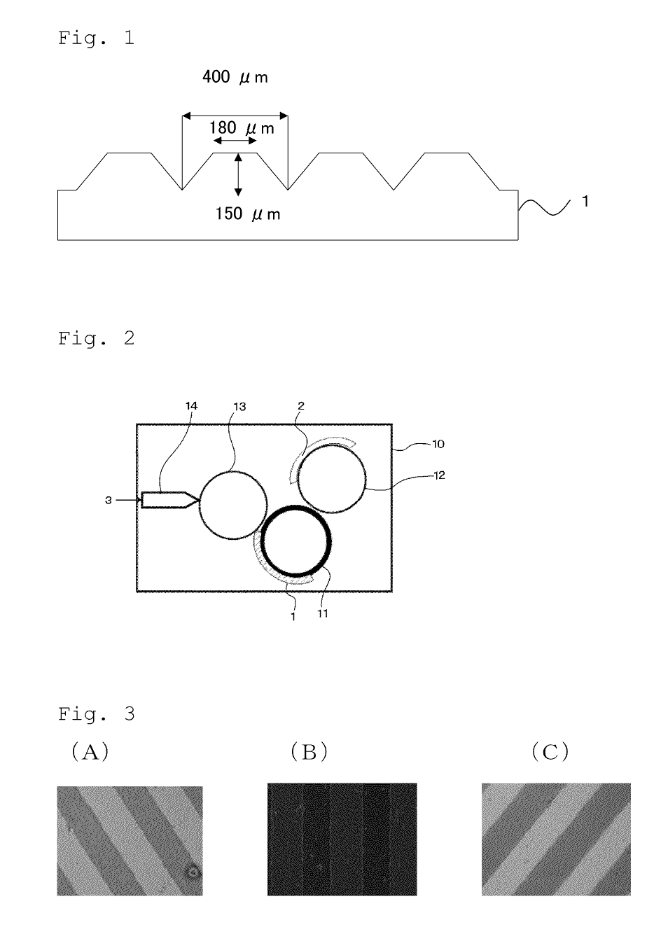

In flexographic printing, preferably employed is a flexographic plate 1 with projections formed on the surface thereof and each having a width corresponding to the pattern of the patterned optical anisotropic layer favorably used in a three-dimensional image display system, as shown in FIG. 1; however, the invention is not limited to the embodiment of FIG. 1.

The method of flexographic printing is shown in FIG. 2. With reference to FIG. 2, a printing step using the flexographic printing apparatus 10 for use in the production method for the laminate of the invention is described. First, a laminate structure is prepared by laminating the entire surface of a transparent support with a parallel alignment film (or vertical alignment film) according to coating or the like. Next, the laminate structure is fitted to the printing roller 12 in such a manner that the parallel alignment film (or vertical alignment film) could face outside. Next, the flexographic plate 1 with an intended pattern formed thereon is fitted to the impression cylinder 11 positioned to face the printing roller 12. Next, a vertical alignment film liquid for patterning (or parallel alignment film liquid for patterning) is fed to the doctor blade 14, and via the anilox roller 13, the vertical alignment film liquid for patterning 3 is transferred onto the projections of the flexographic plate 1 fitted to the impression cylinder 11. The vertical alignment film liquid for pattering 3 that has been transferred onto the projections of the flexographic plate 1 is thereafter transferred onto apart of the parallel alignment film 2 fitted to the printing roller 12.

In the production method for the laminate of the invention, the coating liquid can be directly printed on the transparent support in accordance with the pattern of the desired patterned optical anisotropic layer that is required for three-dimensional image display systems, and therefore, as compared with any other conventional photoalignment method or lithographic method using a photoresist, the productivity of the production method in the invention is extremely enhanced.

### (1) Printing Step (I-A)

In the printing step (I-A), the first alignment control region is printed on the transparent support, and the second alignment control region is printed on a part of the first alignment control region, then both the first alignment control region and the second alignment control region are processed simultaneously in one direction.

In case where the production method for the laminate of the invention comprises the printing step (I-A) to produce a laminate for alignment control of a rod-shaped compound, it is desirable that the first alignment control region printing liquid to be used for printing the first alignment control region contains anyone of a parallel alignment film composition and a vertical alignment film composition and a first alignment control region solvent, and the second alignment control region printing liquid to be used for printing the second alignment control region contains the other compound and a second alignment control region solvent.

In case where a laminate for alignment control of a discotic liquid-crystal compound, it is desirable that the first alignment control region printing liquid to be used for printing the first alignment control region contains any one of a parallel/vertical alignment film composition and a orthogonal/vertical alignment film composition and a first alignment control region solvent, and the second alignment control region printing liquid to be used for printing the second alignment control region contains the other compound and a second alignment control region solvent. However, as mentioned above, the parallel/vertical alignment and the orthogonal/vertical alignment vary depending on the resin material to be used as the main ingredient and also on the presence or absence of additive (pyridinium compound and imidazolium compound) and the production temperature. Accordingly, the production method of the invention is not limited to the embodiment where the parallel/vertical alignment film composition and the orthogonal/vertical alignment film composition are differentiated in use thereof.

A concrete embodiment including a preferred printing step is described below.

First, as the alignment film, a coating liquid of a composition containing, as the main ingredient thereof, an acrylic acid copolymer or a methacrylic acid copolymer containing a recurring unit represented by the general formula (I) and a recurring unit represented by the general formula (II) or (III), or a composition containing, as the main ingredient thereof, a polymer having at least one structural unit represented by any of the general formulae (I-TH), (II-TH) and (III-TH) (alignment film 1) is prepared, and applied onto the entire surface of the support, and a composition containing, as the main ingredient thereof, a modified or unmodified polyvinyl alcohol (alignment film 2) is pattern-like printed thereon, and dried, and thereafter this is rubbed in one direction. According to the process, the laminate of the invention shown in FIG. 4 can be produced.

### (2) Printing Step (I-B)

Printing Step (I-B): The first alignment control region is printed on the transparent support, then the first alignment control region is processed in one direction, and thereafter the second alignment control region is printed on a part of the processed surface of the first alignment controlled region.

In case where the production method for the laminate of the invention comprises the printing step (I-B) and where the laminate is for alignment control of a discotic liquid crystal, for example, it is desirable that the first alignment control region printing liquid for use for printing the first alignment control region contains a parallel/vertical alignment film composition and a first alignment control region solvent, and the second alignment control region printing liquid for use for printing the second alignment control region contains at least one of a pyridinium compound and an imidazolium compound and a second alignment control region solvent.

Also preferably, the first alignment control region printing liquid contains an orthogonal/vertical alignment film composition and a first alignment control region solvent and the second alignment control region printing liquid for use of the second alignment control region contains at least one of a pyridinium compound and an imidazolium compound and a second alignment control region solvent.

In this, it may be desirable, as the case may be, that the second alignment control region printing liquid is for inkjet printing from the viewpoint of increasing the patterning accuracy. Preferred embodiments of inkjet printing in the invention include, for example, the embodiments described in JP-A 2008-26391, 2010-150409, 2010-046822. Of those, the embodiment described in JP-A 2008-26391 is preferred in the present invention.

In the laminate of the invention obtained in these embodiments, the second alignment control region may be printed on the first alignment control region to protrude above it, as shown in FIG. 4. On the other hand, the second alignment control region may penetrate into the first alignment control region so that the surface of the laminate of the invention is flat, as shown in FIG. 5. In any case where the pyridinium compound and the imidazolium compound are arranged above the first alignment control region or are penetrated into the first alignment control region, they may change the alignment control direction of the part of the first alignment control region into which they have penetrated to thereby form the second alignment control region. However, in case where the pyridinium compound and the imidazolium compound are arranged above the first alignment control region, they may be arranged after the first alignment control region has been previously rubbed, or after the second alignment control region has been arranged, they may be rubbed. In case where the first alignment control region is previously rubbed, the second alignment control region (upper layer) as formed to comprise the protruding pyridinium compound and the imidazolium compound could be one not processed in one direction depending on the degree of the penetration of the compound, and in such a case, the processing direction of the second alignment control region is the processing direction of the first (lower layer) alignment control region. This shall apply to any other embodiment where the upper layer is not processed in one direction.

On the other hand, in the process comprising the printing step (I-B), the second alignment control region printing liquid may contain a resin for the second alignment control region. In this case, the combination with the resin that is the main ingredient in the alignment film composition to be contained in the first alignment control region printing liquid is the same as that described hereinabove in the section relating to the laminate of the invention, and the main ingredient resin in the two may be the same or different. In case where the laminate for alignment control of a discotic liquid crystal is produced, any one and/or both of the first alignment control region printing liquid and the second alignment control region printing liquid may contain a pyridinium compound and an imidazolium compound.

### (3) Printing Step (II-A)

Printing Step (II-A): The first alignment control region is printed on a part of the transparent support, the second alignment control region is printed on the other region of the transparent support on which the first alignment control region is not printed, and the first alignment control region and the second alignment control region are simultaneously processed in one direction.

In case where the production method for the laminate of the invention comprises the printing step (II-A), it is desirable that the first alignment control region printing liquid for use for printing the first alignment control region contains any one of a parallel alignment film composition and a vertical alignment film composition, and a first alignment control region solvent, and the second alignment control region printing liquid for use for printing the second alignment control region contains the other compound and a second alignment control region solvent.

The printing step (II-A) is described more concretely. For the alignment film, a composition comprising, as the main ingredient thereof, an acrylic acid copolymer or a methacrylic acid copolymer containing a recurring unit represented by the general formula (I) and a recurring unit represented by the general formula (II) or (III), or a composition comprising, as the main ingredient thereof, a polymer containing at least one structural unit represented by any of the general formulae (I-TH), (II-TH) and (III-TH) (alignment film 1), and a composition containing, as the main ingredient thereof, a modified or unmodified polyvinyl alcohol (alignment film 2) are pattern-like printed so that they are alternately arranged, and then dried, and thereafter rubbed in one direction. The process gives the laminate of the invention shown in FIG. 5.

### (Solvent for Printing Liquid)

In the production method for the laminate of the invention, preferably, the second alignment control region solvent does not substantially dissolve the compounds contained in the first alignment control region printing liquid.

Using the solvent of the type enables patterning with higher accuracy, without mutually evading the boundary between the first alignment region and the second alignment region.

### <Step or Processing in One Direction>

Preferably, the production method for the laminate of the invention includes a step of processing the first alignment control region and the second alignment control region for alignment in one direction. The step of processing in one direction is more preferably a rubbing step in one direction. Alignment in one direction solves the problem of mispositioning to be caused by the difficulty in positioning in mask rubbing.

The rubbing treatment may be carried out generally by rubbing a few times the surface of the film that comprises a polymer as the main ingredient thereof, with paper or cloth in a predetermined direction. General methods of rubbing are described, for example, in “handbook of Liquid Crystal” (published by Maruzen Publishing on Oct. 30, 2000).

For changing the rubbing density, usable is the method described in “handbook of Liquid Crystal” (by Maruzen). The rubbing density (L) is quantified according to the following formula (A):

L=Nl(1+2πrn/60v) Formula (A)

In the formula (A), N means the rubbing frequency, l means the contact length of rubbing roller, r means the radius of roller, n means the rotation number of roller (rpm), and v means the stage moving rate (/sec).

For increasing the rubbing density, the rubbing frequency is increased, or the contact length of rubbing roller is increased, or the radius of roller is increased, or the rotation number of roller is increased, or the stage moving rate is reduced. On the other hand, for reducing the rubbing density, the opposite to the above is taken.

Between the rubbing density and the pretilt angle of the alignment film, there is a relationship that, when the rubbing density is higher, then the pretilt angle is smaller, and when the rubbing density is lower, then the pretilt angle is larger.

In an embodiment where the alignment film is continuously formed on a support of a long polymer film, it is desirable that the direction of rubbing treatment (rubbing direction) is the same as the longitudinal direction of the polymer film.

### [Optical Film]

The optical film of the invention has the laminate of the invention and has, on the alignment control region on the laminate, an optical anisotropic layer formed of a composition comprising a polymerizing group-having liquid crystal as the main ingredient thereof, wherein the optical anisotropic layer comprises a first retardation region and a second retardation region that are alternately patterned and that differ in the in-plane slow axis thereof.

In other words, in the optical film of the invention, the first retardation region and the second retardation region are formed within the region of optical anisotropic layer corresponding to the orthogonal projection in the vertical direction to the film surface of the first alignment control region and the second alignment control region, respectively, in the surface of the alignment control layer.

The optical film having the configuration as above can form a good three-dimensional image when incorporated in a three-dimensional image display system.

### [Optical Anisotropic Layer]

Preferably, the optical anisotropic layer in the invention has the function of a λ/4 plate, or that is, the function of converting linear polarization to circular polarization. Various methods are known for forming the optical anisotropic layer having the function as a λ/4 plate. Especially in the invention, it is desirable that the layer is formed by polymerizing and fixing a polymerizing group-having rod-shaped liquid-crystal compound or discotic liquid-crystal compound while kept in horizontal alignment or vertical alignment.

Preferably, in the optical film of the invention, the optical anisotropic layer has at least one of a parallel alignment region and a vertical alignment region as the first retardation region and the second retardation region. The parallel alignment region and the vertical alignment region as referred to herein mean, when the polymerizing group-having liquid crystal is a rod-shaped liquid crystal, a region where the long axis of the rod-shaped liquid-crystal compound is horizontal relative to the layer surface in the optical anisotropic layer and is in the parallel direction relative to the alignment treatment direction (for example, in the rubbing direction), and the region where the long axis is horizontal relative to the layer surface and is in the vertical direction relative to the alignment treatment direction, respectively.

On the other hand, in case where the polymerizing group-having liquid crystal is a discotic liquid crystal, the parallel alignment region and the vertical alignment region in the optical film of the invention mean the region in the optical anisotropic layer in which the discotic liquid-crystal molecules are aligned in a vertical alignment state with their discotic faces kept vertically relative to the layer surface and the long axes thereof (in the direction in which the discotic surfaces are connected in series) is in the parallel direction relative to the alignment treatment direction (for example, in the rubbing direction, and the region in which the discotic liquid-crystal molecules are aligned in a vertical alignment state and the long axes thereof are in the vertical direction relative to the alignment treatment direction.

In the optical anisotropic layer in the optical film of the invention, preferably, the first retardation region and the second retardation region are alternately belt-like patterned so as to have long sides parallel to one side of the optical anisotropic layer, and the in-plane slow axis of the first retardation region is nearly vertical to the in-plane slow axis of the second retardation region.

Preferably, in the optical anisotropic layer in the invention, the first region and the second region are both belt-like regions of which the length of the short side is nearly the same, from the viewpoint of using the optical film in 3D image display systems.

The thickness of the optical anisotropic layer to be formed in the manner as above is not specifically defined, but is preferably from 0.1 to 10 μm, more preferably from 0.5 to 5 μm.

### <Polymerizing Group-Having Liquid Crystal>

### (Rod-Shaped Liquid Crystal)

As the polymerizing group-having liquid-crystal compound usable as the main material of the optical anisotropic layer in the invention, there are mentioned a polymerizing group-having rod-shaped liquid crystal and a polymerizing group-having discotic liquid crystal. Preferred is a polymerizing group-having discotic liquid crystal.

The rod-shaped liquid crystal may be selected for use herein from, for example, the compounds described in publications of Makromol. Chem., Vol. 190, p. 2255 (1989), Advanced Materials, Vol. 5, p. 107 (1993), U.S. Pat. No. 4,683,327, U.S. Pat. No. 5,622,648, U.S. Pat. No. 5,770,107, WO95/22586, WO95/24455, WO97/00600, WO98/23580, WO98/52905, JP-A 1-272551, JP-A 6-16616, JP-A 7-110469, JP-A 11-80081, JP-A 11-513019 and Japanese Patent Application 2001-64627.

As the low-molecular rod-shaped liquid-crystal compound, preferred are the compounds represented by the following general formula (X):

Q¹-L¹-Cy¹-L²-(Cy²-L³)ₙ-Cy³-L⁴-Q² General Formula (X)

In the formula, Q¹ and Q² each independently represent a polymerizing group; L¹ and L⁴ each independently represent a divalent linking group; L² and L³ each independently represent a single bond or a divalent linking group, Cy¹, Cy² and Cy³ each independently represent a divalent cyclic group; and n indicates 0, 1 or 2.

In the formula, Q¹ and Q² each independently represent a polymerizing group. Preferably, the polymerization reaction of the polymerizing group is addition polymerization (including ring-opening polymerization) or a condensation polymerization. In other words, the polymerizing group is preferably a functional group capable of undergoing addition polymerization reaction or condensation polymerization reaction.

In the optical film of the invention, it is desirable that the polymerizing group-having liquid crystal is a rod-shaped liquid crystal and the rod-shaped liquid crystal is fixed in a horizontal alignment state in the optical anisotropic layer. Preferably, the rod-shaped liquid crystal is fixed in a horizontal alignment state by the use of a compound of promoting horizontal alignment to be mentioned below.

### (Discotic Liquid Crystal)

The discotic liquid crystal capable of being used as the main material in the optical anisotropic layer of the optical film of the invention is a polymerizing group-having compound as mentioned above.

Preferably, the polymerizing group-having discotic liquid crystal is a compound represented by the following general formula (I):

D(-L-H-Q)ₙ General Formula (I)

In the formula, D represents a discotic core; L represents a divalent linking group; H represents a divalent aromatic ring or hetero ring; Q represents a polymerizing group; and n indicates an integer of from 3 to 12.

The discotic core (D) is preferably a benzene ring, a naphthalene ring, a triphenylene ring, an anthraquinone ring, a truxene ring, a pyridine ring, a pyrimidine ring or a triazine ring, and more preferably a benzene ring, a triphenylene ring, a pyridine ring, a pyrimidine ring or a triazine ring.

L is preferably a divalent linking group selected from the group consisting of *—O—CO—, *—CO—O—, *—CH═CH—, *—C≡C— and a combination of thereof, and is especially preferably a divalent linking group containing any one or at least one or more of *—CH═CH— and *—C≡C—. In this, * indicates the position at which the group bonds to D in the general formula (I).

When H is an aromatic ring, it is preferably a benzene ring or a naphthalene ring, and is more preferably a benzene ring. When H is a hetero ring, it is preferably a pyridine ring or a pyrimidine ring, and is more preferably a pyridine ring. Especially preferably, H is an aromatic ring.

The polymerization reaction of the polymerizing group Q is preferably addition polymerization (including ring-opening polymerization) or condensation polymerization. In other words, the polymerizing group is preferably a functional group capable of undergoing addition polymerization reaction or condensation polymerization reaction. Above all, the polymerizing group is preferably a (meth)acrylate group or an epoxy group.

The discotic liquid crystal represented by the above-mentioned general formula (I) is more preferably a discotic liquid crystal represented by the following general formula (II) or (III).

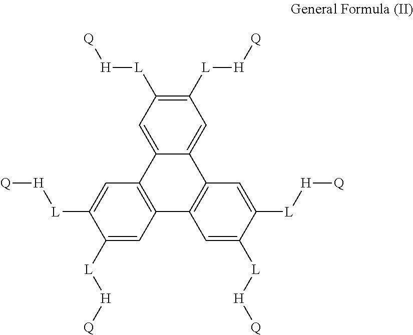

In the formula, L, H, and Q have the same meanings as those of L, H and Q in the above-mentioned general formula (I), and their preferred ranges are also the same as those of the latter.

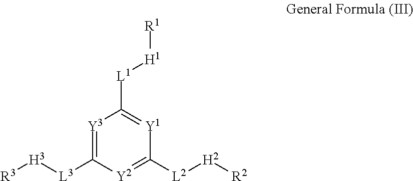

In the formula, Y¹, Y² and Y³ are the same meanings as those of Y¹¹, Y¹² and Y¹³ in the general formula (IV) to be mentioned below, and their preferred ranges are also the same as those of the latter. L¹, L², L³, H¹, H², H³, R¹, R² and R³ have the same meanings as those of L¹, L², L³, H¹, H², H³, R¹, R² and R³ in the general formula (IV) to be mentioned below, and their preferred ranges are also the same as those of the latter.

As described below, the discotic liquid crystal having multiple aromatic rings in the molecule as represented by the general formulae (I), (II), (III) and (IV) undergoes intermolecular π-π interaction with the pyridinium compound or the imidazolium compound which is used as an alignment-controlling agent, therefore realizing vertical alignment. In particular, for example, in the general formula (II), in case where L is a divalent linking group containing any one or at least one or more of *—CH═CH— and *—C≡C—, and in the general formula (III), in case where plural aromatic rings and hetero rings are linked together via a single bond, the free rotation of bonding is strongly restrained by the linking group to secure the linearity of the molecule whereby the liquid crystallinity of the compound is enhanced and stable vertical alignment can be realized owing to the stronger intermolecular π-π interaction occurring in the compound.

Preferably, the discotic liquid crystal is a compound represented by the following general formula (IV):

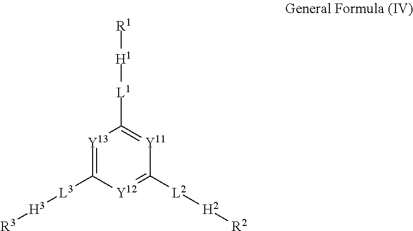

In the formula, Y¹¹, Y¹² and Y¹³ each independently represent an optionally substituted methine group or a nitrogen atom.

In case where Y¹¹, Y¹² and Y¹³ each are a methine group, the hydrogen atom of the methine group may be replaced with a substituent. Preferred examples of the substituent that the methine group may have include an alkyl group, an alkoxy group, an aryloxy group, an acyl group, an alkoxycarbonyl group, an acyloxy group, an acylamino group, an alkoxycarbonylamino group, an alkylthio group, an arylthio group, a halogen atom and a cyano group. Of those substituents, more preferred are an alkyl group, an alkoxy group, an alkoxycarbonyl group, an acyloxy group, a halogen atom and a cyano group; and even more preferred are an alkyl group having from 1 to 12 carbon atoms, an alkoxy group having from 1 to 12 carbon atoms, an alkoxycarbonyl group having from 2 to 12 carbon atoms, an acyloxy group having from 2 to 12 carbon atoms, a halogen atom and a cyano group.

More preferably, Y¹¹, Y¹² and Y¹³ each are a methine group from the viewpoint of the easiness and the cost in producing the compound. More preferably, the methine group is unsubstituted.

L¹, L² and L³ each independently represent a single bond or a divalent linking group.

When L¹, L² and L³ each are a divalent group, preferably, they are independently a divalent linking group selected from the group consisting of —O—, —S—, —C(═O)—, —NR⁷—, —CH═CH—, —C≡C—, a divalent cyclic group or a combination thereof. R⁷ represents an alkyl group having from 1 to 7 carbon atoms, or a hydrogen atom, preferably an alkyl group having from 1 to 4 carbon atoms, or a hydrogen atom, more preferably a methyl group, an ethyl group or a hydrogen atom, and most preferably a hydrogen atom.

The divalent cyclic group for L¹, L² and L³ is a divalent linking group having at least one cyclic structure (hereinafter this may be referred to as a cyclic group). The cyclic group is preferably a 5-membered ring, a 6-membered ring or a 7-membered ring, more preferably a 5-membered ring or a 6-membered ring, most preferably a 6-membered ring. The ring to constitute the cyclic group may be a condensed ring. However, The ring is more preferably a single ring than a condensed ring. The ring to constitute the cyclic group may be any of an aromatic ring, an aliphatic ring and a hetero ring. Preferred examples of the aromatic ring include a benzene ring and a naphthalene ring. Preferred examples of the aliphatic ring include a cyclohexane ring. Preferred examples of the hetero ring include a pyridine ring and a pyrimidine ring. The cyclic group is more preferably an aromatic ring or a hetero ring. The divalent cyclic group in the invention is more preferably a divalent linking group comprising a cyclic structure alone (however, including a substituent) (the same shall apply hereinunder).

Of the divalent cyclic group represented by L¹, L² and L³, the cyclic group having a benzene ring is preferably a 1,4-phenylene group. The cyclic group having a naphthalene ring is preferably a naphthalene-1,5-diyl group or a naphthalene-2,6-diyl group. The cyclic group having a cyclohexane ring is preferably a 1,4-cyclohexylene group. The cyclic group having a pyridine ring is preferably a pyridine-2,5-diyl group. The cyclic group having a pyrimidine ring is preferably a pyrimidine-2,5-diyl group.

The divalent cyclic group represented by L¹, L² and L³ may have a substituent. The substituent includes a halogen atom (preferably a fluorine atom, a chlorine atom), a cyano group, a nitro group, an alkyl group having from 1 to 16 carbon atoms, an alkenyl group having from 2 to 16 carbon atoms, an alkynyl group having from 2 to 16 carbon atoms, a halogen-substituted alkyl group having from 1 to 16 carbon atoms, an alkoxy group having from 1 to 16 carbon atoms, acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, a carbamoyl group substituted with an alkyl group having from 2 to 16 carbon atoms, and an acylamino group having from 2 to 16 carbon atoms.

L¹, L² and L³ each are preferably a single bond, *—O—CO—, *—CO—O—, *—CH═CH—, *—C≡C—, *-divalent cyclic group-, *—O—CO-divalent cyclic group-, *—CO—O-divalent cyclic group, *—CH═CH-divalent cyclic group-, *—C≡C-divalent cyclic group-, *-divalent cyclic group-O—CO—, *-divalent cyclic group-CO—O—, *-divalent cyclic group-CH═CH— or *-divalent cyclic group-C≡C—. More preferred are a single bond, *—CH═CH—, *—C≡C—. *—CH═CH-divalent cyclic group- and *—C≡C-divalent cyclic group-; and most preferred is a single bond. In this, * indicates the position at which the group bonds to the 6-membered ring containing Y¹¹, Y¹² and Y¹³ in the general formula (IV).

In the general formula (I), H¹, H² and H³ each independently represent a group of the following general formula (IV-A) or (IV-B):

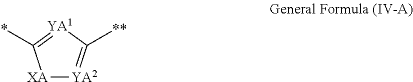

In the general formula (IV-A), YA¹ and YA² each independently represent a methine group or a nitrogen atom;

XA represents an oxygen atom, a sulfur atom, methylene or imino;

* indicates the position at which the group bonds to any of L¹ to L³ in the general formula (IV);

** indicates the position at which the group bonds to any of R¹ to R³ in the general formula (IV).

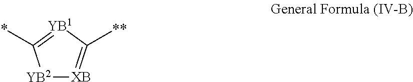

In the general formula (IV-B), YB¹ and YB² each independently represent a methine group or a nitrogen atom;

XB represents an oxygen atom, a sulfur atom, methylene or imino;

* indicates the position at which the group bonds to any of L¹ to L³ in the general formula (IV);

** indicates the position at which the group bonds to any of R¹ to R³ in the general formula (IV).

In the general formula (IV), R¹, R² and R³ each independently represent the following general formula (IV-R):

*-(-L²¹-Q²)ₙ₁-L²²-L²³-Q¹ General Formula (IV-R)

In the general formula (IV-R), * indicates the position at which the group bonds to any of H¹ to H³ in the general formula (IV).

L²¹ represents a single bond or a divalent linking group. When L²¹ is a divalent linking group, it is preferably a divalent linking group selected from the group consisting of —O—, —S—, —C(═O)—, —NR⁷—, —CH═CH—, —C≡C— and a combination thereof. R⁷ represents an alkyl group having from 1 to 7 carbon atoms, or a hydrogen atom, and is preferably an alkyl group having from 1 to 4 carbon atoms, or a hydrogen atom, more preferably a methyl group, an ethyl group or a hydrogen atom, most preferably a hydrogen atom.

L²¹ is preferably any of a single bond, ***—O—CO—, ***—CO—O—, ***—CH═CH— and ***—C≡C— (in which *** indicates the side of * in the general formula (DI-R)), and more preferably a single bond.

Q² represents a divalent group having at least one cyclic structure (cyclic group). The cyclic group of the type is preferably a cyclic group having a 5-membered ring, a 6-membered ring or a 7-membered ring, more preferably a cyclic group having a 5-membered ring or a 6-membered ring, even more preferably a cyclic group having a 6-membered ring. The cyclic structure to constitute the cyclic group may be a condensed ring. However, the group is more preferably a single ring than a condensed ring. The ring to constitute the cyclic group may be any of an aromatic ring, an aliphatic ring and a hetero ring. Preferred examples of the aromatic ring include a benzene ring, a naphthalene ring, an anthracene ring and a phenanthrene ring. Preferred examples of the aliphatic ring include a cyclohexane ring. Preferred examples of the hetero ring include a pyridine ring and a pyrimidine ring.

Of Q², the cyclic group having a benzene ring is preferably a 1,4-phenylene group. The cyclic group having a naphthalene ring is preferably a naphthalene-1,4-diyl group, a naphthalene-1,5-diyl group, a naphthalene-1,6-diyl group, a naphthalene-2,5-diyl group, a naphthalene-2,6-diyl group or a naphthalene-2,7-diyl group. The cyclic group having a cyclohexane ring is preferably a 1,4-cyclohexylene group. The cyclic group having a pyridine ring is preferably a pyridine-2,5-diyl group. The cyclic group having a pyrimidine ring is preferably a pyrimidine-2,5-diyl group. Of those, more preferred are a 1,4-phenylene group, a naphthalene-2,6-diyl group and a 1,4-cyclohexylene group.

Q² may have a substituent. Examples of the substituent include a halogen atom (fluorine atom, chlorine atom, bromine atom, iodine atom), a cyano group, a nitro group, an alkyl group having from 1 to 16 carbon atoms, an alkenyl group having from 2 to 16 carbon atoms, an alkynyl group having from 2 to 16 carbon atoms, a halogen-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl-substituted carbamoyl group having from 2 to 16 carbon atoms, and an acylamino group having from 2 to 16 carbon atoms. Of those, preferred are a halogen atom, a cyano group, an alkyl group having from 1 to 6 carbon atoms, and a halogen-substituted alkyl group having from 1 to 6 carbon atoms; more preferred are a halogen atom, an alkyl group having from 1 to 4 carbon atoms, and a halogen-substituted alkyl group having from 1 to 4 carbon atoms; and even more preferred are a halogen atom, an alkyl group having from 1 to 3 carbon atoms, and a trifluoromethyl group.

n1 indicates an integer of from 0 to 4. n1 is preferably an integer of from 1 to 3, more preferably 1 or 2.

L²² represents **—O—, **—O—CO—, **—CO—O—, **—O—CO—O—, **—S—, **—NH—, **—SO₂—, **—CH₂—, **—CH═CH— or **—C≡C—, and ** indicates the position at which the group bonds to Q² in the formula.

L²² is preferably **—O—, **—O—CO—, **—CO—O—, **—O—CO—O—, **—CH₂—, **—CH═CH— or **—C≡C—, more preferably **—O—, **—O—CO—, **—O—CO—O— or **—CH₂—. When L²² is a group having a hydrogen atom, the hydrogen atom may be substituted with a substituent. Preferred examples of the substituent include a halogen atom, a cyano group, a nitro group, an alkyl group having from 1 to 6 carbon atoms, a halogen-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, an alkyl-substituted carbamoyl group having from 2 to 6 carbon atoms, and an acylamino group having from 2 to 6 carbon atoms. More preferred are a halogen atom and an alkyl group having from 1 to 6 carbon atoms.

L²³ represents a divalent linking group selected from the group consisting of —O—, —S—, —C(═O)—, —SO₂—, —NH—, —CH₂—, —CH═CH— and —C≡C— and a combination thereof. In this, the hydrogen atom in —NH—, —CH₂— and —CH═CH— may be substituted with a substituent. Preferred examples of the substituent include a halogen atom, a cyano group, a nitro group, an alkyl group having from 1 to 6 carbon atoms, a halogen-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, an alkyl-substituted carbamoyl group having from 2 to 6 carbon atoms, and an acylamino group having from 2 to 6 carbon atoms. More preferred are a halogen atom and an alkyl group having from 1 to 6 carbon atoms. Substituted with any of these substituents, the liquid-crystal compound enables the solubility thereof in the solvent to be used in preparing a liquid-crystal composition containing the compound.

L²³ is preferably selected from the group consisting of —O—, —C(═O)—, —CH₂—, —CH═CH— and —C≡C— and a combination thereof. L²³ preferably has from 1 to 20 carbon atoms, more preferably from 2 to 14 carbon atoms. Also preferably, L²³ has from 1 to 16 (—CH₂—)s, even more preferably from 2 to 12 (—CH₂—)s.

Q¹ represents a polymerizing group or a hydrogen atom. In case where the liquid-crystal compound of the invention is used in an optical film of which the retardation is desired not to change by heat, such as an optical compensation film, Q¹ is preferably a polymerizing group. The polymerization reaction is preferably addition polymerization (including ring-opening polymerization) or condensation polymerization. In other words, the polymerizing group is preferably a functional group capable of undergoing addition polymerization reaction or condensation polymerization reaction. Preferred examples of the polymerizing group are shown below.

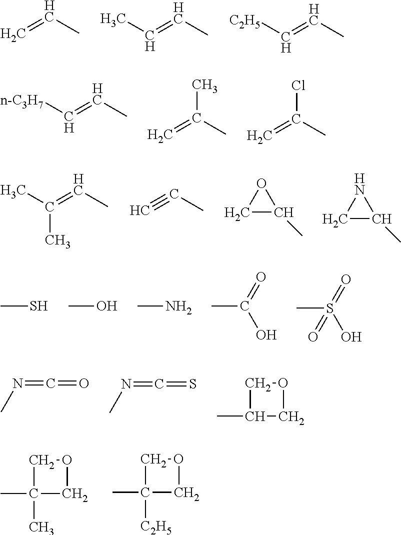

Further, the polymerizing group is especially preferably a functional group capable of undergoing addition polymerization reaction. The polymerizing group of the type is preferably a polymerizing ethylenic unsaturated group or a ring-opening polymerizing group.

Examples of the polymerizing ethylenic unsaturated group include the following formulae (M-1) to (M-6):

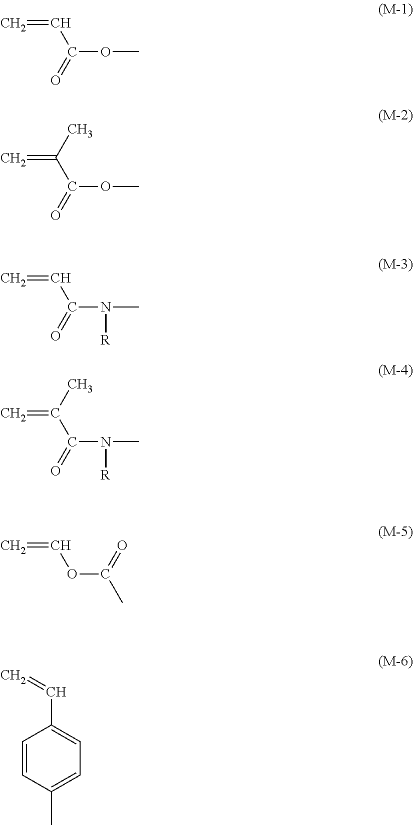

In the formulae (M-3) and (M-4), R represents a hydrogen atom or an alkyl group, and is preferably a hydrogen atom or a methyl group.

Of the above-mentioned formulae (M-1) to (M-6), preferred are (M-1) and (M-2), and more preferred is (M-1).

The ring-opening polymerizing group is preferably a cyclic ether group, and more preferably an epoxy group or an oxetanyl group.

Of the compounds of the above-mentioned formula (IV), more preferred are the compounds represented by the following general formula (IV′):

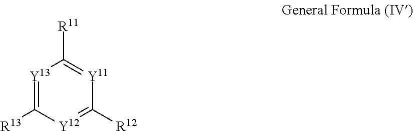

In the general formula (IV′), Y¹¹, Y¹² and Y¹³ each independently represent a methine group or a nitrogen atom, and is preferably a methine group. The methine group is preferably unsubstituted.

R¹¹, R¹² and R¹³ each independently represent the following general formula (IV′-A), (IV′-B) or (IV′-C). In case where the wavelength dispersion of intrinsic birefringence of the compound is desired to be small, preferred is the general formula (IV′-A) or (IV′-C), and more preferred is the general formula (IV′-A). Preferably, R¹¹, R¹² and R¹³ are R¹¹═R¹²═R¹³.

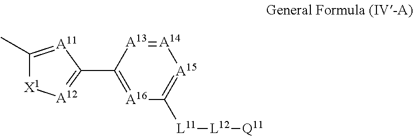

In the general formula (IV′-A), A¹¹, A¹², A¹³, A¹⁴, A¹⁵ and A¹⁶ each independently represent a methine group or a nitrogen atom.

At least one of A¹¹ and A¹² is preferably a nitrogen atom, and more preferably, both are nitrogen atoms.

Of A¹³, A¹⁴, A¹⁵ and A¹⁶, at least three are preferably methine groups, and more preferably all are methine groups. Further, the methine groups are preferably unsubstituted.

Examples of the substituent of the methine group for A¹¹, A¹², A¹³, A¹⁴, A¹⁵ and A¹⁶ include a halogen atom (fluorine atom, chlorine atom, bromine atom, iodine atom), a cyano group, a nitro group, an alkyl group having from 1 to 16 carbon atoms, an alkenyl group having from 2 to 16 carbon atoms, an alkynyl group having from 2 to 16 carbon atoms, a halogen-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl-substituted carbamoyl group having from 2 to 16 carbon atoms, and an acylamino group having from 2 to 16 carbon atoms. Of those, preferred are a halogen atom, a cyano group, an alkyl group having from 1 to 6 carbon atoms, and a halogen-substituted alkyl group having from 1 to 6 carbon atoms; more preferred are a halogen atom, an alkyl group having from 1 to 4 carbon atoms, and a halogen-substituted alkyl group having from 1 to 4 carbon atoms; and even more preferred are a halogen atom, an alkyl group having from 1 to 3 carbon atoms, and a trifluoromethyl group.

X¹ represents an oxygen atom, a sulfur atom, methylene or imino, and is preferably an oxygen atom.

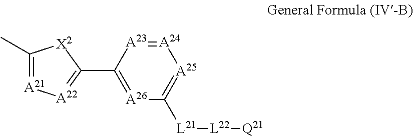

In the general formula (IV′-B), A²¹, A²², A²³, A²⁴, A²⁵ and A²⁶ each independently represent a methine group or a nitrogen atom.

At least one of A²¹ and A²² is preferably a nitrogen atom, and more preferably, both are nitrogen atoms.

Of A²³, A²⁴, A²⁵ and A²⁶, at least three are preferably methine groups, and more preferably all are methine groups.

Examples of the substituent of the methine group for A²¹, A²², A²³, A²⁴, A²⁵ and A²⁶ include a halogen atom (fluorine atom, chlorine atom, bromine atom, iodine atom), a cyano group, a nitro group, an alkyl group having from 1 to 16 carbon atoms, an alkenyl group having from 2 to 16 carbon atoms, an alkynyl group having from 2 to 16 carbon atoms, a halogen-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl-substituted carbamoyl group having from 2 to 16 carbon atoms, and an acylamino group having from 2 to 16 carbon atoms. Of those, preferred are a halogen atom, a cyano group, an alkyl group having from 1 to 6 carbon atoms, and a halogen-substituted alkyl group having from 1 to 6 carbon atoms; more preferred are a halogen atom, an alkyl group having from 1 to 4 carbon atoms, and a halogen-substituted alkyl group having from 1 to 4 carbon atoms; and even more preferred are a halogen atom, an alkyl group having from 1 to 3 carbon atoms, and a trifluoromethyl group.

X² represents an oxygen atom, a sulfur atom, methylene or imino, and is preferably an oxygen atom.

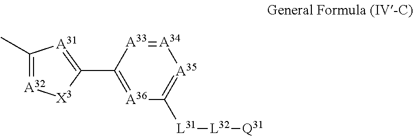

In the general formula (IV′-C), A³¹, A³², A³³, A³⁴, A³⁵ and A³⁶ each independently represent a methine group or a nitrogen atom.

At least one of A³¹ and A³² is preferably a nitrogen atom, and more preferably, both are nitrogen atoms.

Of A³³, A³⁴, A³⁵ and A³⁶, at least three are preferably methine groups, and more preferably all are methine groups.

In case where A³¹, A³², A³³, A³⁴, A³⁵ or A³⁶ is a methine group, the methine group may have a substituent. Examples of the substituent include a halogen atom (fluorine atom, chlorine atom, bromine atom, iodine atom), a cyano group, a nitro group, an alkyl group having from 1 to 16 carbon atoms, an alkenyl group having from 2 to 16 carbon atoms, an alkynyl group having from 2 to 16 carbon atoms, a halogen-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl-substituted carbamoyl group having from 2 to 16 carbon atoms, and an acylamino group having from 2 to 16 carbon atoms. Of those, preferred are a halogen atom, a cyano group, an alkyl group having from 1 to 6 carbon atoms, and a halogen-substituted alkyl group having from 1 to 6 carbon atoms; more preferred are a halogen atom, an alkyl group having from 1 to 4 carbon atoms, and a halogen-substituted alkyl group having from 1 to 4 carbon atoms; and even more preferred are a halogen atom, an alkyl group having from 1 to 3 carbon atoms, and a trifluoromethyl group.

X³ represents an oxygen atom, a sulfur atom, methylene or imino, and is preferably an oxygen atom.

L¹¹ in the general formula (IV′-A), L²¹ in the general formula (IV′-B) and L³¹ in the general formula (IV′-C) each independently represent —O—, —C(═O)—, —O—CO—, —CO—O—, —O—CO—O—, —S—, —NH—, —SO₂—, —CH₂—, —CH═CH— or —C≡C—. Preferred is —O—, —C(═O)—, —O—CO—, —CO—O—, —O—CO—O—, —CH₂—, —CH═CH— or —C≡C—; and more preferred is —O—, —O—CO—, —CO—O—, —O—CO—O— or —C≡C—. In particular, small wavelength dispersion of intrinsic birefringence of the compound is expected. L¹¹ in the general formula (DI-A) is more preferably —O—, —CO—O— or —C≡C—. Of those, even more preferred is —CO—O—, as the compound can express a discotic nematic phase at a higher temperature. In case where the above-mentioned group contains a hydrogen atom, the hydrogen atom may be substituted with a substituent. Preferred examples of the substituent include a halogen atom, a cyano group, a nitro group, an alkyl group having from 1 to 6 carbon atoms, a halogen-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, an alkyl-substituted carbamoyl group having from 2 to 6 carbon atoms and an acylamino group having from 2 to 6 carbon atoms. More preferred are a halogen atom, and an alkyl group having from 1 to 6 carbon atoms.

L¹² in the general formula (IV′-A), L²² in the general formula (IV′-B) and L³² in the general formula (IV′-C) each independently represent a divalent linking group selected from the group consisting of —O—, —S—, —C(═O)—, —SO₂—, —NH—, —CH₂—, —CH═CH— and —C≡C— and a combination thereof. In this, the hydrogen atom in —NH—, —CH₂— and —CH═CH— may be substituted with a substituent. Preferred examples of the substituent include a halogen atom, a cyano group, a nitro group, a hydroxyl group, a carboxyl group, an alkyl group having from 1 to 6 carbon atoms, a halogen-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, an alkyl-substituted carbamoyl group having from 2 to 6 carbon atoms, and an acylamino group having from 2 to 6 carbon atoms. More preferred are a halogen atom, a hydroxyl group and an alkyl group having from 1 to 6 carbon atoms; and even more preferred are a halogen atom, a methyl group and an ethyl group.

Preferably, L¹², L²² and L³² are each independently selected from the group consisting of —O—, —C(═O)—, —CH₂—, —CH—CH— and —C≡C— and a combination thereof.

Preferably, L¹², L²² and L³² have each independently from 1 to 20 carbon atoms, more preferably from 2 to 14 carbon atoms. Also preferably, these each have from 2 to 14 carbon atoms and have from 1 to 16 (—CH₂—)s, even more preferably from 2 to 12 (—CH₂—)s.

The number of the carbon atoms constituting L¹², L²² and L³² has some influence on phase transition temperature of the liquid crystal and on the solubility of the compound in solvent. In general, when the carbon number increases, then the transition temperature from the discotic nematic phase (N_{D} phase) to the isotropic liquid tends to lower. Also in general, the solubility in solvent tends to increase when the carbon number increases.

Q¹¹ in the general formula (IV′-A), Q²¹ in the general formula (IV′-B) and Q³¹ in the general formula (IV′-C) each independently represent a polymerizing group or a hydrogen atom. Preferably, Q¹¹, Q²¹ and Q³¹ each are a polymerizing group. The polymerization reaction is preferably addition polymerization (including ring-opening polymerization) or condensation polymerization. In other words, the polymerizing group is preferably a functional group capable of undergoing addition polymerization reaction or condensation polymerization reaction. Examples of the polymerizing group are the same as those mentioned above, and preferred examples thereof are also the same as above.

Specific examples of the compound represented by the general formula (IV) include the exemplary compounds described in JP-A 2006-76992, [0052], [Chemical Formula 13] to [Chemical Formula 43], and the exemplary compounds described in JP-A 2007-2220, [0040], [Chemical Formula 36] of [Chemical Formula 13] to [Chemical Formula 43]. However, the invention is not limited to these compounds.

The above-mentioned compounds may be synthesized according to various methods. For example, they may be synthesized according to the method described in JP-A 2007-2220, [0064] to [0070].

Preferably, the discotic liquid-crystal compound exhibit a columnar phase and a discotic nematic phase (N_{D} phase) as the liquid crystal phase thereof, and of those liquid crystal phases, more preferred is a discotic nematic phase (N_{D} phase) showing good monodomain performance.

Of the above-mentioned discotic liquid-crystal compounds, preferred are those capable of expressing the liquid crystal phase thereof at a temperature falling within a range of from 20° C. to 300° C., more preferably from 40° C. to 280° C., even more preferably from 60° C. to 250° C. The behavior that the compound exhibit the liquid crystal phase at from 20° C. to 300° C. is meant to include a case where the liquid crystal temperature range strides across 20° C. (for example, from 10° C. to 22° C.), or a case where the liquid crystal temperature range strides across 300° C. (for example, from 298° C. to 310° C.). The same shall apply to the expression of from 40° C. to 280° C., and from 60° C. to 250° C.

The discotic liquid crystal represented by the above-mentioned general formula (IV) has multiple aromatic rings in the molecule, and therefore provides a strong intermolecular π-π interaction with a pyridinium compound or a imidazolium compound, as will be mentioned below, therefore increasing the tilt angle of the discotic liquid crystal at around the interface thereof to the alignment film containing the liquid crystal. In particular, in the discotic liquid crystal represented by the general formula (IV′), multiple aromatic rings are linked together via a single bond, and consequently, the compound has a molecular structure with high linearity that restrains the rotational freedom of the molecule thereof, therefore providing a stronger intermolecular π-π interaction with a pyridinium compound or a imidazolium compound and increasing the tilt angle of the discotic liquid crystal at around the interface thereof to the alignment film containing the liquid crystal.

In case where a rod-shaped liquid-crystal compound is used, preferably, the rod-shaped liquid crystal is horizontally aligned. In this description, “horizontal alignment” means that the long axis of the rod-shaped liquid crystal is parallel to the layer surface. This does not require any strict parallel state, but in this description, this alignment state means that the tilt angle to the horizontal face is less than 10 degrees. The tilt angle is preferably from 0 to 5 degrees, more preferably from 0 to 3 degrees, even more preferably from 0 to 2 degrees, most preferably from 0 to 1 degree.

An additive capable of promoting horizontal alignment of liquid crystal may be added to the above-mentioned composition, and examples of the additive include the compounds described in JP-A 2009-223001, [0055] to [0063].

In case where a discotic liquid crystal is used here, preferably, the discotic liquid crystal is vertically aligned. In this description, “vertical alignment” means that the discotic face of the discotic liquid crystal is vertical to the layer surface. This does not require any strict vertical state, but in this description, this alignment state means that the tilt angle to the horizontal face is not less than 70 degrees. The tilt angle is preferably from 85 to 90 degrees, more preferably from 87 to 90 degrees, even more preferably from 88 to 90 degrees, most preferably from 89 to 90 degrees.

An additive capable of promoting vertical alignment of liquid crystal may be added to the above-mentioned composition, and examples of the additive are as described above.

In the optical anisotropic layer in which a liquid-crystal compound is aligned, it is difficult to measure directly and accurately the tilt angle (the tilt angle means the angle between the physical symmetric axis in a liquid-crystal compound and the interface of the optical anisotropic layer) θ1 on one surface of the optical anisotropic layer and the tilt angle θ2 on the other surface thereof. Consequently, in this description, θ1 and θ2 are computed according to the method mentioned below. This method could not accurately express the actual alignment state in the present invention, but is effective as a means of expressing the relative relationship of apart of optical characteristics that an optical film has.

For facilitating the computation in this method, the following two matters are estimated to provide the tilt angle at the two interfaces of an optical anisotropic layer.

1. The optical anisotropic layer is estimated as a multilayer layer comprising a layer that contains a liquid-crystal compound. Further, the minimal unit layer constituting it (the tilt angle of the liquid-crystal compound is estimated as uniform in the layer) is estimated as optically monoaxial.

2. The tilt angle in each layer is estimated as monotonously varying as a linear function along the thickness direction of the optical anisotropic layer.

A concrete computation method is as follows.

(1) In the plane in which the tilt angle in each layer monotonously varies as a linear function along the thickness direction of the optical anisotropic layer, the incident angle of the measurement light running into the optical anisotropic layer is varied and the retardation value is measured at three or more measurement angles. For simplifying the measurement and the computation, the normal direction to the optical anisotropic layer is taken as 0°, and it is desirable that the retardation value is measured at three measurement angles of −40°, 0° and +40°. For the measurement, employable are KOBRA-21ADH and KOBRA-WR (by Oji Scientific Instruments), transmission ellipsometer, AEP-100 (by Shimadzu), M150 and M520 (by JASCO), ABR10A (by Uniopto).

(2) In the above model, the refractive index of normal light to each layer is referred to as no, the refractive index of extraordinary light is as ne (ne is the same value in every layer, and the same shall apply to no), and the thickness of the entire multilayer is as d. Further, with the assumption that the tilt direction in each layer and the monoaxial optical axis direction in that layer correspond to each other, the tilt angle θ1 at one face of the optical anisotropic layer and the tilt angle θ2 at the other face thereof are processed for fitting as variables in order that the computation of the angle dependence of the retardation value of the optical anisotropic layer could correspond to the measured value, thereby computing θ1 and θ2.

In this, no and ne may be known data such as literature data, catalogue data, etc. In case where the data are unknown, they may be determined through measurement with an Abbe's refractiometer. The thickness of the optical anisotropic layer may be measured with an optical interferometric thickness meter, or on a cross-sectional photograph taken with a scanning electronic microscope, etc.

### <Pyridinium Compound and Imidazolium Compound (Alignment Film-Side Alignment-Controlling Agent)>

The optical anisotropic layer in the optical film of the invention may contain a pyridinium compound and an imidazolium compound as an alignment film-side alignment-controlling agent. When the optical anisotropic layer contains a pyridinium compound and an imidazolium compound and especially when the layer contains a discotic liquid-crystal compound, the vertical alignment of the discotic liquid-crystal compound at the interface on the side of the alignment film, or that is, on the side of the laminate of the invention can be controlled to be more vertical relative to the surface of the laminate of the invention.

The preferred range of the pyridinium compound and the imidazolium compound for use in the optical anisotropic layer in the optical film of the invention is the same as that of the pyridinium compound and the imidazolium compound used as additives to the laminate of the invention.

The amount of the pyridinium compound and the imidazolium compound to be added is not more than 5% by mass relative to the liquid-crystal compound and is preferably from 0.1 to 2% by mass or so.

### <Fluoroaliphatic Group-Containing Copolymer (Air Interface Alignment-Controlling Agent)>

A fluoroaliphatic group-containing copolymer is added mainly for the purpose of controlling the alignment at the air interface of a discotic liquid crystal represented by the above-mentioned general formula (I), and has an effect of increasing the tilt angle at around the air interface of discotic liquid-crystal molecules. Further, the copolymer is effective for overcoming coating unevenness and coating rejection.

The fluoroaliphatic group-containing copolymer usable in the optical anisotropic layer in the invention may be selected from the compounds described in JP-A 2004-333852, 2004-333861, 2005-134884, 2005-179636, 2005-181977, etc. Especially preferred are the polymers containing a fluoroaliphatic group and at least one hydrophilic group selected from the group consisting of a carboxyl group (—COOH), a sulfo group (—SO₃H), a phosphonoxy group {—OP(═O)(OH)₂} and their salts in the side chain thereof, as described in JP-A 2005-179636 and 2005-181977.

The amount of the fluoroaliphatic group-containing copolymer to be added is not more than 2% by mass relative to the liquid-crystal compound, preferably from 0.1 to 1% by mass Or so.

Owing to the hydrophobic effect of the fluoroaliphatic group thereof, the fluoroaliphatic group-containing copolymer enhances the eccentric localization of liquid crystal molecules in the air interface and provides the field of low surface energy on the air interface side, thereby increasing the tilt angle of liquid crystal molecules, especially the tilt angle of discotic liquid-crystal molecules. Further, when the copolymer has a copolymerization component containing at least one hydrophilic group selected from the group consisting of a carboxyl group (—COOH), a sulfo group (—SO₃H), a phosphonoxy group {—OP(═O)(OH)₂} and their salts in the side chain thereof, then the vertical alignment of the liquid-crystal compound can be realized owing to the charge repulsion between the anion thereof and the π electron of the liquid crystal.

### <Black Matrix>

Preferably, the optical film of the invention has a black matrix between the first retardation region and the second retardation region from the viewpoint of crosstalk reduction in use of the optical film of the invention as a patterned retardation plate in 3D image display devices. The configuration where such a black matrix is arranged between the first retardation region and the second retardation region includes both the embodiment where the black matrix is so arranged as to partition the first retardation region and the second retardation region from each other and the embodiment where the black matrix is laminated on the boundary between the first retardation region and the second retardation region.

### <Characteristics of Optical Film>

### (Re, Rth)

Preferably, the total Re(550) of the optical film of the invention is from 100 to 190 nm, more preferably from 100 to 175 nm, even more preferably from 110 to 165 nm.

Preferably, in the optical film of the invention, the total of Rth of the transparent support of the laminate and Rth of the optical anisotropic layer is |Rth|≦20 nm.

Re and Rth mean the in-plane and the thickness-direction retardation value at a wavelength of 550 nm (unit: nm).

### (Thermal Expansion Coefficient)

In the invention, the thermal expansion coefficient may be determined according to ISO11359-2. Briefly, a sample is heated from room temperature to 80° C., and then cooled from 60° C. to 50° C., and the thermal expansion coefficient of the sample is computed from the inclination of the film length.

### (Humidity Expansion Coefficient)

In the invention, the humidity expansion coefficient is determined as follows: A film sample having a length of 25 cm (measurement direction) and a width of 5 cm, which has been so cut that the direction thereof to have a maximum elastic modulus could be the longitudinal direction, is prepared, then the sample is pin-holed at intervals of 20 cm, conditioned at 25° C. and at a relative humidity of 10% for 24 hours, and the distance between the pinholes is measured with pin gauge (the measured value is referred to as L₀). Next, the sample is conditioned at 25° C. and at a relative humidity of 80% for 24 hours, and the distance between the pinholes is measured with a pin gauge (the measured value is referred to as L₁). From these measured values, the humidity expansion coefficient of the sample is computed according to the following formula:

Humidity Expansion Coefficient[/% RH]={(L₁−L₀)/L₀}/(R₁−R₀)

The humidity expansion coefficient of the optical film of the invention can be suitably defined depending on the combination with the thermal expansion coefficient thereof, but is preferably from 3.0×10⁻⁶ to 500×10⁻⁶/% RH, more preferably from 4.0×10⁻⁶ to 100×10⁻⁶/% RH, even more preferably from 5.0×10⁻⁶ to 50×10⁻⁶/% RH, most preferably from 5.0×10⁻⁶ to 40×10⁻⁶/% RH. RH means relative humidity.

### (Sound Velocity)

In the invention, the direction of the film in which the sound velocity (propagation velocity of sound wave) is the largest is determined as follows: A film sample is conditioned at 25° C. and at a relative humidity of 60% for 24 hours, and then using an alignment analyzer (SST-2500, by Nomura Shoji), the sample is analyzed to determine the direction thereof in which the propagation speed of the longitudinal wave vibration of ultrasonic pulse is the highest.

### (Elastic Modulus)

In the invention, the elastic modulus is determined as follows: A film sample having a length of 150 mm and a width of 10 mm is prepared, conditioned at 25° C. and at a relative humidity of 60% for 24 hours, and according to the standard of ISO527-3:1995, the sample having an original length of 100 mm is tested at a tensile speed of 10 mm/min. The tensile elastic modulus of the sample is obtained from the initial inclination of the stress-strain curve. Depending on the length direction and the width direction in which the film sample is collected, the elastic modulus of a film varies. In the invention, the film sample is prepared in the direction in which its elastic modulus is the largest, and the measured value of the sample is referred to as the elastic modulus of the film of the invention. In case where the elastic modulus in direction in which the sound velocity measured in the manner as above is the largest is referred to as E1 and the elastic modulus in the direction vertical thereto is referred to as E2, the ratio of the two (E1/E2) is preferably from 1.1 to 5.0, more preferably from 1.5 to 3.0 from the viewpoint of reducing the dimension change of the film while maintaining the flexibility thereof.

Not specifically defined, the elastic modulus of the film of the invention is preferably from 1 to 50 GPa, more preferably from 5 to 50 GPa, even more preferably from 7 to 20 GPa. The elastic modulus can be controlled by suitably selecting the type of the polymer, the type and the amount of the additive and the degree of stretching.

### (Whole Light Transmittance, Haze)

In the invention, a film sample is conditioned at 25° C. and at a relative humidity of 60% for 24 hours, and then using a haze meter (NDH 2000, by Nippon Denshoku), the sample is analyzed for the whole light transmittance and the haze thereof.

The whole light transmittance of the optical film of the invention is preferably higher from the viewpoint of effectively utilizing the light from a light source to reduce the power consumption by panel, and concretely, it is preferably at least 85%, more preferably at least 90%, even more preferably at least 92%. Also preferably, the haze of the optical film of the invention is at most 5%, more preferably at most 3%, even more preferably at most 2%, still more preferably at most 1%, especially preferably at most 0.5%.

### (Tear Strength)

In the invention, the tear strength (Elmendorf tearing method) is determined as follows: Two film samples each having a size of 64 mm×50 mm are cut out in the direction parallel to the slow axis of the film and in the direction perpendicular thereto, and conditioned at 25° C. and at a relative humidity of 60% for 2 hours. Using a light load tear strength tester, the samples are tested, and the smaller value thus measured is referred to as the film tear strength.

The tear strength of the optical film of the invention is preferably from 3 to 50 g, more preferably from 5 to 40 g, even more preferably from 10 to 30 g from the viewpoint of film brittleness.

### (Film Thickness)

The thickness of the optical film of the invention is preferably from 10 to 1000 μm, more preferably from 40 to 500 μm, even more preferably from 40 to 200 μm from the viewpoint of cost reduction.

### [Production Method for Optical Film]

The production method for the optical film of the invention comprises arranging a composition that contains a polymerizing group-having liquid crystal, on a laminate produced according to the production method for laminate of the invention, forming an optical anisotropic layer, and forming a patterned optical anisotropic layer that contains a first retardation region with alignment control on the first alignment control region and a second retardation region with alignment control on the second alignment control region.

### <Method for Forming Patterned Optical Anisotropic Layer>

The method for forming a patterned optical anisotropic layer is described.

Preferably, the optical anisotropic layer is a layer formed by applying a composition that contains the above-mentioned polymerizing group-having liquid crystal (for example, coating liquid) onto the surface of the rubbed alignment film to be mentioned below, then making it in an alignment state that expresses the desired liquid-crystal phase, and fixing the alignment state by heating or through exposure to ionizing radiation.

### (Arrangement of Composition Containing Polymerizing Group-Having Liquid Crystal)

Preferably, the production method for the optical film of the invention comprises a step of coating with a coating liquid that contains a solvent and a polymerizing group-having liquid crystal, as the method of arranging a composition that contains a polymerizing group-having liquid crystal.

As the coating method, there are mentioned known coating methods such as a curtain coating method, a dip coating method, a spin coating method, a printing coating method, a spray coating method, a slot coating method, a roll coating method, a slide coating method, a blade coating method, a gravure coating method, a wire bar coating method, etc.

In the production method for the optical film of the invention, preferably, the coating liquid contains at least one of a pyridinium compound and an imidazolium compound from the viewpoint that, when a discotic liquid crystal is used, the vertical alignment of the discotic liquid-crystal molecules can be enhanced at the interface on the side of the laminate of the invention.

Also preferably, in the production method for the optical film of the invention, the polymerizing group-having liquid crystal is a discotic liquid crystal.

As the solvent for use in preparing the coating liquid, preferably used is an organic solvent. Examples of the organic solvent include amides (e.g., N,N-dimethylformamide), sulfoxides (e.g., dimethylsulfoxide), heterocyclic compounds (e.g., pyridine), hydrocarbons (e.g., benzene, hexane), alkyl halides (e.g., chloroform, dichloromethane), esters (e.g., methyl acetate, butyl acetate), ketones (e.g., acetone, methyl ethyl ketone), and ethers (e.g., tetrahydrofuran, 1,2-dimethoxyethane). Preferred are alkyl halides and ketones. Two or more different types of those organic solvents may be used as combined.

In the production method for the optical film of the invention, preferably, the solvent contained in the coating liquid that contains the above-mentioned solvent and the polymerizing group-having liquid crystal does not substantially dissolve any of the compound contained in the above-mentioned first alignment control region printing liquid and the compound contained in the above-mentioned second alignment control region printing liquid. When the solvent of the type is used in coating with the coating liquid that contains the solvent and the polymerizing group-having liquid crystal, the alignment control capability of the alignment control regions in the laminate of the invention is not disordered and a good patterned optical anisotropic layer can be thereby formed.

In case where a rod-shaped liquid-crystal compound is used, preferably, the rod-shaped liquid crystal is aligned horizontally. In this description, “horizontal alignment” means that the long axis of the rod-shaped liquid crystal is parallel to the layer face. This does not require any strict parallel state, but in this description, this alignment state means that the tilt angle to the horizontal face is less than 10 degrees. The tilt angle is preferably from 0 to 5 degrees, more preferably from 0 to 3 degrees, even more preferably from 0 to 2 degrees, most preferably from 0 to 1 degree.

An additive capable of promoting horizontal alignment of liquid crystal may be added to the above-mentioned composition, and examples of the additive include the compounds described in JP-A 2009-223001, [0055] to [0063].

In case where a discotic liquid crystal is used here, preferably, the discotic liquid crystal is vertically aligned. In this description, “vertical alignment” means that the discotic face of the discotic liquid crystal is vertical to the layer surface. This does not require any strict vertical state, but in this description, this alignment state means that the tilt angle to the horizontal face is not less than 70 degrees. The tilt angle is preferably from 85 to 90 degrees, more preferably from 87 to 90 degrees, even more preferably from 88 to 90 degrees, most preferably from 89 to 90 degrees.

Preferably, at least one of a pyridinium compound and an imidazolium compound is added to the composition as an additive capable of promoting vertical alignment of liquid crystal, and examples of the additive are as described above.

### (Heating)

The method of alignment control for the patterned optical anisotropic layer preferably includes a method of heating the coating film to thereby align the long axis of the liquid crystal on any one of the first alignment control region or the second alignment control region in the direction vertical to the rubbing direction to provide a vertical alignment region and to align the long axis of the liquid crystal on the other alignment control region in the direction parallel to the rubbing direction to provide a parallel alignment region.

In particular, it is desirable that at least one of the first composition to be used for printing the first alignment control region and the second composition to be used for printing the second alignment control region contains at least one of a pyridinium compound and an imidazolium compound and that the production method includes a step of alignment treatment by heating the first composition and the second composition. As described above, by controlling the alignment temperature, the direction in which the discotic liquid-crystal compound is aligned can be changed relative to the alignment control region containing at least one of the pyridinium compound and the imidazolium compound thereby attaining the desired alignment state.

### (Fixation)

Next, the aligned liquid-crystal compound is preferably fixed while keeping the alignment state thereof. Preferably, the fixation is attained through polymerization of the reactive group introduced into the liquid-crystal compound. The polymerization reaction includes thermal polymerization using a thermal polymerization initiator and photopolymerization using a photopolymerization initiator. Preferred is photopolymerization. The production method of the invention preferably includes a step of fixing the alignment state of the liquid crystal in the coating film through photoirradiation.

The photopolymerization may be any of radical polymerization or cationic polymerization. Examples of the radical photopolymerization initiators include α-carbonyl compounds (described in U.S. Pat. Nos. 2,367,661 and 2367670), acyloin ethers (described in U.S. Pat. No. 2,448,828), α-hydrocarbon-substituted aromatic acyloin compounds (described in U.S. Pat. No. 2,722,512), polynuclear quinone compounds (described in U.S. Pat. Nos. 3,046,127 and 2951758), combination of triarylimidazole dimer and p-aminophenyl ketone (described in U.S. Pat. No. 3,549,367), acridine and phenazine compounds (described in JP-A 60-105667, U.S. Pat. No. 4,239,850) and oxadiazole compounds (described in U.S. Pat. No. 4,212,970). Examples of the cationic photopolymerization initiator include organic sulfonium salts, iodonium salts, phosphonium salts. Preferred are organic sulfonium salts, and more preferred are triphenylsulfonium salts. As the pair ion for these compounds, preferably used are hexafluoroantimonate, hexafluorophosphonate, etc.

The amount of the photopolymerization initiator to be used is preferably from 0.01 to 20% by mass of the solid content of the coating liquid, more preferably from 0.5 to 5% by mass.

In addition to the polymerization initiator, a sensitizer may also be used for increasing the sensitivity of the composition. Examples of the sensitizer include n-butylamine, triethylamine, tri-n-butyl phosphine, thioxanthone, etc. Different types of photopolymerization initiators may be used here as combined, and the amount of the photopolymerization initiator to be used is preferably from 0.01 to 20% by mass, more preferably from 0.5 to 5% by mass. UV light is preferably used for photoirradiation for polymerizing the liquid-crystal compound.

Apart from the polymerizing liquid-crystal compound therein, the composition may contain a non-liquid-crystalline polymerizing monomer. As the polymerizing monomer, preferred are compounds having a vinyl group, a vinyloxy group, an acryloyl group or a methacryloyl group. In case where a polyfunctional monomer having two or more polymerizing reactive functional groups, for example, an ethylene oxide-modified trimethylolpropane acrylate is used, it is favorable as enhancing the durability of the composition. The non-liquid-crystalline polymerizing monomer is a non-liquid-crystalline component, and therefore, the amount thereof to be added is not more than 40% by mass relative to the liquid-crystal compound, and is preferably from 0 to 20% by mass.

As the light for irradiation, usable is X ray, electron beams, UV ray, visible ray or IR ray (heat ray). Above all, UV ray is preferred for photoirradiation for polymerization of liquid-crystal compound. As the light source, preferably used is a low-pressure mercury lamp (bactericidal lamp, fluorescent chemical lamp, black light), a high-pressure discharge lamp (high-pressure mercury lamp, metal halide lamp), or a short arc discharge lamp (ultra-high-pressure mercury lamp, xenon lamp, mercury-xenon lamp). The photoirradiation dose is preferably from 50 to 1000 mJ/cm² or so, more preferably from 50 to 200 mJ/cm² or so. The irradiation wavelength range preferably has a peak at from 250 to 450 nm, more preferably a peak at from 300 to 410 nm. For promoting photopolymerization reaction, the photoirradiation may be attained in an inert gas atmosphere such as nitrogen or under heat. For increasing the patterning resolution, photoexposure at room temperature is preferred. For making the first retardation region and the second retardation region have the same front retardation (Re) and the same thickness-direction retardation (Rth), the temperature for photoexposure is preferably controlled.

For forming the patterned optical anisotropic layer, the laminate of the invention is used. In particular, it is desirable to use the laminate of the invention at least containing a rubbed alignment film. The rubbed alignment film in the invention has the property that it expresses alignment controlling capability through rubbing treatment and that the alignment axis thereof is defined depending on the rubbing direction and the heating condition. Accordingly, by pattern-like coating the alignment film with a liquid-crystal composition according to a printing process and heating it, there may be formed domains of which the alignment axes are vertical to each other, and on these, rod-shaped liquid-crystal molecules are horizontally aligned or discotic liquid-crystal molecules are vertically aligned thereby forming a ¼ wavelength layer where the slow axes of the domains are vertical to each other.

An example of the printing process is described below.

An optical anisotropic layer forming composition, which contains a discotic liquid crystal, a pyridinium compound, a fluoroaliphatic group-containing copolymer, a polymerization initiator, a sensitizer and others and which is prepared as a coating liquid is applied to the surface (preferably the rubbed surface) on the side of the alignment control region of the laminate of the invention.

In case where a discotic liquid crystal is used, the coating film of the composition is dried and then heated so that the discotic liquid crystal is made to be in a vertical alignment state of such that the long axis of the liquid crystal is parallel/vertical to the rubbing direction in accordance with pattern, and thereafter cured through polymerization to fix the alignment state, thereby forming the pattern.

On the other hand, in case where a rod-shaped liquid crystal is used, the coating film of the composition is dried and then heated so that the rod-shaped liquid crystal is made to be in a horizontal alignment state of such that the long axis of the liquid crystal is parallel/vertical to the rubbing direction in accordance with pattern. After the molecules of the rod-shaped liquid crystal have been made to be in the desired alignment state, they are cured through polymerization to thereby fix the alignment state to form the pattern.

### <Formation of Black Matrix>

The production method for the optical film of the invention may include a step of forming a black matrix between the first retardation region and the second retardation region, before or after the formation of the optical anisotropic layer.

Not specifically defined, for example, the following case may be mentioned as one concrete method for the formation.

Preferably, the invention includes a step of forming a black matrix between the first retardation region and the second retardation region on the laminate, in which a coating liquid containing a rod-shaped liquid crystal or a discotic liquid crystal is applied to the space for the black matrix.

Also preferably, the invention includes a step of forming a black matrix at least on the boundary between the first retardation region and the second retardation region adjacent to each other, after the step of coating with the coating liquid that contains a rod-shaped liquid crystal or a discotic liquid crystal.

### [Polarizing Plate]

The polarizing plate of the invention comprises at least one optical film of the invention and a polarizing plate, in which the in-plane slow axis direction of both the first retardation region and the second retardation region of the optical anisotropic layer is at about 45° to the absorption axis direction of the polarizing plate.

The polarizing plate may have any ordinary configuration heretofore known in the art, and not specifically defined, the concrete configuration of the polarizing plate may be any known configuration, for which, for example, employable is the configuration shown in FIG. 6 in JP-A 2008-262161. The optical film of the invention may be laminated on one surface of an ordinary polarizing plate to give a patterned retardation film that may be used in polarized glasses-assisted 3D image display systems. The embodiment of the polarizing plate includes not only film sheets cut to have a size that may be directly incorporated in liquid-crystal display devices but also long films continuously produced and rolled up into rolls (for example, an embodiment having a roll length of 2500 m or more, or 3900 m or more). For use in large-panel liquid-crystal display devices, the width of the polarizing plate is preferably at least 1470 mm as mentioned above.

### <Production Method for Polarizing Plate>

The production method for the polarizing plate of the invention comprises a step of rubbing the entire film containing a transparent support of a cellulose acylate and, as laminated thereon, a patterned alignment film, a step of aligning the composition applied onto the film and containing, as the main ingredient thereof, a rod-shaped liquid crystal or a discotic liquid crystal, a step of photoexposing the entire surface of the film to form a first retardation region and a second retardation region, and a step of roll-to-roll laminating the thus-obtained optical anisotropic film with a polarizing film of which the transmission axis is at 45°.

According to this embodiment, the production method for the polarizing plate of the invention enables continuous production and therefore reduces the production cost as compared with conventional production methods.

### <Adhesive Layer>

Preferably, in the polarizing plate of the invention, the optical film and the polarizing film are laminated via an adhesive layer.

In the invention, the adhesive layer to be used for laminating the optical film and the polarizing film is, for example, a substance having a ratio of G″ to G′ (tan δ=G″/G′), as measured with a dynamic viscoelastometer, of from 0.001 to 1.5, and includes so-called adhesive agents and easily-creepable substances, etc.

### <Antireflection Film>

Preferably, at least one antireflection film is laminated on the polarizing plate of the invention as the outermost surface thereof.

### (Antireflection Layer)

Preferably, the protective film to be arranged on the opposite side of the polarizing plate to the side thereof to face a liquid-crystal cell is provided with a functional film such as an antireflection layer or the like. In particular, in the invention, it is desirable that an antireflection layer comprising at least a light-scattering layer and a low-refractivity layer laminated in that order is provided on a transparent protective film, or an antireflection layer comprising a middle-refractivity layer, a high-refractivity layer and a low-refractivity layer laminated in that order is provided on a transparent protective film. This is because especially in 3D image expression, flickering by external light reflection can be effectively prevented.

Preferred examples of the case are described below.

One preferred example of an antireflection layer comprising a light-scattering layer and a low-refractivity layer and provided on a transparent support film is described.

Mat agents are dispersed in the light-scattering layer in the invention, and preferably, the refractive index of the other material than the mat particles in the light-scattering layer falls within a range of from 1.50 to 2.00. Also preferably, the refractive index of the low-refractivity layer falls within a range of from 1.35 to 1.49. In the invention, the light-scattering layer may serve also for antiglaring and hard coating, and the layer may be a single layer or a multilayer of, for example, from 2 to 4 layers.

Regarding the surface roughness profile thereof, the antireflection layer is preferably so designed that the centerline mean roughness Ra is from 0.08 μm to 0.40 μm, the 10-point mean roughness Rz is at most 10 times Ra, the mean mountain-to-valley distance Sm is from 1 μm to 100 μm, the standard deviation from the deepest part of the valleys to the height of the mountain is at most 0.5 μm, the standard deviation of the mean mountain-to-valley distance Sm based on the centerline is at most 20 μm, and the face having a tilt angle of from 0 degree to 5 degrees is at least 10%, and the thus-designed antireflection layer attains sufficient antiglare performance and a uniform matted appearance in visual observation.

Also preferably, the color of reflected light on the antireflection layer under a C light source is such that the a* value thereof is from −2 to 2, the b* value thereof is from −3 to 3, and the ratio of the minimum value to the maximum value of the reflectivity within a range of from 380 nm to 780 nm is from 0.5 to 0.99. On the antireflection layer satisfying the requirements, the color of the reflected light could be neutral. Also preferably, the b* value of the transmitted light under a C light source is from 0 to 3, and satisfying this, when the antireflection layer is applied to a display device, the device is prevented from yellowing at the time of white level of display.

Also preferably, the standard deviation of the brightness distribution, as measured on the antireflection layer of the invention with a lattice of 120 μm×40 μm inserted between the planar light source and the layer, is at most 20. This is because when the film of the type of the invention is applied to a high-definition panel, the panel is prevented from glaring.

Preferably, the antireflection layer in the invention has, as optical characteristics thereof, a mirror reflectivity of at most 2.5%, a transmittance of at least 90%, and a 60-degree glossiness of at most 70%. The antireflection layer of the type can prevent reflection of external light and improves the visibility on the film. In particular, the mirror reflectivity is more preferably at most 1%, most preferably at most 0.5%. Also preferably, the haze is from 20% to 50%, the ratio of internal haze/total haze is from 0.3 to 1, the reduction from the haze value after formation of the light-scattering layer to the haze value after formation of the low-reflectivity layer is at most 15%, the transmitted image sharpness at a comb width of 0.5 mm is from 20% to 50%, and the transmittance ratio of vertical transmitted light/transmittance inclined by 2 degrees from the vertical direction is from 1.5 to 5.0. The preferred embodiment attains antiglaring on high-definition LCD panels and prevents letters and others from blurring thereon.

### (Low-Refractivity Layer)

The refractive index of the low-refractivity layer of the antireflection film in the invention is from 1.20 to 1.49, preferably from 1.30 to 1.44. Preferably, the low-refractivity layer satisfies the following numerical formula (IX) from the viewpoint of attaining the low refractivity thereof.

(mλ/4)×0.7<n1d1<(mλ/4)×1.3 Numerical Formula (IX)

In the formula, m indicates a positive odd number, n1 means the refractive index of the low-refractivity layer, and d1 means the thickness (nm) of the low-refractivity layer. λ means a wavelength, falling within a range of from 500 to 550 nm.

The material to form the low-refractivity layer in the invention is described below.

The low-refractivity layer in the invention contains a fluoropolymer as the low-refractivity binder therein. The fluoropolymer is preferably a fluorine-containing polymer which has a dynamic friction factor of from 0.03 to 0.20, a contact angle to water of from 90° to 120° and a slip angle of pure water of at most 70° and which can be crosslinked by heating or through exposure to ionizing radiation. When the antireflection film of the invention is applied to an image display device, it is desirable that the peeling force thereof from a commercial adhesive tape is lower since a seal or a note attached thereto could be readily peeled away. Preferably, the peeling force is at most 500 gf, more preferably at most 300 gf, most preferably at most 100 gf. In addition, the surface hardness of the low-refractivity layer, as measured with a microhardness meter, is preferably higher since the layer is hardly scratched. Preferably, the surface hardness is at least 0.3 GPa, more preferably at least 0.5 GPa.

The fluoropolymer for use in the low-refractivity layer includes hydrolyzed or dehydrative-condensed products of perfluoroalkyl group-containing silane compounds (for example, (heptadecafluoro-1,1,2,2-tetrahydrodecyl)triethoxysilane), as well as other fluorine-containing copolymers comprising a fluorine-containing monomer unit and a constitutive unit for crosslinkability impartation.

Examples of the fluorine-containing monomer include, for example, fluoro-olefins (e.g., fluoroethylene, vinylidene fluoride, tetrafluoroethylene, perfluoro-octylethylene, hexafluoropropylene, perfluoro-2,2-dimethyl-1,3-dioxol, etc.), partially or completely-fluorinated alkyl ester derivatives of (meth)acrylic acid (e.g., Biscoat 6FM (by Osaka Organic Chemical), M-2020 (by Daikin), etc.), completely or partially-fluorinated vinyl ethers, etc. Preferred are perfluoro-olefins; and more preferred is hexafluoropropylene from the viewpoint of the refractive index, the solubility, the transparency and the availability thereof.

The constitutive unit for crosslinkability impartation includes a constitutive unit derived from polymerization with a monomer previously having a self-crosslinking functional group in the molecule thereof, such as glycidyl (meth)acrylate or glycidyl vinyl ether, a constitutive unit derived from polymerization with a monomer having a carboxyl group, a hydroxy group, an amino group, a sulfo group or the like (for example, (meth)acrylic acid, methylols (meth)acrylate, hydroxyalkyl (meth)acrylate, allyl acrylate, hydroxyethyl vinyl ether, hydroxybutyl vinyl ether, maleic acid, crotonic acid, etc.), and a constitutive unit constructed by introducing a crosslinking reactive group such as a (meth)acryloyl group or the like into any of these constitutive units through polymer reaction (for example, the group is introduced according to a method of reacting acrylic acid chloride with a hydroxyl group).

Apart from the above-mentioned fluorine-containing monomer unit and constitutive unit for crosslinkability impartation, any other monomer not containing a fluorine may be suitably copolymerized from the viewpoint of enhancing the solubility of the copolymer in solvent and the transparency of the formed film. The usable monomer is not specifically defined. For example, there are mentioned olefins (ethylene, propylene, isoprene, vinyl chloride, vinylidene chloride, etc.), acrylates (methyl acrylate, methyl acrylate, ethyl acrylate, 2-ethylhexyl acrylate), methacrylates (methyl methacrylate, ethyl methacrylate, butyl methacrylate, ethylene glycol dimethacrylate, etc.), styrene derivatives (styrene, divinylbenzene, vinyltoluene, α-methylstyrene, etc.), vinyl ethers (methyl vinyl ether, ethyl vinyl ether, cyclohexyl vinyl ether, etc.), vinyl esters (vinyl acetate, vinyl propionate, vinyl cinnamate, etc.), acrylamides (N-tert-butylacrylamide, N-cyclohexylacrylamide, etc.), methacrylamides, acrylonitrile derivatives, etc.

For the above-mentioned polymers, a curing agent may be used as in JP-A 10-25388 and 10-147739.

### (Light-Scattering Layer)

The light-scattering layer is formed for the purpose of giving to the film, light scatterability through surface scattering and/or internal scattering, and hard coatability for enhancing the scratch resistance of the film. Accordingly, the layer is formed, containing a binder for imparting hard coatability, mat particles for imparting light scatterability, and optionally an inorganic filler for refractivity increase, crosslinking shrinkage prevention and intensity increase.

Preferably, the thickness of the light-scattering layer is from 1 μm to 10 μm, from the viewpoint of imparting hard coatability thereto, preventing the layer from curing and preventing the layer from being brittle, more preferably from 1.2 μm to 6 μm.

As the binder to be in the scattering layer, preferred is a polymer having a saturated hydrocarbon chain or a polyether chain as the main chain thereof, and more preferred is a polymer having a saturated hydrocarbon chain as the main chain thereof. Also preferably, the binder polymer has a crosslinked structure. As the binder polymer having a saturated hydrocarbon chain as the main chain thereof, preferred is a polymer of an ethylenic unsaturated monomer. As the binder polymer having a saturated hydrocarbon chain as the main chain thereof and having a crosslinked structure, preferred is a (co)polymer of a monomer having at least two ethylenic unsaturated groups. In order to make the binder polymer have a high refractive index, monomers having an aromatic ring in the monomer structure or containing at least one atom selected from halogen atoms except fluorine, and sulfur atom, phosphor atom and nitrogen atom may be selected for the polymer.

The monomer having at least two ethylenic unsaturated groups includes esters of polyalcohol and (meth)acrylic acid (e.g., ethylene glycol di(meth)acrylate, butanediol di(meth)acrylate, hexanediol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, polyester polyacrylate), ethylene oxide-modified derivatives of these compounds, vinylbenzene and its derivatives (e.g., 1,4-divinylbenzene, 2-acryloylethyl 4-vinylbenzoate, 1,4-divinylcyclohexanone), vinyl sulfones (e.g., divinyl sulfone), acrylamides (e.g., methylenebisacrylamide) and methacrylamides. Two or more these monomers may be used as combined.

Specific examples of the high-refractivity monomer include bis(4-methacryloylthiophenyl)sulfide, vinylnaphthalene, vinylphenyl sulfide, 4-methacryloxyphenyl-4′-methoxyphenylthioether, etc. Two or more these monomers may be used as combined.

The ethylenic unsaturated group-having monomer may be polymerized in the presence of a photoradical initiator or a thermal radical initiator through exposure to ionizing radiation or by heating.

Accordingly, a coating liquid containing an ethylenic unsaturated group-having monomer, a photoradical initiator or a thermal radical initiator, mat particles and an inorganic filler is prepared, the coating liquid is applied onto a transparent support, and after thus coated, the support is exposed to ionizing radiation or heat to induce polymerization for curing thereby to form the intended antireflection film. As the photoradical initiator and others, any known ones are usable.

The polymer having a polyether main chain is preferably a polymer produced through ring-opening polymerization of a polyfunctional epoxy compound. The ring-opening polymerization of a polyfunctional epoxy compound may be attained in the presence of a photoacid generator or a thermal acid generator through exposure to ionizing radiation or by heating.

Accordingly, a coating liquid containing a polyfunctional epoxy compound, a photoacid generator or a thermal acid generator, mat particles and an inorganic filler is prepared, the coating liquid is applied onto a transparent support, and after thus coated, the support is exposed to ionizing radiation or heat to induce polymerization for curing thereby to form the intended antireflection film.

In place of or in addition to the monomer having at least two ethylenic unsaturated groups, a monomer having a crosslinking functional group may be used to introduce the crosslinking functional group into the formed polymer, and through the reaction of the crosslinking functional group, a crosslinked structure may be introduced into the binder polymer.

Examples of the crosslinking functional group include an isocyanate group, an epoxy group, an aziridine group, an oxazoline group, an aldehyde group, a carbonyl group, a hydrazine group, a carboxyl group, a methylols group and an active methylene group. Vinylsulfonic acids, acid anhydrides, cyanoacrylate derivatives, melamines, etherified methylols, esters, urethanes and metal alkoxides such as tetramethoxysilane are also usable as the monomer for crosslinked structure introduction. A functional group capable of exhibiting crosslinkability as a result of decomposition, such as a blocked isocyanate group, is also employable. Specifically in the invention, the crosslinking functional group may be not only one directly exhibiting the reaction but also one capable of exhibiting the reactivity as a result of decomposition.

The crosslinking functional group-having binder polymer may form the crosslinked structure by heating after coating.

The light-scattering layer contains, for the purpose of antiglaring impartation thereto, mat particles larger than filler particles and having a mean particle size of from 1 μm to 10 μm, preferably from 1.5 μm to 7.0 μm, for example, particles of an inorganic compound or resin particles.

Preferred examples of the mat particles include, for example, inorganic compound particles such as silica particles, TiO₂ particles, etc.; resin particles such as acrylic particles, crosslinked acrylic particles, polystyrene particles, crosslinked styrene particles, melamine resin particles, benzoguanamine resin particles, etc. Above all, more preferred are crosslinked styrene particles, crosslinked acrylic particles, crosslinked acrylstyrene particles, silica particles. Regarding the shape thereof, the mat particles for use herein may be spherical or amorphous particles.

Two or more different types of mat particles each having a different particle size may be combined for use herein. The mat particles having a larger particle size may act for antiglaring impartation and those having a smaller particle size may act for impartation of any other optical characteristics.

Regarding the particle size distribution thereof, the mat particles are most preferably monodispersed ones. It is better that the particle size of the constitutive particles is nearer to each other or is the same. For example, when particles of which the particle size is larger by at least 20% than the mean particle size are referred to as coarse particles, it is desirable that the proportion of such coarse particles in the mat particles is at most 1% of all the particles, more preferably at most 0.1%, even more preferably at most 0.01%. The mat particles having such a particle size distribution may be obtained through classification after ordinary production thereof, and by increasing the frequency of classification or by strengthening the degree of classification, a mat agent having a more preferred distribution can be obtained.

The mat particles are added to the light-scattering layer in such a manner that the amount thereof in the formed light-scattering layer could be from 10 mg/m² to 1000 mg/m², more preferably from 100 mg/m² to 700 mg/m².

Regarding the particle size distribution thereof, the mat particles may be analyzed according to a Coulter counter method, and the found distribution data may be computed to give the particle number distribution.

Preferably, in addition to the above-mentioned mat particles, an inorganic filler of an oxide of at least one metal selected from titanium, zirconium, aluminium, indium, zinc, tin and antimony having a mean particle size of at most 0.2 μm, preferably at most 0.1 μm, more preferably at most 0.06 μm is added to the light-scattering layer for the purpose of increasing the refractive index of the layer.

Contrary to this, for increasing the difference in the refractive index between the light-scattering layer and the mat particles therein and for lowering the refractive index of the light-scattering layer in which high-refractivity mat particles are used, it is also desirable to use a silicon oxide in the layer. The preferred particle size of the silicon oxide particles is the same as that of the above-mentioned inorganic filler.

Specific examples of the inorganic filler to be used in the light-scattering layer include TiO₂, ZrO₂, Al₂O₃, In₂O₃, ZnO, SnO₂, Sb₂O₃, ITO, SiO₂, etc. Especially preferred are TiO₂ and ZrO₂ from the viewpoint of increasing refractivity. Preferably, the surface of the inorganic filler is processed through silane coupling treatment or titanium coupling treatment, for which preferably used is a surface-treating agent having a functional group capable of reacting with a binder species on the filler surface.

The amount of the inorganic filler to be added is preferably from 10% to 90% of all the mass of the light-scattering layer, more preferably from 20% to 80%, even more preferably from 30% to 75%.

The filler of the type does not cause scattering since the particle size thereof is sufficiently smaller than the wavelength of light, and the dispersion prepared by dispersing the filler in a binder polymer behaves as an optically homogeneous substance.

The bulk refractive index of the mixture of a binder and an inorganic filler for the light-scattering layer is preferably from 1.48 to 2.00, more preferably from 1.50 to 1.80. In order to make the refractive index fall within the above range, it is good that the type and the blend ratio of the binder and the inorganic filler are suitably selected. How to select them may be easily known through previous experiments.

Especially for securing the plane uniformity of the light-scattering layer without coating unevenness, drying unevenness, fish eyes and others therein, any of fluorine-containing surfactants or silicone surfactants, or both of the two are added to the coating composition for forming the antiglare layer. In particular, fluorine-containing surfactants are preferably used because of the reason that even when a smaller amount thereof is added, the surfactant is effective for overcoming the surface defects such as coating unevenness, drying unevenness, fish eyes and others of the antireflection film in the invention. The surfactants are for enhancing the planar uniformity of the coated surface and for making the coating liquid satisfy rapid coatability, thereby increasing the productivity of the film.

Next described is an antireflection layer that comprises a middle-refractivity layer, a high-refractivity layer and a low-refractivity layer laminated in that order on a transparent protective film.

The antireflection layer having a layer configuration that comprises at least a middle-refractivity layer, a high-refractivity layer and a low-refractivity layer (outermost layer) laminated in that order on a substrate is so designed that the refractive indices of the constitutive layers could satisfy the following relationship.

Refractive index of high-refractivity layer>refractive index of middle-refractivity layer>refractive index of transparent support>refractive index of low-refractivity layer

A hard coat layer may be arranged between the transparent support and the middle-refractivity layer. Further, the layer configuration may comprise a middle-refractivity hard coat layer, a high-refractivity layer and a low-refractivity layer (for example, see JP-A 8-122504, 8-110401, 10-300902, 2002-243906, 2000-111706). Any other function may be imparted to the constitutive layers. For example, there is a layer configuration of an antifouling low-refractivity layer and an antistatic high-refractivity layer (e.g., JP-A 10-206603, 2002-243906), etc.

Preferably, the intensity of the antireflection layer is at least the grade H in the pencil hardness test according to JIS K5400, more preferably at least 2H, most preferably at least 3H.

### (High-Refractivity Layer and Middle-Refractivity Layer)

The layer having a high refractive index of the antireflection film is formed of a cured film that contains at least ultrafine particles of an inorganic compound having a mean particle size of at most 100 nm and having a high refractive index and a matrix binder.

As the high-refractivity fine particles of an inorganic compound, there is mentioned an inorganic compound having a refractive index of at least 1.65, preferably at least 1.9. For example, there are mentioned oxides with Ti, Zn, Sb, Sn, Zr, Ce, Ta, Ca, In or the like, and composite oxides containing any of these metal atoms, etc.

For producing such ultrafine particles, for example, the particle surface is treated with a surface-treating agent (for example, with a silane coupling agent or the like as in JP-A 11-295503, 11-153703, 2000-9908, or with an anionic compound or an organic metal coupling gent as in JP-A 2001-310432), or a core/shell structure is formed in which a high-refractivity particle is the core (as in JP-A2001-166104, 2001-310432, etc.), a specific dispersing agent is used (as in JP-A 11-153703, U.S. Pat. No. 6,210,858, JP-A 2002-2776069, etc.), etc.

As the material to form the matrix, there are mentioned conventional known thermoplastic resins, curable resin films, etc.

Further, preferred is at least one composition selected from a composition containing a polyfunctional compound that has at least two, radical polymerizing and/or cationic-polymerizing groups, and a composition containing a hydrolyzing group-having organic metal compound and its partial condensation product. For example, there are mentioned the compositions described in JP-A 2000-47004, 2001-315242, 2001-31871, 2001-296401, etc. Also preferred is a curable film to be obtained from a colloidal metal oxide obtained from a hydrolytic condensation product of a metal alkoxide and a metal alkoxide composition. For example, it is described in JP-A 2001-293818.

The refractive index of the high-refractivity layer is generally from 1.70 to 2.20. The thickness of the high-refractivity layer is preferably from 5 nm to 10 μm, more preferably from 10 nm to 1 μm.

The refractive index of the middle-refractivity layer is so controlled as to fall between the refractive index of the low-refractivity layer and the refractive index of the high refractivity layer. The refractive index of the middle-refractivity layer is preferably from 1.50 to 1.70. The thickness of the layer is preferably from 5 nm to 10 μm, more preferably from 10 nm to 1 μm.

### (Low-Refractivity Layer)

The low-refractivity layer is sequentially laminated on the high-refractivity layer. The refractive index of the low-refractivity layer is from 1.20 to 1.55, preferably from 1.30 to 1.50.

Preferably, the layer is formed as the outermost layer having scratch resistance and fouling resistance. For greatly increasing the scratch resistance of the layer, a method of imparting lubricity to the layer is effective, for which is employable any known method of forming a thin film layer with silicone introduction or fluorine introduction thereinto.

Preferably, the fluorine-containing compound has a refractive index of from 1.35 to 1.50, more preferably from 1.36 to 1.47. Also preferably, the fluorine-containing compound is a compound containing a fluorine atom in a range of from 35% by mass to 80% by mass and containing a crosslinking or polymerizing functional group.

For example, there are mentioned the compounds described in JP-A 9-222503, paragraphs [0018] to [0026], JP-A 11-38202, paragraphs [0019] to [0030], JP-A2001-40284, paragraphs [0027] to [0028], JP-A 2000-284102, etc.

The silicone compound is a compound having a polysiloxane structure, and preferably contains a curable functional group or a polymerizing functional group in the polymer chain to form a crosslinked structure in the film containing it. For example, there are mentioned reactive silicones (e.g., Silaplane by Chisso), polysiloxanes having a silanol group at both ends thereof (as in JP-A 11-258403), etc.

Preferably, the crosslinking or polymerization reaction of the crosslinking or polymerizing group-having, fluorine-containing and/or siloxane polymer is attained by photoirradiation or heating simultaneously with or after coating with the coating composition for forming the outermost layer that contains a polymerization initiator, a sensitizer, etc.

Also preferred is a sol-gel curable film capable of curing through condensation of an organic metal compound such as a silane coupling agent or the like and a specific fluorohydrocarbon group-having silane coupling agent in the presence of a catalyst.

For example, there are mentioned a polyfluoroalkyl group-containing silane compound or its partial hydrolytic condensation product (compounds described in JP-A 58-142958, 58-147483, 58-147484, 9-157582, 11-106704, etc.), a silyl compound having a fluorine-containing long chain group of polyperfluoroalkyl ether group (compounds described in JP-A 2000-117902, 2001-48590, 2002-53804, etc.), etc.

As other additives than the above, the low-refractivity layer may contain a filler (for example, silicon dioxide (silica), a low-refractivity inorganic compound having a primary particle mean size of from 1 nm to 150 nm, such as fluorine-containing particles (magnesium fluoride, calcium fluoride, barium fluoride), etc., organic particles described in JP-A 11-3820, paragraphs [0020] to [0038], etc.), a silane coupling agent, a lubricant, a surfactant, etc.

In case where the low-refractivity layer is positioned as an underlayer of the outermost layer, the low-refractivity layer may be formed according to a vapor-phase method (vacuum evaporation method, sputtering method, ion plating method, plasma CVD method, etc.). The coating method is preferred as capable of producing the layer at low cost.

Preferably, the thickness of the low-refractivity layer is from 30 nm to 200 nm, more preferably from 50 nm to 150 nm, most preferably from 60 nm to 120 nm.

(Other Layers than Antireflection Layer)

Further, a hard coat layer, a front scattering layer, a primer layer, an antistatic layer, an undercoat layer, a protective layer and others may be provided.

### [Liquid-Crystal Display Device]

The liquid-crystal display device of the invention is an image display device having at least first and second polarizing films; a pair of substrates arranged to face each other and having an electrode on at least one of them, and a liquid-crystal cell having a liquid-crystal layer between the pair of substrates, as arranged between the first and second polarizing films; and the optical film of the invention arranged outside the first polarizing film, in which the absorption axis direction of the first polarizing film is at an angle of ±45° to both the in-plane slow axis of the first retardation region and the in-plane slow axis of the second retardation region in the optical film.

The liquid-crystal display device of the invention is applicable to liquid-crystal cells and liquid-crystal display devices of various display modes. The device is favorably applicable to various modes of TN (twisted nematic), IPS (in-plane switching), FLC (ferroelectric liquid crystal), AFLC (anti-ferroelectric liquid crystal), OCH (optically compensatory bend), STN (supper twisted nematic), VA (vertically aligned) and HAN (hybrid aligned nematic) modes.

### [Three-Dimensional Image Display System]

The three-dimensional image display system of the invention comprises at least the image display device of the invention and a third polarizing plate to be arranged outside the optical film of the invention, wherein a three-dimensional image is visualized through the third polarizing plate.

In particular, the image display system of the invention is for visualizing a three-dimensional image that is referred to as a 3D image for viewers, which therefore preferably visualizes the image through a glasses-like polarizing plate as the above-mentioned third polarizing plate.

### <Polarized Glasses>

The image display system of the invention includes polarized glasses where the slow axis of the right-eye glass is vertical to that of the left-eye glass and is preferably so designed that the right-eye image light outputted from anyone of the first region and the second region of the patterned retardation film passes through the right-eye les and is blocked by the left-eye glass while the left-eye image light outputted from the remaining one of the first region and the second region of the patterned retardation film passes through the left-eye glass and is blocked by the right-eye glass.

Naturally, the polarized glasses are constructed to include the retardation functional layer as positioned to correspond to the patterned retardation described in detail in the invention, and a linear polarizing element. The polarized glasses may include any other member having the same function as that of the linear polarizing element.

The concrete configurations of the image display system of the invention, including polarized glasses, are described below. First, the patterned retardation film is so designed as to have the above-mentioned first region and the above-mentioned second region that differ in the polarized light conversion function on multiple first lines and multiple second lines alternately repeated in the image display panel (for example, when the lines run in the horizontal direction, the regions may be on the odd-numbered lines and even-numbered lines in the horizontal direction, and when the lines run in the vertical direction, the regions may be on the odd-numbered lines and the even-numbered lines in the vertical direction). In case where a circularly-polarized light is used for display, the retardation of the above-mentioned first region and that of the second region are preferably both λ/4, and more preferably, the slow axes of the first region and the second region are vertical to each other.

In case where a circularly-polarized light is used for display, preferably, the retardation of the above-mentioned first region and that of the second region are both λ/4, the right-eye image is displayed on the odd-numbered lines of the image display panel, and when the slow axis in the odd-lined retardation region is in the direction of 45 degrees, a λ/4 plate is arranged in both the right-eye glass and the left-eye glass of the polarized glasses, and the λ/4 plate of the right-eye glass of the polarized glasses may be fixed concretely at about 45 degrees. In the above-mentioned situation, similarly, the left-eye image is displayed on the even-numbered lines of the image display panel, and when the slow axis of the even-numbered line retardation region is in the direction of 135 degrees, then the slow axis of the left-eye glass of the polarized glasses may be fixed concretely at about 135 degrees.

Further, from the viewpoint that a circularly-polarized image light is once outputted via the patterned retardation film and its polarization state is returned to the original state through the polarized glasses, the angle of the slow axis to be fixed of the right-eye glass in the above-mentioned case is preferably nearer to accurately 45 degrees in the horizontal direction. Also preferably, the angle of the slow axis to be fixed of the left-eye glass is nearer to accurately 135 degrees (or −45 degrees) in the horizontal direction.

For example, in a case where the image display panel is a liquid-crystal display panel, in general, it is desirable that the absorption axis direction of the front-side polarizing plate of the liquid-crystal display panel is in the horizontal direction and the absorption axis of the linear polarizing element of the polarized glasses is in the direction vertical to the absorption axis direction of the front-side polarizing plate, and more preferably, the absorption axis of the linear polarizing element of the polarized glasses is in the vertical direction.

Also preferably, the absorption axis direction of the front-side polarizing plate of the liquid-crystal display panel is at an angle of 45 degrees to each slow axis of the odd-numbered line retardation region and the even-numbered line retardation region of the patterned retardation film from the viewpoint of the polarized light conversion efficiency of the system.

Preferred configurations of the polarized glasses as well as those of the patterned retardation film and the liquid-crystal display device are disclosed in, for example, JP-A 2004-170693.

As examples of polarized glasses usable here, there are mentioned those described in JP-A 2004-170693, and as commercial products thereof, there are mentioned accessories to Zalman's ZM-M220 W.

### <Configuration of Other Three-Dimensional Image Display System>

Preferably, the image display system includes a panel for pixel display, in which the pixels form a pixel group in such a manner that the pixels are arranged repeatedly in line with their height kept equal to each other and in which the first retardation region and the second retardation region of the optical film are patterned alternately in accordance with the line of the line-like arranged pixel group.

### EXAMPLES

The invention is described in more detail with reference to the following Examples. In the following Examples, the material used, its amount and ratio, the details of the treatment and the treatment process may be suitably modified or changed not overstepping the spirit and the scope of the invention. Accordingly, the invention should not be limitatively interpreted by the Examples mentioned below.

### Reference Example 1

### (1) Production of Rubbed Alignment Film-Attached Transparent Support (Alignment Films A to C)

### (Production of Alignment Film A)

A 4% water/methanol solution of Kuraray's polyvinyl alcohol “PVA103” (prepared by dissolving PVA-103 (4.0 g) in water (72 g) and methanol (24 g) and having a viscosity of 4.35 cp and a surface tension of 44.8 dyne) was applied onto the surface of a transparent glass support, using a number 12 bar, and dried at 120° C. for 2 minutes. Re(550) of the glass support was 0 nm, Rth thereof was 0 nm, and the thickness of the alignment film was 0.9 μm. Subsequently, this was rubbed once before and behind in one direction at 1000 rpm, thereby producing a rubbed alignment film-attached glass support (alignment film A). This alignment film generally acts as a horizontal alignment film.

### (Production of Alignment Film B)

Like in the above, a solution of a vertical alignment film (Compound Number 5) (prepared by dissolving 1.323 g of the alignment film in 0.329 g of triethylamine and 38.35 g of methanol, and having a viscosity of 0.84 cp and a surface tension of 22.7 dyne) was applied onto the surface of a transparent glass support, using a number 12 bar, and dried at 120° C. for 2 minutes. The thickness of the alignment film was 0.9 μm. Subsequently, this was rubbed once before and behind in one direction at 1000 rpm, thereby producing a rubbed alignment film-attached glass support (alignment film B). This alignment film generally acts as a vertical alignment film.

### (Production of Alignment Film C)

A 4% water/methanol solution of Kuraray's polyvinyl alcohol “PVA103” (prepared by dissolving PVA-103 (4.0 g) in water (72 g) and methanol (24 g) and having a viscosity of 4.35 cp and a surface tension of 44.8 dyne) was applied onto the surface of a transparent glass support, using a number 12 bar, and dried at 120° C. for 2 minutes. Re(550) of the glass support was 0 nm, Rth thereof was 0 nm, and the thickness of the PVA alignment film was 0.9 μm. Onto the parallel alignment film, applied was a solution of a vertical alignment film (Compound Number 5) (prepared by dissolving 1.323 g of the alignment film in 0.329 g of triethylamine and 38.35 g of methanol, and having a viscosity of 0.84 cp and a surface tension of 22.7 dyne), using a number 12 bar, and dried at 120° C. for 2 minutes. The total thickness of the alignment film was 1.8 μm. Subsequently, this was rubbed once before and behind in one direction at 1000 rpm, thereby producing a rubbed alignment film-attached glass support (alignment film C).

### (2) Coating with Liquid Crystal, Curing, Confirmation of Alignment in Obtained Optical Film

0.35 ml of the following liquid crystal composition 1 was applied onto the alignment film-attached glass substrate in a mode of spin coating (2500 rpm, 10 seconds), and while heated at 90° C., this was cured through UV irradiation (10 seconds), and then the alignment condition therein was confirmed with a microscope.

Rod-Shaped Liquid-Crystal Composition 1

Methyl ethyl ketone (MEK) solution having a solid content of 26% of the following polymerizing liquid crystal 1/the following polymerization initiator 1/the following air interface alignment agent 1 (=100/3/0.3, % by weight—the same shall apply hereinunder).

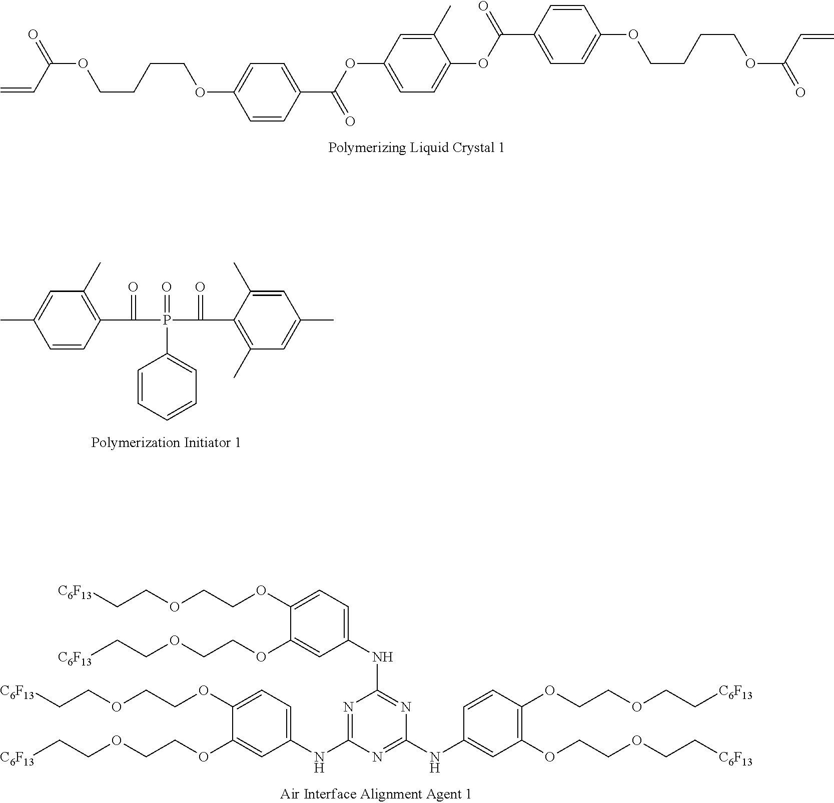

### Reference Example 2

An optical film was produced in the same manner as in Reference Example 1 except that the following rod-shaped liquid-crystal composition 2 was used in place of the above-mentioned liquid-crystal composition 1, and the obtained film was inspected with a microscope.

Rod-Shaped Liquid-Crystal Composition 2

Methyl ethyl ketone (MEK) solution having a solid content of 26% of the following polymerizing liquid crystal 2/the above polymerization initiator 1/the above air interface alignment agent 1 (=100/3/0.3).

### Polymerizing Liquid Crystal 2

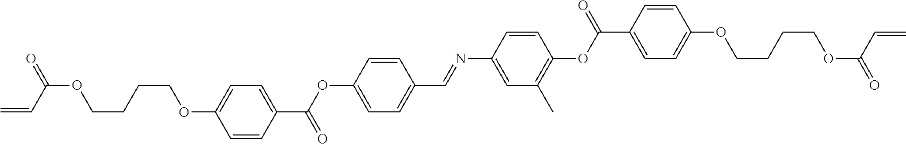 [SMILES: C=CC(=O)OCCCCOc1ccc(C(=O)Oc2ccc(/C=N/c3ccc(OC(=O)c4ccc(OCCCCOC(=O)C=C)cc4)c(C)c3)cc2)cc1]

### Reference Example 3

An optical film of Reference Example 3 was produced in the same manner as in Reference Example 1, except that the following discotic liquid-crystal composition 1 was used in place of the above-mentioned liquid-crystal composition 1 and that the coating film of the discotic liquid-crystal composition 1 was heated up to 140° C. and then cooled to 90° C. and thereafter UV-irradiated, and the obtained film was inspected with a microscope.

Discotic Liquid-Crystal Composition 1

MEK solution having a solid content of 20% of the following polymerizing liquid crystal 3/the following polymerization initiator 2/the following sensitizer 1/the following pyridinium compound 1/the following air interface alignment agent 2/the following air interface alignment agent 3 (=100/3/1/2/0.3/0.5).

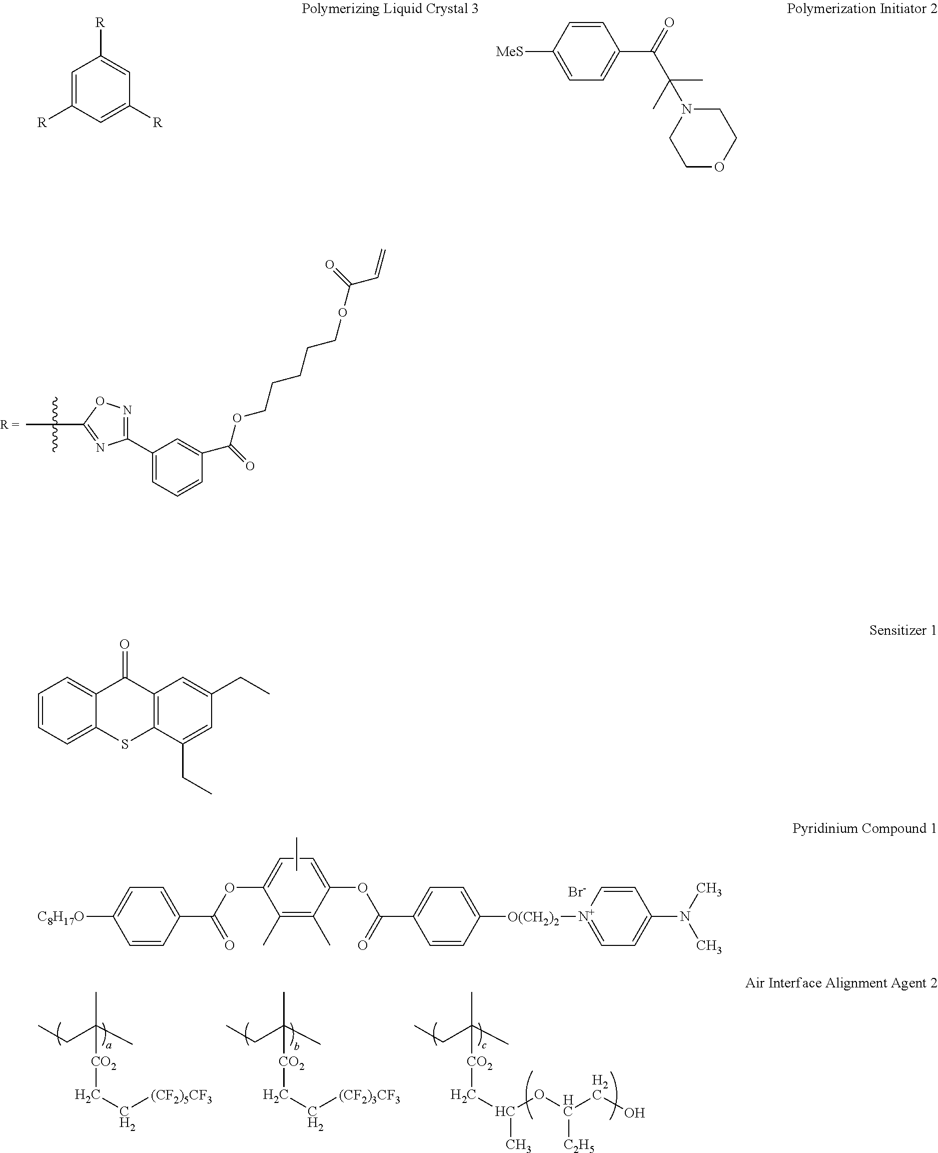

### Air Interface Alignment Agent 3

Cellulose acylate butyrate (Eastman Chemical's CAB551-0.2)

### Reference Example 4

An optical film of Reference Example 4 was produced in the same manner as in Reference Example 1, except that the following discotic liquid-crystal composition 2 was used in place of the above-mentioned liquid-crystal composition 1 and that the coating film of the discotic liquid-crystal composition 2 was heated up to 140° C. and then cooled to 90° C. and thereafter UV-irradiated, and the obtained film was inspected with a microscope.

### (Discotic Liquid-Crystal Composition 2)

MEK solution having a solid content of 20% of the following polymerizing liquid crystal 4/the above polymerization initiator 2/the above sensitizer 1/the above pyridinium compound 1/the above air interface alignment agent 2/the above air interface alignment agent 3 (=100/3/1/2/0.3/0.5).

### Polymerizing Liquid Crystal 4

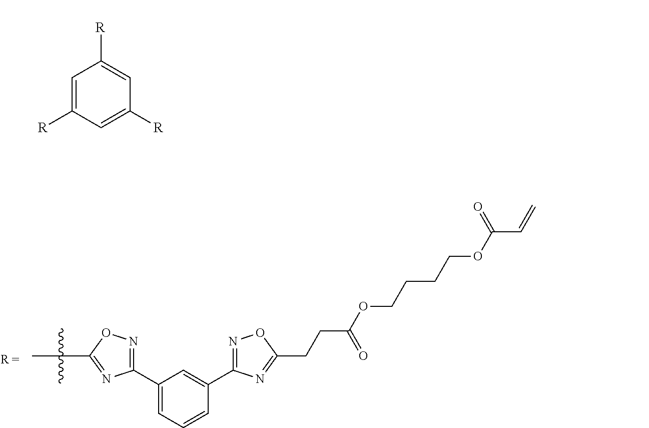

In Reference Examples 1 to 4, the inspected results of the alignment in the films through microscopy are summarized in the following Table. In this description including the following Tables, “parallel alignment” means that the rubbing direction of the alignment film is nearly parallel to the long axis of the rod-shaped liquid crystal. “Vertical alignment” means that the rubbing direction of the alignment film is nearly vertical to the long axis of the rod-shaped liquid crystal. “Parallel/vertical alignment” means that the discotic face of the discotic liquid crystal rises nearly vertical to the alignment film and the rubbing direction of the alignment film is nearly vertical to the direction (long axis) in which the discotic face of the discotic liquid crystal is laminated.

TABLE 28

| | Liquid-Crystal | Alignment | Alignment | Alignment |
|---|---|---|---|---|
| | Composition | Film A | Film B | Film C |
| Reference | rod-shaped | parallel | vertical | vertical |
| Example 1 | liquid-crystal | alignment | alignment | alignment |
| | composition 1 | | | |
| Reference | rod-shaped | parallel | vertical | vertical |
| Example 2 | liquid-crystal | alignment | alignment | alignment |
| | composition 2 | | | |
| Reference | discotic | parallel/ | orthogonal/ | orthogonal/ |
| Example 3 | liquid-crystal | vertical | vertical | vertical |
| | composition 1 | alignment | alignment | alignment |
| Reference | discotic | parallel/ | orthogonal/ | orthogonal/ |
| Example 4 | liquid-crystal | vertical | vertical | vertical |
| | composition 2 | alignment | alignment | alignment |

From the above Table, it is known that, by using the alignment films, the alignment of liquid crystal can be controlled.

### Example 1

### Production of Patterned Retardation Film

### (1) Coating with Parallel Alignment Film (First Alignment Film)

A 4% water/methanol solution of Kuraray's polyvinyl alcohol “PVA103” (prepared by dissolving PVA-103 (4.0 g) in water (72 g) and methanol (24 g) and having a viscosity of 4.35 cp and a surface tension of 44.8 dyne) was applied onto the surface of a TAC film, using a number 12 bar, and dried at 80° C. for 5 minutes (film A).

### (2) Pattern-Coating with Vertical Alignment Film (Second Alignment Film)

2.646 g of the above-mentioned compound for vertical alignment film (compound No. 5) was dissolved in 0.658 g of triethylamine and 12 g of tetrafluoropropanol to prepare a vertical alignment film liquid 1 for pattern printing.

As a flexographic plate, a synthetic rubber-made flexographic plate was produced, having the profile with the dimension shown in FIG. 1.

As the flexographic printing apparatus 10 shown in FIG. 2, used here was FlexoProof 100 (RK Print Coat Instruments Ltd., UK). The anilox roller 13 used here is one with cell 400 lines/cm (volume 3 cm³/m²). The flexographic plate 1 was stuck to the impression cylinder 11 of FlexoProof 100 via a pressure-sensitive tape (not shown). The above-mentioned film A was stuck to the printing roller 12, and then the above-mentioned, vertical alignment film liquid 1 for pattern printing (reference number 3 in FIG. 2) was put into the doctor blade 14, and pattern-like printed on the parallel alignment film to form a vertical alignment film thereon, at a printing rate of 30 m/min (under anilox roller pressure of 40 and printing roller pressure of 42, both requiring no unit of quantity) (film B).

### (3) Formation of Rubbed Alignment Film

The film B was dried at 80° C. for 5 minutes, then rubbed once before and behind in one direction at 1000 rpm, thereby producing a rubbed alignment film-attached TAC film (film C1).

### (4) Coating with Liquid Crystal, Curing and Confirmation of Alignment in Obtained Patterned Retardation Film

The above-mentioned rod-shaped liquid-crystal composition 1 was applied to the film C1 in a mode of spin coating (2500 rpm, 10 seconds), and cured through UV irradiation (10 seconds) while heated at 90° C., and thereafter the alignment in the film was inspected with a microscope (patterned retardation film 1). It was confirmed that, in the patterned retardation film 1, the slow axis of the parallel alignment film region aligned in the direction parallel to the rubbing direction and the slow axis of the vertical alignment film region aligned in the direction vertical thereto.

### Example 2

A patterned retardation film 2 was produced in the same manner as in Example 1 except that the liquid-crystal composition to be applied was changed from the rod-shaped liquid-crystal composition 1 to the above-mentioned rod-shaped liquid-crystal composition 2. It was confirmed that, in the patterned retardation film 2, the slow axis of the parallel alignment film region aligned in the direction parallel to the rubbing direction and the slow axis of the vertical alignment film region aligned in the direction vertical thereto.

### Example 3

A patterned retardation film 3 was produced in the same manner as in Example 1 except that the liquid-crystal composition to be applied was changed from the rod-shaped liquid-crystal composition 1 to the above-mentioned discotic liquid-crystal composition 1 and that the film was heated up to 140° C. in the step of heating and then cooled to 90° C. and thereafter UV-irradiated. It was confirmed that, in the patterned retardation film 3, the slow axis of the parallel alignment film region was in the parallel/vertical direction relative to the rubbing direction and the slow axis of the vertical alignment film region was in the orthogonal/vertical direction thereto.

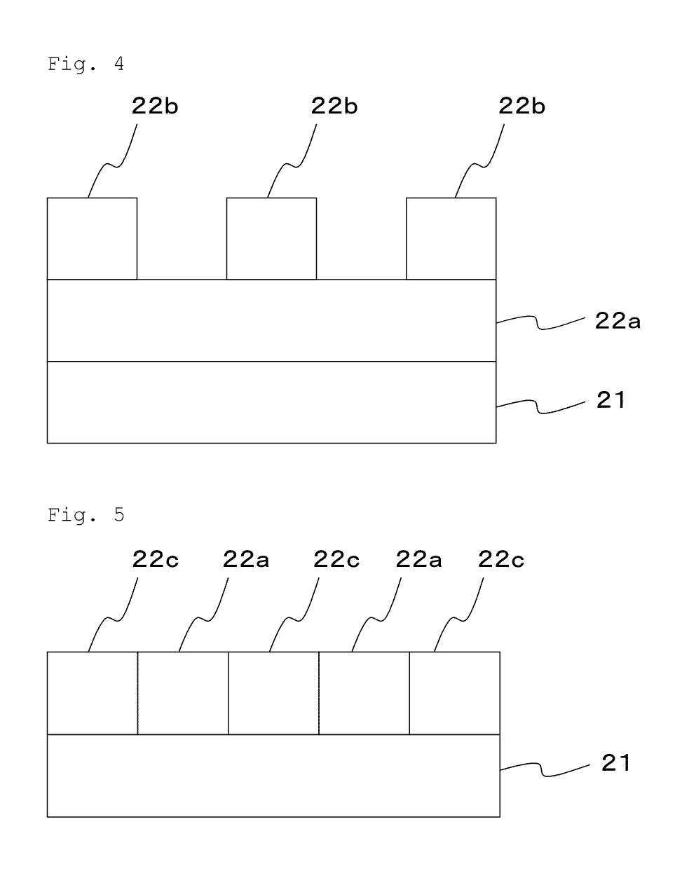

The patterned optical anisotropic layer was put between two polarizing plates combined in a vertical state to each other in such a manner that the slow axis of any one of the first retardation region or the second retardation region thereof could be parallel to the polarization axis of any one of those polarizing plates, and further, a sensitive color plate having a retardation of 530 nm was put on the optical anisotropic layer in such a manner that the slow axis of the plate could be at an angle of 45° to the polarization axis of each polarizing plate (FIG. 3(A)). Next, a state where the optical anisotropic layer was rotated by +45° (FIG. 3(B) a state where the layer was rotated by −45° (FIG. 3(C)) were observed with a polarizing microscope (Nikon's ECLIPE E600 W POL). As obvious from the observation results shown in FIGS. 3(A) to (C), in the case where the layer was rotated by +45°, the slow axis of the first retardation region was parallel to the slow axis of the sensitive color plate, and therefore the retardation was larger than 530 nm and the color changed to blue (the dark part in the white-and-black picture). On the other hand, the slow axis of the second retardation region was vertical to the slow axis of the sensitive color plate, and therefore the retardation was smaller than 530 nm and the color changed to yellow (the light part in the white-and-black picture). In the case where the layer was rotated by −45°, opposite phenomena to the above appeared.

### Example 4

A patterned retardation film 4 was produced in the same manner as in Example 1 except that the liquid-crystal composition to be applied was changed from the rod-shaped liquid-crystal composition 1 to the above-mentioned discotic liquid-crystal composition 2 and that the film was heated up to 140° C. in the step of heating and then cooled to 90° C. and thereafter UV-irradiated. It was confirmed that, in the patterned retardation film 4, the slow axis of the parallel alignment film region was in the parallel/vertical direction relative to the rubbing direction and the slow axis of the vertical alignment film region was in the orthogonal/vertical direction thereto.

### Example 5

A patterned retardation film 5 was produced in the same manner as in Example 1 except that the vertical alignment film liquid to be applied for pattern printing was changed from the vertical alignment film liquid 1 for pattern printing to the vertical alignment film liquid 2 for pattern printing where the compound number 31 was used. It was confirmed that, in the patterned retardation film 5, the slow axis of the parallel alignment film region aligned in the direction parallel to the rubbing direction and the slow axis of the vertical alignment film region aligned in the direction vertical thereto.

### Example 6

A patterned retardation film 6 was produced in the same manner as in Example 1 except that the vertical alignment film liquid to be applied for pattern printing was changed from the vertical alignment film liquid 1 for pattern printing to the vertical alignment film liquid 2 for pattern printing where the compound number 46 was used. It was confirmed that, in the patterned retardation film 6, the slow axis of the parallel alignment film region aligned in the direction parallel to the rubbing direction and the slow axis of the vertical alignment film region aligned in the direction vertical thereto.

### Example 7

### Discotic Liquid-Crystal Composition 3

First prepared was a MEK solution having a solid content of 20% of the above polymerizing liquid crystal 4/the above polymerization initiator 2/the above sensitizer 1/the above air interface alignment agent 2/the above air interface alignment agent 3 (=100/3/1/0.3/0.5).

The surface of a TAC film was coated with a 4% water/methanol/triethylamine solution of polyacrylic acid by Wako Pure Chemicals, using a number 12 bar, dried at 80° C. for 5 minutes (film A2). Onto this, a patterned retardation film 7 was formed in the same manner as in Example 1, except that a solution, which had been prepared by 50% dissociating the acrylic acid moiety of a polystyrene (55% by mass)/polyacrylic acid (45% by mass) copolymer (BASF's Joncryl 690, Mw 16500, acid value 240) and dissolving it in propanol, was flexoprinted thereon and dried and thereafter rubbed in the same manner as above and that the liquid-crystal composition to be applied was changed from the above-mentioned rod-shaped liquid-crystal composition 1 to the discotic liquid-crystal composition 3 that had been prepared in the above and the film, was heated at 110° C. It was confirmed that, in the patterned retardation film 7, the slow axis of the parallel alignment film region was in the parallel/vertical direction relative to the rubbing direction and the slow axis of the vertical alignment film region was in the orthogonal/vertical direction thereto.

### Example 8

A patterned retardation film 8 was produced in the same manner as in Example 3, except that the vertical alignment film liquid for pattern printing was changed from the vertical alignment film liquid 1 for pattern printing to an aqueous propanol solution that had been prepared by 90% dissociating polyacrylic acid (Mw 25000, by Wako Pure Chemicals) with triethylamine (polyacrylic acid 2.0 g/water 1.12 g/propanol 5.09 g/3-methoxy-1-butanol 5.09 g/triethylamine 2.52 g) and that the liquid-crystal composition to be applied was changed to the above-mentioned discotic liquid-crystal composition 2. It was confirmed that, in the patterned retardation film 8, the slow axis of the upper region of the PVA 103 moiety was in the parallel/vertical direction relative to the rubbing direction and the slow axis of the upper region of the polyacrylic acid moiety that is naturally in a parallel alignment state was in the orthogonal/vertical direction to the rubbing direction owing to the influence of the pyridinium additive thereon. Specifically, it was known that, when the pyridinium compound-containing discotic liquid-crystal compound was applied onto the upper region of the PVA 103 moiety, then once heated up to T_{Iso} and thereafter cooled, then the discotic liquid-crystal compound aligned in the parallel/vertical direction relative to the rubbing direction. In addition, it was also known that, when the pyridinium compound-containing discotic liquid-crystal compound was applied onto the upper region of the polyacrylic acid moiety, then once heated up to T_{Iso} and thereafter cooled, then the discotic liquid-crystal compound aligned in the orthogonal/vertical direction relative to the rubbing direction.

### Example 9

### (1) Coating with Parallel Alignment Film (First Alignment Film)

The surface of a TAC film was coated with a 4% water/methanol/triethylamine solution of a polyacrylic acid by Wako Pure Chemicals, using a number 12 bar, and then dried at 80° C. for 5 minutes (film A2).

### (2) Pattern-Coating for Pyridinium Compound-Containing Alignment Control Region

As a vertical alignment film liquid for pattern printing, 10 g of the above-mentioned pyridinium compound was dissolved in 100 g of methyl ethyl ketone to prepare a pyridinium solution 1 for pattern printing.

According to an inkjet system, the pyridinium solution 1 was printed on the film A2 to form a pattern thereon. In this Example, an inkjet head was used as the discharge part. The inkjet head used here is FUJIFILM DIMATIX's DMP2831 head, DMC-11610 (product lot number). In this case, it was confirmed that the pyridinium solution remained on the first alignment film without being dried, and penetrated into the inside of the first alignment film right below the printed part.

### (3) Formation of Rubbed Alignment Film

Subsequently, a patterned retardation film 9 was produced in the same manner as in Example 3 except that the above-mentioned discotic liquid-crystal composition 1 was used as the liquid-crystal composition to be applied and that the heating temperature was changed to from 100° C. to lower than 140° C. (T_{Iso}). It was confirmed that, in the optical anisotropic layer of the patterned retardation film 9, the slow axis of the alignment film region above the part not containing the pyridinium compound aligned in the direction parallel to the rubbing direction and the slow axis of the upper region of the part on which the pyridinium compound had been printed by inkjet printing aligned in the direction vertical to the rubbing direction owing to the influence of the pyridinium additive thereon. Specifically, it was known that, when the discotic liquid-crystal compound (not containing the pyridinium compound) was applied onto the upper region of the polyacrylic acid moiety not containing the pyridinium compound, then once heated up to T_{Iso} and thereafter cooled, then the discotic liquid-crystal compound aligned in the parallel/vertical direction relative to the rubbing direction. In addition, it was also known that, when the discotic liquid-crystal compound (not containing the pyridinium compound) was applied onto the upper region of the polyacrylic acid moiety containing the pyridinium compound, then once heated up to T_{Iso} and thereafter cooled, then the discotic liquid-crystal compound aligned in the orthogonal/vertical direction relative to the rubbing direction.

### Example 10

A patterned retardation film 10 was produced in the same manner as in Example 8, except that the film was, not heated at all up to 140° C. (T_{Iso}), heated only to from 100 to 120° C., in place of heating it up to 140° C. followed by cooling to 90° C. It was confirmed that, in the patterned retardation film 10, the slow axis of the upper region of the PVA 103 moiety was in the parallel/vertical direction relative to the rubbing direction and the slow axis of the upper region of the polyacrylic acid moiety was in the parallel/vertical direction to the rubbing direction owing to the influence of the pyridinium additive thereon. Specifically, it was known that, when the pyridinium compound-containing discotic liquid-crystal compound was applied onto the upper region of the PVA 103 moiety and then heated up to from 100 to 120° C., without being heated at all up to T_{Iso}, then the discotic liquid-crystal compound aligned in the orthogonal/vertical direction relative to the rubbing direction. In addition, it was also known that, when the pyridinium compound-containing discotic liquid-crystal compound was applied onto the upper region of the polyacrylic acid moiety and then heated up to from 100 to 120° C., without being heated at all up to T_{Iso}, then the discotic liquid-crystal compound aligned in the parallel/vertical direction relative to the rubbing direction.

### Example 11

A patterned retardation film 11 was produced in the same manner as in Example 9, except that a solution, which had been prepared by 50% dissociating the acrylic acid moiety of a polystyrene (55% by mass)/polyacrylic acid (45% by mass) copolymer (BASF's Joncryl 690, Mw 16500, acid value 240) followed by dissolving it in propanol, was used in place of the 4% water/methanol/triethylamine solution of Wako Pure Chemicals' polyacrylic acid and that the film was heated up to 140° C. in place of heating it at a temperature of from 100° C. to lower than 140° C. (T_{Iso}) in the heating step, and thereafter cooled to 90° C. It was confirmed that, in the patterned retardation film 11, the slow axis of alignment film region above the part not containing the pyridinium compound aligned in the vertical direction relative to the rubbing direction and the slow axis of the upper region where the pyridinium compound had been printed by inkjet printing aligned in the direction parallel to the rubbing direction owing to the influence of the pyridinium additive thereon. Specifically, it was known that, when the discotic liquid-crystal compound (not containing the pyridinium compound) was applied onto the upper region of the polystyrene/polyacrylic acid copolymer moiety not containing the pyridinium compound, and heated up to from 100° C. to lower than 140° C. not heated at all up to T_{Iso}, then the discotic liquid-crystal compound aligned in the orthogonal/vertical direction relative to the rubbing direction. In addition, it was also known that, when the discotic liquid-crystal compound (not containing the pyridinium compound) was applied onto the upper region of the polystyrene/polyacrylic acid copolymer moiety containing the pyridinium compound, and heated up to from 100° C. to less than 140° C. not heated at all up to T_{Iso}, then the discotic liquid-crystal compound aligned in the parallel/vertical direction relative to the rubbing direction.

Re of the laminates obtained in Examples 1 to 11 was determined according to the method described herein, and the results are summarized in the following Table.

TABLE 29

| | Re of Printed Part | Re of Non-Printed Part |
|---|---|---|
| Example 1 | 126 | 132 |
| Example 2 | 125 | 130 |
| Example 3 | 161 | 164 |
| Example 4 | 140 | 141 |
| Example 5 | 144 | 146 |
| Example 6 | 152 | 155 |
| Example 7 | 125 | 132 |
| Example 8 | 155 | 160 |
| Example 9 | 155 | 161 |
| Example 10 | 154 | 160 |
| Example 11 | 148 | 150 |

### Example 12

Black ink (Dainichiseika Color & Chemicals' Hydric FCG) was flexoprinted in the boundary region having a width of 30 μm between the printed part and the non-printed part of the patterned alignment film obtained in Example 8, thereby producing a patterned retardation 12. Subsequently, a liquid crystal was applied thereto in the same manner as in Example 8 to give a patterned retardation film 12 having a black matrix.

### Comparative Example 1

A generally known vertical alignment film of polystyrene (Photoalignment of Liquid Crystal, written by Kunihiro Yoneda, published Yoneda Publishing, p. 83) was dissolved in a toluene solvent. This was used for pattern-like printing as a vertical alignment film liquid for pattern printing in place of the vertical alignment film used in Example 1. Subsequently, the rod-shaped liquid-crystal composition 1 was applied thereto according to spin coating in the same manner as in Example 1, then heated and UV-irradiated at room temperature on the entire surface thereof. However, vertical alignment was not confirmed in the film but partial parallel alignment alone was confirmed therein. This is because the polystyrene of the vertical alignment film was soluble in the solvent MEK for the rod-shaped liquid-crystal composition 1 and therefore the patterned alignment film dissolved therein. From the above, it is known that in alignment film printing, it is necessary that the coating solvent for the liquid-crystal composition should not evade the parallel alignment film and the vertical alignment film.

### Comparative Example 2

An alignment film compound having the following composition was produced according to the same synthesis method as that for the compound 5 used in Example 1 (Mn 13421, Mw 31543, Mw/Mn=2.350).

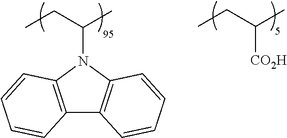

Like in Example 1, dissolving 2.646 g of the above alignment film compound in 0.658 g of triethylamine and 12 g of tetrafluoropropanol was tried, but the compound could not dissolve therein at all. Since a large quantity of solvent was needed for dissolving the compound, and the compound was therefore unsuitable for a flexoprinting ink.

### Comparative Example 3

An alignment film compound having the following composition was produced according to the same synthesis method as that for the compound 5 used in Example 1 (Mn 5053, Mw 24501, Mw/Mn=4.848).

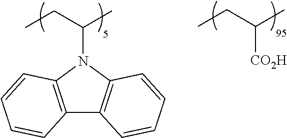

A vertical alignment film was pattern-like formed on the film A according to a flexoprinting method in the same manner as in Example 1, except that 2.646 g of the above-mentioned alignment film compound was dissolved in 0.658 g of triethylamine and 12 g of tetrafluoropropanol to prepare a vertical alignment film liquid for pattern printing. As a result, the film exhibited parallel alignment in the entire region and any vertical alignment region could not be confirmed therein.

Using a number 12 bar, the vertical alignment film solution for pattern printing (Comparative Example 3) was applied onto a PVA 103 alignment film, dried at 120° C. for 2 minutes, and thereafter rubbed once before and behind in one direction at 1000 rpm, thereby producing a rubbed alignment film-attached glass substrate. The above-mentioned rod-shaped liquid-crystal composition 1 was applied onto the alignment film according to spin coating. The solvent was evaporated away, and the coating liquid of the liquid-crystal composition was heated and fixed through entire surface UV irradiation. As a result, all the region of the film exhibited parallel alignment and any vertical alignment part could not be confirmed in the film.

### Comparative Example 4

An alignment film compound having the following composition was produced according to the same synthesis method as that for the compound 5 used in Example 1.

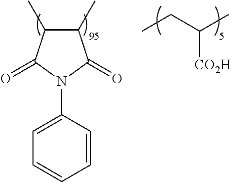

Like in Comparative Example 2, dissolving 2.646 g of the above alignment film compound in 0.658 g of triethylamine and 12 g of tetrafluoropropanol was tried, but the compound could not dissolve therein at all. Since a large quantity of solvent was needed for dissolving the compound, and the compound was therefore unsuitable for a flexoprinting ink.

### Comparative Example 5

A compound having the following composition was produced according to the same synthesis method as that for the compound 5 used in Example 1.

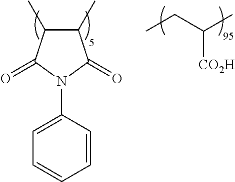

A vertical alignment film was pattern-like formed on the film A according to a flexoprinting method in the same manner as in Example 1, except that 2.646 g of the alignment film compound was dissolved in 0.658 g of triethylamine and 12 g of tetrafluoropropanol to prepare a vertical alignment film liquid for pattern printing like in Comparative Example 3. As a result, the film exhibited parallel alignment in the entire region and any vertical alignment region could not be confirmed therein.

Using a number 12 bar, the vertical alignment film solution for pattern printing (Comparative Example 3) was applied onto a PVA 103 alignment film, dried at 120° C. for 2 minutes, and thereafter rubbed once before and behind in one direction at 1000 rpm, thereby producing a rubbed alignment film-attached glass substrate. The rod-shaped liquid-crystal composition 1 was applied onto the alignment film according to spin coating. The solvent was evaporated away, and the coating liquid of the liquid-crystal composition was heated and fixed through entire surface UV irradiation. As a result, all the region of the film exhibited parallel alignment and any vertical alignment part could not be confirmed in the film.

### Example 101

### Production of Antireflection Film

A hard coat layer was formed by coating on the patterned retardation film 1 of Example 1.

### (Preparation of Hard Coat Layer Coating Liquid)

The following ingredients were put into a mixing tank and stirred to prepare a hard coat layer coating liquid.

100 parts by mass of cyclohexanone, 750 parts by mass of a partially caprolactone-modified polyfunctional acrylate (DPCA-20, by Nippon Kayaku), 200 parts by mass of silica sol (MIBK-ST, by Nissan Chemical) and 50 parts by mass of a photopolymerization initiator (Irgacure 184, by Ciba Specialty Chemicals) were added to 900 parts by mass of methyl ethyl ketone, and stirred. The mixture was filtered through a polypropylene filter having a pore size of 0.4 μm to prepare a coating liquid for hard coat layer.

### (Preparation of Coating Liquid A for Middle-Refractivity Layer)

1.5 parts by mass of a mixture of dipentaerythritol pentaacrylate and dipentaerythritol hexaacrylate (DPHA), 0.05 parts by mass of a photopolymerization initiator (Irgacure 907, by Ciba Specialty Chemicals), 66.6 parts by mass of methyl ethyl ketone, 7.7 parts by mass of methyl isobutyl ketone and 19.1 parts by mass of cyclohexanone were added to 5.1 parts by mass of a ZrO₂ fine particles-containing hard coat agent (Desolight Z7404 [having a refractive index of 1.72, a solid concentration of 60% by mass, a content of zirconium oxide fine particles of 70% by mass (relative to solid fraction), a mean particle diameter of zirconium oxide fine particles of about 20 nm, a solvent composition of methyl isobutyl ketone/methyl ethyl ketone of 9/1, by JSR], and stirred. After fully stirred, the mixture was filtered through a polypropylene filter having a pore size of 0.4 μm to prepare a coating liquid A for middle-refractivity layer.

### (Preparation of Coating Liquid B for Middle-Refractivity Layer)

4.5 parts by mass of a mixture of dipentaerythritol pentaacrylate and dipentaerythritol hexaacrylate (DPHA), 0.14 parts by mass of a photopolymerization initiator (Irgacure 907, by Ciba Specialty Chemicals), 66.5 parts by mass of methyl ethyl ketone, 9.5 parts by mass of methyl isobutyl ketone and 19.0 parts by mass of cyclohexanone were stirred. After fully stirred, the mixture was filtered through a polypropylene filter having a pore size of 0.4 μm to prepare a coating liquid B for middle-refractivity layer.

The middle-refractivity layer coating liquid A and the middle-refractivity layer coating liquid B were suitably mixed so as to have a refractive index of 1.36 and a film thickness of 90 μm, thereby preparing a middle refractivity layer coating liquid.

### (Preparation of Coating Liquid for High-Refractivity Layer)

0.75 parts by mass of a mixture of dipentaerythritol pentaacrylate and dipentaerythritol hexaacrylate (DPHA), 62.0 parts by mass of methyl ethyl ketone, 3.4 parts by mass of methyl isobutyl ketone and 1.1 parts by mass of cyclohexanone were added to 14.4 parts by mass of a ZrO₂ fine particles-containing hard coat agent (Desolight Z7404 [having a refractive index of 1.72, a solid concentration of 60% by mass, a content of zirconium oxide fine particles of 70% by mass (relative to solid fraction), a mean particle diameter of zirconium oxide fine particles of about 20 nm, a solvent composition of methyl isobutyl ketone/methyl ethyl ketone of 9/1, and containing a photopolymerization initiator, by JSR], and stirred. After fully stirred, the mixture was filtered through a polypropylene filter having a pore size of 0.4 μm to prepare a coating liquid C for high refractivity layer.

### [Preparation of Coating Liquid for Low Refractivity Layer]

### (Synthesis of Perfluoro-Olefin Copolymer (1))

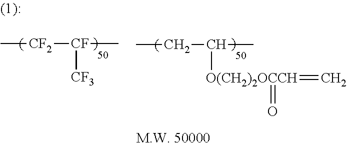

In the above structural formula, 50/50 is a ratio by mol.

40 ml of ethyl acetate, 14.7 g of hydroxyethyl vinyl ether and 0.55 g of dilauroyl peroxide were put into an autoclave having an inner capacity of 100 ml and equipped with a stainless stirrer, and the system was degassed and purged with nitrogen gas. Further, 25 g of hexafluoropropylene (HFP) was introduced into the autoclave and heated up to 65° C. The pressure when the temperature inside the autoclave reached 65° C. was 0.53 MPa (5.4 kg/cm²). While kept at the temperature, the reaction was continued for 8 hours, and when the pressure reached 0.31 MPa (3.2 kg/cm²), the heating was stopped and the system was left cooled. After the inner temperature lowered to room temperature, the unreacted monomer was expelled away, and the autoclave was opened to take out the reaction liquid. The obtained reaction liquid was put into a large excessive amount of hexane, and the solvent was removed through decantation to thereby take out the precipitated polymer. Further, the polymer was dissolved in a small amount of ethyl acetate and reprecipitated twice from hexane to thereby completely remove the remaining monomer. After dried, 28 g of a polymer was obtained. Next, 20 g of the polymer was dissolved in 100 ml of N,N-dimethylacetamide, and with cooling with ice, 11.4 g of acrylic acid chloride was dropwise added thereto, and then stirred at room temperature for 10 hours. Ethyl acetate was added to the reaction liquid, than this was washed with water, and the organic layer was extracted out and concentrated. The resulting polymer was reprecipitated from hexane to give 19 g of a perfluoro-olefin copolymer (1). The refractive index of the thus-obtained polymer was 1.422, and the mass-average molecular weight thereof was 50000.

### [Preparation of Hollow Silica Particles Dispersion A]

30 parts by mass of acryloyloxypropyltrimethoxysilane and 1.51 parts by mass of diisopropoxyaluminiumethyl acetate were added to and mixed with 500 parts by mass of a sol of hollow silica fine particles (isopropyl alcohol silica sol, Catalysts & Chemicals Industries' CS60-IPA, having a mean particle diameter of 60 nm, a shell thickness of 10 nm, a silica concentration of 20% by mass, a refractive index of silica particles of 1.31), and then 9 parts by mass of ion-exchanged water was added thereto. After reacted at 60° C. for 8 hours, this was cooled to room temperature, then 1.8 parts by mass of acetylacetone was added thereto to prepare a dispersion. Subsequently, while cyclohexanone was added thereto until the silica content became almost constant, the system was processed for solvent substitution through reduced pressure distillation under a pressure of 30 Torr, thereby giving a dispersion A having a solid concentration of 18.2% by mass through final concentration control. The remaining IPA amount in the thus-obtained dispersion A was at most 0.5% by mass, as found through gas chromatography.

### [Preparation of Coating Liquid for Low Refractivity Layer]

The following ingredients were mixed and dissolved in methyl ethyl ketone to prepare a coating liquid Ln6 for low refractivity layer having a solid concentration of 5% by mass. The amount of each ingredient shown below is the ratio of the solid content of each ingredient, in terms of % by mass relative to the total amount of the coating liquid.

| | |
|---|---|
| P-1: perfluoro-olefin copolymer (1) | 15% by mass |
| DPHA: mixture of dipentaerythritol pentaacrylate and | 7% by mass |
| dipentaerythritol hexaacrylate (by Nippon Kayaku) | |
| MF1: fluorine-containing unsaturated compound | 5% by mass |
| mentioned below, described in Examples in | |
| W02003/022906 (having a weight- | |
| average molecular weight of 1600) | |
| M-1: Nippon Kayaku's KAYARAD DPHA | 20% by mass |
| Dispersion A: hollow silica particles dispersion A mentioned | 50% by mass |
| above (sol of hollow silica particles surface-modified with | |
| acryloyloxypropyltrimethoxysilane, having a solid | |
| concentration of 18.2%) | |
| Irg 127: photopolymerization initiator Irgacure 127 (by Ciba | 3% by mass |
| Specialty Chemicals) | |

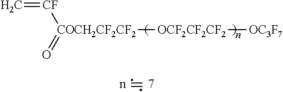

Using a gravure coater, the hard coat layer coating liquid having the composition mentioned above was applied onto the above-mentioned optical film. This was dried at 100° C. While purged with nitrogen so that the atmosphere could have an oxygen concentration of not more than 1.0% by volume, the coating layer was cured through exposure to UV rays, using an air-cooled, 160 W/cm metal halide lamp (by Eye Graphics) at a lighting intensity of 400 mW/cm² and at a dose of 150 mJ/cm², thereby forming a hard coat layer A having a thickness of 12 μm.

Further, the middle-refractivity layer coating liquid, the high-refractivity layer coating liquid and the low-refractivity layer coating liquid were applied to the above, using a gravure coater. The drying condition for the middle-refractivity layer was at 90° C. and for 30 seconds. The UV curing condition was as follows: While purged with nitrogen so that the atmosphere could have an oxygen concentration of not more than 1.0% by volume, the coating layer was cured through exposure to UV rays, using an air-cooled, 180 W/cm metal halide lamp (by Eye Graphics) at a lighting intensity of 300 mW/cm² and at a dose of 240 mJ/cm².

The drying condition for the high-refractivity layer was at 90° C. and for 30 seconds. The UV curing condition was as follows: While purged with nitrogen so that the atmosphere could have an oxygen concentration of not more than 1.0% by volume, the coating layer was cured through exposure to UV rays, using an air-cooled, 240 W/cm metal halide lamp (by Eye Graphics) at a lighting intensity of 300 mW/cm² and at a dose of 240 mJ/cm².

The drying condition for the low-refractivity layer was at 90° C. and for 30 seconds. The UV curing condition was as follows: While purged with nitrogen so that the atmosphere could have an oxygen concentration of not more than 0.1% by volume, the coating layer was cured through exposure to UV rays, using an air-cooled, 240 W/cm metal halide lamp (by Eye Graphics) at a lighting intensity of 600 mW/cm² and at a dose of 600 mJ/cm².

### <Production of Polarizing Plate>

The following adhesive coating liquid and upper layer coating liquid B were applied to the transparent support side of the film produced in the above, in an amount of 20 ml/m² each, and dried at 100° C. for 5 minutes to produce an adhesive-attached film sample.

(Adhesive Coating Liquid)

| | | |
|---|---|---|
| Water-soluble polymer (m) mentioned below | 0.5 | g |
| Acetone | 40 | ml |
| Ethyl acetate | 55 | ml |
| Isopropanol | 5 | ml |

(Upper Layer Coating Liquid B)

| | | |
|---|---|---|
| Polyvinyl alcohol (Nippon Gohsei's Gohsenol NH-26) | 0.3 | g |
| Saponin (Merck's surfactant) | 0.03 | g |
| Pure water | 57 | ml |
| Methanol | 40 | ml |
| Methylpropylene glycol | 3 | ml |

Water-Soluble Polymer (m)

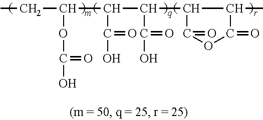

Subsequently, a roll of polyvinyl alcohol film having a thickness of 80 μm was unrolled and continuously stretched by 5 times in an aqueous iodine solution and dried to give a polarizing film having a thickness of 30 μm. The polarizing film was stuck to the adhesive-attached film in such a manner that the adhesive-coated side of the film could face the polarizing film. A commercial cellulose acetate film (Fujitac TD80UF, by FUJIFILM, having Re(550) of 3 nm and |Rth(630)| of 50 nm) was alkali-saponified. The adhesive layer was arranged on the other side of the polarizing film, and the alkali-saponified film was stuck to the adhesive layer side of the polarizing film, thereby producing a polarizing plate.

### <Evaluation of Mounting on Liquid-Crystal Display Device>

The patterned retardation plate and the front polarizing plate were peeled from a circularly-polarized glasses-use 3D monitor (by Zalman), and the polarizing plate produced in the above was stuck thereto.

An image for stereovision was projected on the thus-produced 3D monitor, and viewed through right eye/left eye circularly-polarized glasses, and as a result, a sharp three-dimensional image with no crosstalk was seen.

A polarizing plate was mounted on the monitor in the same manner as above except that the black matrix prepared in Example 12 was provided between the first retardation region and the second retardation region. As a result, a sharp three-dimensional image with less crosstalk was seen.

### Example 201

### Production of Transparent Film for Three-Dimensional Image

Using a digital camera equipped with right and left two-system picture-taking lenses (FUJIFILM's FinePix Real 3D W1), a right-eye image and a left-eye image were formed. Next, using a 3D-image forming software (striper), images were formed by alternately changing the right-eye image and the left-eye image at intervals of 200 μm. Finally, the image data were outputted on an OHP sheet (Kokuyo's VF-1300), and printed with an electrophotographic printer (Fuji Xerox's Docuprint C3540) to form a transparent image 1 for three-dimensional stereoscopy.

### <Production of Patterned Polarizing Film>

Using an adhesive, the patterned retardation film 1 of Example 1 was attached to a polarizing plate. Further, also using an adhesive, the above-mentioned transparent image 1 for three-dimensional stereoscopy was stuck thereto, and viewed through right-eye/left-eye circularly-polarized glasses. As a result, a sharp three-dimensional image with no crosstalk was observed.

### Example 202

### Production of Transparent Film for Three-Dimensional Image

In the same manner as in Example 201, the data of the digital image 1 were outputted on a transparent film for IJ (Mitsubishi Paper's IJ-Film FT100), using an inkjet unit (EPSON's PM-A820), thereby giving a transparent image 2 for three-dimensional stereoscopy.

### <Production of Patterned Polarizing Film>

Using an adhesive, the patterned retardation film 1 of Example 1 was attached to a polarizing plate. Further, also using an adhesive, the above-mentioned transparent image 2 for three-dimensional stereoscopy was stuck thereto, and viewed through right-eye/left-eye circularly-polarized glasses. As a result, a sharp three-dimensional image with no crosstalk was observed.

### Example 203

### Production of Transparent Film for Three-Dimensional Image>

### (Production of Printing Paper for Three-Dimensional Image)

### <Formation of Transparent Dye-Receiving Layer>

The surface of a cellulose acetate protective film was corona-discharged, and a gelatin undercoat layer containing sodium dodecylbenzenesulfonate was provided thereon. Further, an interlayer A having the composition mentioned below as formed thereon by coating with a bar coater, and dried, and subsequently a receiving layer A having the composition mentioned below was formed by coating with a bar coater, and dried. The coating with a bar coater was attained at 40° C., and the drying was at 50° C. for 16 hours for each layer. The coating was so attained that the dry coating amount of the interlayer A could be 1.0 g/m² and that of the receiving layer A1 could be 3.0 g/m².

<Interlayer A>

| | |
|---|---|
| Polyester resin (Vylon 200, trade name by Toyobo) | 10 parts by mass |
| Fluorescent brightener (Uvitex OB, trade name by | 1 part by mass |
| Ciba Specialty Chemicals) | |
| Titanium oxide | 30 parts by mass |
| Methyl ethyl ketone/toluene (1/1 by mass) | 90 parts by mass |

<Receiving Layer A>

| | |
|---|---|
| Polyester resin (described in Example 1 in | 100 parts by mass |
| JP-A 2-265789) | |
| Amino-modified silicone (Shin-etsu Chemical's | 5 parts by mass |
| trade name, X-22-3050C) | |
| Epoxy-modified silicone (Shin-etsu Chemical's | 5 parts by mass |
| trade name, X-22-300E) | |
| Methyl ethyl ketone/toluene (1/1 by mass) | 400 parts by mass |

### (Printing Paper for Three-Dimensional Image)

As in the above, a printing paper for transparent three-dimensional image was produced.

### (Production of Ink Sheet for Three-Dimensional Image)

A polyester film having a thickness of 6.0 μm (Lumirror, trade name by Toray) was used as the substrate film. A heat-resistant slip layer (thickness 1 μm) was formed on the back of the film, and the surface thereof was coated with yellow, magenta and cyan compositions mentioned each as individual single colors (dry coating amount 1 g/m²).

Yellow Composition

| | |
|---|---|
| Dye (Macrolex Yellow 6G, trade name by Bayer) | 5.5 parts by mass |
| Polyvinyl butyral resin (Eslec BX-1, trade name by | 4.5 parts by mass |
| Sekisui Chemical) | |
| Methyl ethyl ketone/toluene (1/1 by mass) | 90 parts by mass |

Magenta Composition

| | |
|---|---|
| Magenta dye (Disperse Red 60) | 5.5 parts by mass |
| Polyvinyl butyral resin (Eslec BX-1, trade name by | 4.5 parts by mass |
| Sekisui Chemical) | |
| Methyl ethyl ketone/toluene (1/1 by mass) | 90 parts by mass |

Cyan Composition

| | |
|---|---|
| Cyan dye (Sorbent Blue 63) | 5.5 parts by mass |
| Polyvinyl butyral resin (Eslec BX-1, trade name by | 4.5 parts by mass |
| Sekisui Chemical) | |
| Methyl ethyl ketone/toluene (1/1 by mass) | 90 parts by mass |

### [Production of Three-Dimensional Image Print]

### (Formation of Right-Eye and Left-Eye Image)

The above-mentioned ink sheet and the above-mentioned printing paper were processed so as to be chargeable in a sublimation-type printer, Nippon Densan Copal's DPB1500 (trade name), and in a high-speed printing mode, a transparent image 3 for three-dimensional stereoscopy was obtained.

### [Observation of Three-Dimensional Image]

A viewer observed the three-dimensional image print via circularly-polarized glasses, and could see a sharp three-dimensional image with neither crosstalk nor ghost. The circularly-polarized glasses comprise a left-eye circular polarization filter and a right-eye circular polarization filter, in which each circular polarization filter is composed of a linear polarization filter and a ¼λ retardation film laminated in such a manner that the polarization axis of the former could be at an angle of 45° to the slow axis of the latter, and the polarization axis of the left-eye linear polarization filter is vertical to the polarization axis of the right-eye linear polarization filter.

### <Production of Patterned Polarizing Film>

Using an adhesive the patterned retardation film 1 in Example 1 was stuck to a polarizing plate. Further, also using an adhesive, this was stuck to the above-mentioned transparent image 3 for three-dimensional stereoscopy, and this was observed through right-eye/left-eye circularly polarized glasses. As a result, a sharp three-dimensional image with no crosstalk was seen.

While the present invention has been described in detail and with reference to specific embodiments thereof, it will be apparent to one skilled in the art that various changes and modifications can be made therein without departing from the spirit and scope thereof.

The present disclosure relates to the subject matter contained in International Application No. PCT/JP2011/067225, filed Jul. 28, 2011, and Japanese Application No. 2010-173077, filed Jul. 30, 2010, the contents of which are expressly incorporated herein by reference in their entirety. A10 the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A laminate comprising a transparent support and, as formed on the transparent support, a patterned alignment control layer containing a first alignment control region and a second alignment control region each having an alignment control surface, in which the two regions differ from each other in point of the composition thereof and in point of the alignment-controlling capability thereof, in which the individual alignment control surfaces are alternately positioned in the patterned alignment control layer, and in which the alignment control surfaces of the first alignment control region and the second alignment control region can control liquid crystals in such a manner that the long axes of the aligned liquid crystals could be vertical to each other in the plane parallel to the alignment control surfaces.

2. The laminate according to claim 1, wherein the first alignment control region and the second alignment control region are processed in the same direction.

3. The laminate according to claim 1, wherein the first alignment control region and the second alignment control region are rubbed in the same direction to be in a rubbed alignment film.

4. The laminate according to claim 1, wherein the first alignment control region and the second alignment control region each are any of a film containing a modified or unmodified polyvinyl alcohol as the main ingredient thereof; a film containing a modified or unmodified polyacrylic acid; a film containing, as the main ingredient thereof, a (meth)acrylic acid copolymer that contains a recurring unit represented by the following general formula (I) or a recurring unit represented by the following general formula (II) or (III); or a film containing, as the main ingredient thereof, a polymer that has at least one structural unit represented by any of the following general formulae, (I-TH), (II-TH) and (III-TH): 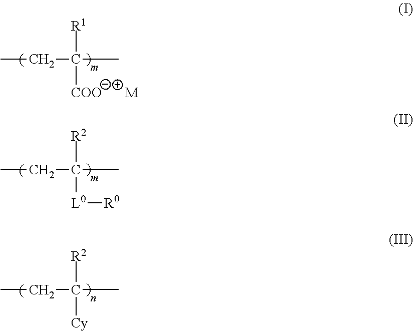
wherein, in the general formulae (I) to (III);
R¹ and R² each independently represent a hydrogen atom, a halogen atom or an alkyl group having from 1 to 6 carbon atoms;
M represents a proton, an alkali metal ion or an ammonium ion;
L⁰ represents a divalent linking group selected from the group consisting of —O—, —CO—, —NH—, —SO₂—, an alkylene group, an alkenylene group, an arylene group and a combination thereof;
R⁰ represents a hydrocarbon group having from 10 to 100 carbon atoms, or a fluorine atom-substituted hydrocarbon group having from 1 to 100 carbon atoms;
Cy represents an aliphatic cyclic group, an aromatic group or a heterocyclic group;
m indicates from 10 to 99 mol %; and n indicates from 1 to 90 mol %; 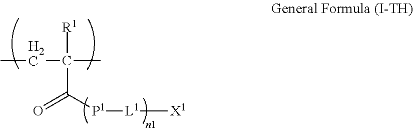
wherein, in the formula, R¹ represents a hydrogen atom, a methyl group, a halogen atom or a cyano group, P¹ represents an oxygen atom, —CO— or —NR¹²—, R¹² represents a hydrogen atom, or a substituted or unsubstituted alkyl group having from 1 to 6 carbon atoms, L¹ represents a divalent linking group selected from the group consisting of a substituted or unsubstituted, alkylene group, divalent cyclic aliphatic group, divalent aromatic group or divalent heterocyclic group, or a combination thereof, X¹ represents a hydrogen-bonding group, n1 indicates an integer of from 1 to 3; 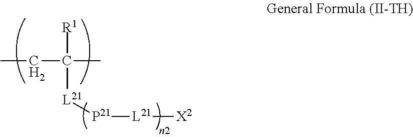
wherein, in the formula, R² represents a hydrogen atom, a methyl group, a halogen atom or a cyano group, L²¹ represents a substituted or unsubstituted, divalent aromatic group or divalent heterocyclic group, P²¹ represents a single bond, or a divalent linking group selected from the group consisting of —O—, —NR²¹—, —CO—, —S—, —SO—, —SO₂— and a combination thereof, R²¹ represents a hydrogen atom, or a substituted or unsubstituted alkyl group having from 1 to 6 carbon atoms, L²² represents a divalent linking group selected from the group consisting of a substituted or unsubstituted, alkylene group, divalent cyclic aliphatic group, divalent aromatic group or divalent heterocyclic group, or a combination thereof; X² represents a hydrogen-bonding group; n2 indicates an integer of from 0 to 3; 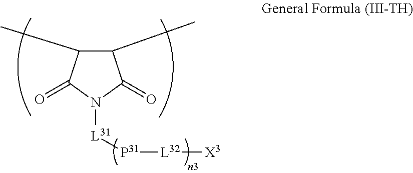
wherein, in the formula, L³¹ represents a substituted or unsubstituted, divalent aromatic group or divalent heterocyclic group, P³¹ represents a single bond, or a divalent linking group selected from the group consisting of —O—, —NR³¹—, —CO—, —S—, —SO—, —SO₂— and a combination thereof, R³¹ represents a hydrogen atom, or a substituted or unsubstituted alkyl group having from 1 to 6 carbon atoms, L³² represents a divalent linking group selected from the group consisting of a substituted or unsubstituted, alkylene group, divalent cyclic aliphatic group, divalent aromatic group or divalent heterocyclic group, or a combination thereof; X³ represents a hydrogen-bonding group; n3 indicates an integer of from 0 to 3.

5. The laminate according to claim 1, wherein the first alignment control region and the second alignment control region each comprise a different resin as the main ingredient thereof.

6. The laminate according to claim 1, wherein at least one region of the first alignment control region and the second alignment control region contains at least one of a pyridinium compound and an imidazolium compound.

7. The laminate according to claim 1, wherein the first alignment control region and the second alignment control region both comprise the same resin as the main ingredient thereof, and at least one region thereof contains at least one of a pyridinium compound and an imidazolium compound.

8. The laminate according to claim 6, wherein the pyridinium compound or the imidazolium compound is liquid-crystalline.

9. The laminate according to claim 1, wherein the first alignment control region and the second alignment control region both comprise a non-developing resin as the main ingredient thereof.

10. The laminate according to claim 1, wherein the first alignment control region and the second alignment control region each are any one mode of the following (1) or (2)
Mode (1): The first alignment control region is formed on the transparent support and the second alignment control region is formed on a part of the first alignment control region.
Mode (2): The first alignment control region is formed on a part of the transparent support and the second alignment control region is formed on the other part of the transparent support on which the first alignment control region is not formed.

11. The laminate according to claim 1, wherein a black matrix is arranged between the first alignment control region and the second alignment control region.

12. The laminate according to claim 1, wherein Re(550) of the transparent support is from 0 to 10 nm, and Re(550) means the front retardation value (unit: nm) at a wavelength of 550 nm.

13. The laminate according to claim 1, which is used as a support of a patterned optical anisotropic layer.

14. An optical film having a laminate and an optical anisotropic layer formed of a composition comprising a polymerizing group-having liquid crystal as the main ingredient thereof, wherein:
the laminate comprises a transparent support and, as formed on the transparent support, a patterned alignment control layer containing a first alignment control region and a second alignment control region each having an alignment control surface, in which the two regions differ from each other in point of the composition thereof and in point of the alignment-controlling capability thereof, in which the individual alignment control surfaces are alternately positioned in the patterned alignment control layer, and in which the alignment control surfaces of the first alignment control region and the second alignment control region can control liquid crystals in such a manner that the long axes of the aligned liquid crystals could be vertical to each other in the plane parallel to the alignment control surfaces,
the optical anisotropic layer is formed on the first alignment control region and the second alignment control region on the laminate, and
the optical anisotropic layer comprises a first retardation region and a second retardation region that are alternately patterned and that differ in the in-plane slow axis thereof.

15. The optical film according to claim 14, wherein in the optical anisotropic layer, the first retardation region and the second retardation region are alternately belt-like patterned so as to have long sides parallel to one side of the optical anisotropic layer, and wherein the in-plane slow axis of the first retardation region is nearly vertical to the in-plane slow axis of the second retardation region.

16. The optical film according to claim 14, of which the total Re(550) is from 100 to 190 nm, and Re(550) means the front retardation value (unit: nm) at a wavelength of 550 nm.

17. The optical film according to claim 14, wherein the polymerizing group-having liquid crystal is a discotic liquid crystal, and in the optical anisotropic layer, the discotic liquid crystal is fixed in a vertical alignment state.

18. The optical film according to claim 17, wherein the optical anisotropic layer contains at least one of a pyridinium compound and an imidazolium compound.

19. The optical film according to claim 14, wherein the polymerizing group-having liquid crystal is a rod-shaped liquid crystal, and in the optical anisotropic layer, the rod-shaped liquid crystal is fixed in a vertical alignment state.

20. The optical film according to claim 14, which has a black matrix between the first retardation region and the second retardation region.

21. A polarizing plate containing an optical film and a polarizing film, wherein:
the optical film has a laminate and an optical anisotropic layer formed of a composition comprising a polymerizing group-having liquid crystal as the main ingredient thereof,
the laminate comprises a transparent support and, as formed on the transparent support, a patterned alignment control layer containing a first alignment control region and a second alignment control region each having an alignment control surface, in which the two regions differ from each other in point of the composition thereof and in point of the alignment-controlling capability thereof, in which the individual alignment control surfaces are alternately positioned in the patterned alignment control layer, and in which the alignment control surfaces of the first alignment control region and the second alignment control region can control liquid crystals in such a manner that the long axes of the aligned liquid crystals could be vertical to each other in the plane parallel to the alignment control surfaces,
the optical anisotropic layer is formed on the first alignment control region and the second alignment control region on the laminate,
the optical anisotropic layer comprises a first retardation region and a second retardation region that are alternately patterned and that differ in the in-plane slow axis thereof, and
the in-plane slow axis direction of the first retardation region and the in-plane slow axis direction of the second retardation region in the optical anisotropic layer are both at 45° to the absorption axis direction of the polarizing film.

22. The polarizing plate according to claim 21, wherein the optical film and the polarizing plate are laminated via an adhesive layer therebetween.

23. The polarizing plate according to claim 21, which is further laminated with at least one antireflection film on the outermost surface thereof.

24. An image display device having at least the following:
first and second polarizing films;
as arranged between the first and second polarizing films, a liquid-crystal cell including a pair of substrates of which at least one has an electrode and which are arranged to face each other and a liquid-crystal layer between the pair of substrates; and
an optical film to be arranged outside the first polarizing film,
wherein:
the optical film has a laminate and an optical anisotropic layer formed of a composition comprising a polymerizing group-having liquid crystal as the main ingredient thereof,
the laminate comprises a transparent support and, as formed on the transparent support, a patterned alignment control layer containing a first alignment control region and a second alignment control region each having an alignment control surface, in which the two regions differ from each other in point of the composition thereof and in point of the alignment-controlling capability thereof, in which the individual alignment control surfaces are alternately positioned in the patterned alignment control layer, and in which the alignment control surfaces of the first alignment control region and the second alignment control region can control liquid crystals in such a manner that the long axes of the aligned liquid crystals could be vertical to each other in the plane parallel to the alignment control surfaces,
the optical anisotropic layer is formed on the first alignment control region and the second alignment control region on the laminate,
the optical anisotropic layer comprises a first retardation region and a second retardation region that are alternately patterned and that differ in the in-plane slow axis thereof, and
the absorption axis direction of the first polarizing film is at an angle of ±45° to both the in-plane slow axis of the first retardation region and the in-plane slow axis of the second retardation region in the optical film.

25. The image display device according to claim 24, which comprises a third polarizing plate to be arranged outside the optical film, wherein a three-dimensional image is visualized through the third polarizing plate.

26. A method for producing a laminate comprising a transparent support and, as formed on the transparent support, a patterned alignment control layer containing a first alignment control region and a second alignment control region each having an alignment control surface, in which the two regions differ from each other in point of the composition thereof and in point of the alignment-controlling capability thereof, in which the individual alignment control surfaces are alternately positioned in the patterned alignment control layer, and in which the alignment control surfaces of the first alignment control region and the second alignment control region can control liquid crystals in such a manner that the long axes of the aligned liquid crystals could be vertical to each other in the plane parallel to the alignment control surfaces, which comprises:
forming a first alignment control region of a first composition on a transparent support, and
pattern-like printing a second alignment control region of a second composition that differ from the first composition.

27. The method for producing a laminate according to claim 26, wherein in the first alignment control region-forming, the first alignment control region is formed on the transparent substrate according to any of the following method (I) or (II):
Method (I): The first alignment control region is formed on the entire surface of the transparent support.
Method (II): The first alignment control region is formed on a part of the transparent support.

28. The method for producing a laminate according to claim 26, which includes aligning the first alignment control region and the second alignment control region in one direction.

29. The method according to claim 26, which includes forming the alignment control layer that contains the first alignment control region and the second alignment control region, according to any one of the following (I-A), (I-B) and (II-A):
(I-A): The first alignment control region is printed on the transparent support, then the second alignment control region is printed on apart of the first alignment control region, and both the first alignment control region and the second alignment control region are simultaneously processed in one direction.
(I-B): The first alignment control region is printed on the transparent support, then the first alignment control region is processed in one direction, and thereafter the second alignment control region is printed on a part of the processed surface of the first alignment controlled region.
(II-A): The first alignment control region is printed on apart of the transparent support, the second alignment control region is printed on the other region of the transparent support on which the first alignment control region is not printed, and the first alignment control region and the second alignment control region are simultaneously processed in one direction.

30. The method according to claim 28, wherein the processing in one direction is rubbing in one direction.

31. The method according to claim 26, wherein the second alignment control region is formed through flexographic printing.

32. The method according to claim 29, wherein in (I-A) or (II-A), the first composition for use in printing the first alignment control region contains any one of a parallel alignment film composition and a vertical alignment film composition and a first solvent, and the second composition for use in printing the second alignment control region contains the other compound and a second alignment solvent.

33. The method according to claim 29, wherein in (I-B), the first composition for use in printing the first alignment control region contains an alignment film compound and a first solvent, and the second composition for use in printing the second alignment control region contains at least any one of a pyridinium compound and an imidazolium compound, and a second solvent.

34. A method for producing an optical film, which comprises arranging a composition that contains a polymerizing group-having liquid crystal on a laminate, forming an optical anisotropic layer, and forming a patterned optical anisotropic layer that contains a first retardation region with alignment control on the first alignment control region and a second retardation region with alignment control on the second alignment control region, wherein:
the laminate comprising a transparent support and, as formed on the transparent support, a patterned alignment control layer containing a first alignment control region and a second alignment control region each having an alignment control surface, in which the two regions differ from each other in point of the composition thereof and in point of the alignment-controlling capability thereof, in which the individual alignment control surfaces are alternately positioned in the patterned alignment control layer, and in which the alignment control surfaces of the first alignment control region and the second alignment control region can control liquid crystals in such a manner that the long axes of the aligned liquid crystals could be vertical to each other in the plane parallel to the alignment control surfaces.

35. The method according to claim 34, wherein at least one of the first alignment control region and the second alignment control region in the laminate contains at least one of a pyridinium compound and an imidazolium compound, the liquid crystal is a discotic liquid crystal, and after a composition containing the discotic liquid crystal is arranged on the laminate, the laminate is heat-treated to control the alignment of the discotic liquid crystal, thereby forming the first retardation region and the second retardation region.

36. The method according to claim 34, wherein before or after the formation of the optical anisotropic layer, a black matrix is formed between the first retardation region and the second retardation region.
